(19) United States
(12) Patent Application Publication
(10) Pub. No.: US 2025/0337688 A1
(43) Pub. Date: Oct. 30, 2025

(54) HARDWARE-ACCELERATED POLICY-BASED ROUTING (PBR) OVER SERVICE FUNCTION CHAINING (SFC)

(71) Applicant: Mellanox Technologies, Ltd., Yokneam (IL)

(72) Inventor: Chen Rozenbaum, Be'er Ya'akov (IL)

(21) Appl. No.: 18/928,794

(22) Filed: Oct. 28, 2024

Related U.S. Application Data
(63) Continuation-in-part of application No. 18/649,319, filed on Apr. 29, 2024.

(51) Int. Cl. H04L 47/20; H04L 45/586; H04L 45/76

(52) U.S. Cl. CPC H04L 47/20; H04L 45/586; H04L 45/76

(57) ABSTRACT

Technologies for creating an optimized and accelerated network pipeline using a network pipeline abstraction layer (NPAL) for policy-based routing (PBR) over Service Function Chaining (SFC) are described. A DPU includes acceleration hardware engine to provide a single accelerated data plane. A processing device can generate a first virtual bridge and a second virtual bridge, the first virtual bridge to be controlled by a first network service hosted on the DPU and having a set of one or more network rules, and the second virtual bridge having a policy-based routing policy (PBR policy). The processing device can add the virtual port between the first virtual bridge and the second virtual bridge. The acceleration hardware engine, in the single accelerated data plane, can route network traffic data using the PBR policy and process the network traffic data using the set of one or more network rules.

### RELATED APPLICATIONS

This application is a continuation-in-part application of U.S. patent application Ser. No. 18/649,319, filed Apr. 29, 2024, the entire contents of which are incorporated by reference. This application is related to commonly assigned U.S. patent application Ser. No. 18/649,295, filed Apr. 29, 2024, U.S. patent application Ser. No. 18/649,334, filed Apr. 29, 2024, U.S. Patent Application No. [yet to be assigned], entitled “Network Pipeline Abstraction Layer (NAPL) Split Interfaces,” concurrently filed with the present application, U.S. Patent Application No. [yet to be assigned], entitled “Network Pipeline Abstraction Layer (NAPL) Fast Link Recovery,” concurrently filed with the present application, and U.S. Patent Application No. [yet to be assigned], entitled “Network Pipeline Abstraction Layer (NAPL) Emulation,” concurrently filed with the present application.

### TECHNICAL FIELD

At least one embodiment pertains to processing resources used to perform and facilitate operations for providing hardware-accelerated policy-based routing (PBR) over service function chaining (SFC) architectures. For example, at least one embodiment pertains to processors or computing systems used to provide and enable virtual bridges with one managing routing according to a PBR policy and another managing different network service rules for an acceleration hardware engine to route network traffic data according to the PBR policy and process network traffic data in a single accelerated data plane using the network rules, according to various novel techniques described herein.

### BACKGROUND

In traditional network architectures, various security and performance functions were managed by specialized hardware devices known as middleboxes, each serving distinct roles. Firewalls, as standalone physical appliances, served as the primary defense mechanism at the network's edge, scrutinizing incoming and outgoing traffic based on set rules to block or allow data transmission, thereby safeguarding the internal network from external threats. Load balancers operated as separate hardware units, intelligently distributing incoming network and application traffic across multiple servers to prevent overload and ensure efficient resource utilization, thereby enhancing application availability and performance. Intrusion Detection Systems (IDS), positioned strategically within the network, were dedicated to monitoring and analyzing network traffic for signs of anomalies, attacks, or security policy violations, acting as a security component in identifying potential security breaches.

Additionally, networks utilized other middlebox functions like Data Loss Prevention (DLP) systems to monitor and prevent unauthorized data exfiltration, virtual private network (VPN) Gateways to establish secure and encrypted connections across networks, and Wide Area Network (WAN) Optimization appliances designed to improve data transfer efficiency across wide area networks. These middleboxes were essential but came with challenges: they required significant capital investment, occupied valuable space in data centers, and demanded specialized personnel for operation and maintenance. Scaling these network functions often meant acquiring and integrating more physical devices, which added to the complexity and cost of the network infrastructure.

### BRIEF DESCRIPTION OF DRAWINGS

Various embodiments in accordance with the present disclosure will be described with reference to the drawings, in which:

FIG. 1 is a block diagram of an integrated circuit with a Service Function Chaining (SFC) logic for generating virtual bridges and interface mappings in an SFC architecture according to at least one embodiment.

FIG. 2 is a block diagram of an example DPU-based Service Function Chaining (SFC) infrastructure for providing an SFC architecture according to at least one embodiment.

FIG. 3 is a block diagram of an SFC architecture with a first virtual bridge, a second virtual bridge, a virtual port, and a network service, according to at least one embodiment.

FIG. 4 is a block diagram of an SFC architecture with a first virtual bridge, a second virtual bridge, a virtual port, and a network service, according to at least one embodiment.

FIG. 5 is a block diagram of a non-SFC architecture with a first virtual bridge and a network service, according to at least one embodiment.

FIG. 6 is a flow diagram of an example method of configuring an SFC architecture with multiple virtual bridges and interface mappings according to at least one embodiment.

FIG. 7 is a block diagram of an example DPU-based SFC infrastructure for providing hardware-accelerated rules for an SFC architecture 220 according to at least one embodiment.

FIG. 8 is a block diagram of an SFC architecture with flexible hardware-accelerated rules for a single accelerated data plane, according to at least one embodiment.

FIG. 9 is a block diagram of an SFC architecture with flexible hardware-accelerated rules for a single accelerated data plane, according to at least one embodiment.

FIG. 10 is a flow diagram of an example method of configuring an SFC architecture with flexible hardware-accelerated rules for acceleration on a single accelerated data plane of a DPU according to at least one embodiment.

FIG. 11 is a block diagram of an example computing system with a DPU having a network pipeline abstraction layer (NPAL) for providing an optimized and accelerated network pipeline to be accelerated by an acceleration hardware engine according to at least one embodiment.

FIG. 12 is a network diagram of an example network pipeline that is optimized and accelerated on an acceleration hardware engine of a DPU having an NPAL according to at least one embodiment.

FIG. 13 is a network diagram of an example network pipeline that is optimized and accelerated on an acceleration hardware engine of a DPU having an NPAL according to at least one embodiment.

FIG. 14 is a network diagram of an example network pipeline that is optimized and accelerated on an acceleration hardware engine of a DPU having an NPAL according to at least one embodiment.

FIG. 15 is a flow diagram of an example method of creating an optimized and accelerated network pipeline using a network pipeline abstraction layer (NPAL) according to at least one embodiment.

FIG. 16 is a block diagram of a software stack of a DPU with an NPAL that supports split interfaces according to at least one embodiment.

FIG. 17 is a network diagram of an example network pipeline that is optimized and accelerated on an acceleration hardware engine of a DPU having an NPAL supporting split interfaces according to at least one embodiment.

FIG. 18 is a flow diagram of a method of operating a DPU with split interfaces according to at least one embodiment.

FIG. 19 is a block diagram of a software stack of a DPU with an NPAL that supports fast link recovery according to at least one embodiment.

FIG. 20 is a network diagram of an example network pipeline that is optimized and accelerated on an acceleration hardware engine of a DPU having an NPAL supporting fast link recovery according to at least one embodiment.

FIG. 21 are flow diagrams of Equal-Cost Multi-Path (ECMP) operations before a link failure, after a link failure, and after a link recovery according to at least one embodiment.

FIG. 22 is a flow diagram of a method of operating a DPU with fast link recovery according to at least one embodiment.

FIG. 23 is a block diagram of an SFC architecture with a PBR policy according to at least one embodiment.

FIG. 24 is a flow diagram of a method of operating a DPU supporting PBR over an SFC architecture according to at least one embodiment.

FIG. 25 is a block diagram of an emulated network pipeline on an emulated acceleration hardware engine of an emulated DPU having an emulated NPAL according to at least one embodiment.

FIG. 26 is a block diagram of an emulated SFC architecture 2600 with an emulated host device and an emulated DPU according to at least one embodiment.

FIG. 27 is a flow diagram of a method of operating an emulated DPU according to at least one embodiment.

FIG. 28 is a block diagram of a computing system having two processing devices coupled to each other and multiple networks according to at least one embodiment.

FIG. 29 is a block diagram of a computing system having a central processing unit (CPU) and a graphics processing unit (GPU) in a single integrated circuit according to at least one embodiment.

FIG. 30 is a block diagram of a computing system having tensor core graphics processing units (GPUs) according to at least one embodiment.

### DETAILED DESCRIPTION

Technologies for providing hardware-accelerated flexible steering rules over service function chaining (SFC) architectures are described. Also, technologies for optimizing network acceleration using a network pipeline abstraction layer (NAPL) are described. Also, technologies for providing configurable and dynamic SFC interfaces on a data processing unit (DPU) are described. DPUs are described in more detail below. Also, technologies for providing NAPL split interfaces are described. Also, technologies for providing NAPL fast link recovery are described. Also, technologies for hardware-accelerated policy-based routing (PBR) over SFC architectures are described. Also, technologies for NAPL emulation are described.

As described above, in traditional network architectures, various security and performance functions were managed by specialized hardware devices known as middleboxes (e.g., firewalls, load balancers, IDSs, etc.). Traditional networks were designed with the assumption that all resources would be housed within an on-premises data center, and often characterized by a centralized model.

Modern networks are increasingly cloud-centric, designed to support cloud services and applications. This includes the use of public, private, and hybrid cloud infrastructures, requiring networks to be more flexible and scalable. Unlike traditional network architectures that rely heavily on physical hardware (i.e., each network function required its own dedicated device), current network architectures leverage virtualization technologies, such as software-defined networking (SDN) and network function virtualization (NFV). These allow network resources to be abstracted from hardware, providing greater flexibility, easier management, and reduced costs. Modern networks increasingly use automation and orchestration tools to manage network resources efficiently, reduce operational overhead, and enable faster deployment of network services. Modern networks are designed for scalability and high performance, utilizing technologies like edge computing to process data closer to the source and reduce latency. Current network architectures are more flexible, scalable, and efficient than traditional ones, designed to support the dynamic and distributed nature of modern computing resources and work practices. They integrate advanced technologies like cloud services, virtualization, and automation to meet the demands of today's digital environment.

### Service Function Chaining (SFC) Architectures

One networking concept and architecture used in SDN and NFV environments is Service Function Chaining (SFC). SFC can be used to define and orchestrate an order of network services through a series of interconnected network nodes. SFC aims to virtualize network services (e.g., firewalls, load balancers, IDSs, and other middlebox functions) and define the sequence in which network traffic data passes through them to achieve specific processing or treatment. Each network service is represented as a Service Function (SF). These SFs can be implemented as virtualized software instances running on physical or virtual infrastructure. A Service Chain defines the sequence of SFs through which network traffic data passes. For example, a service function chain might specify that network traffic data first goes through a firewall, then a load balancer, and finally an IDS using Service Function Paths (SFPs) and Service Function Forwarders (SFFs). The SFP refers to the defined sequence of scalable functions (SFs) through which network traffic data is steered in a specific order. An SFP is a logical representation of the path that network traffic data will follow through the network, traversing various service functions, such as firewalls, load balancers, IDSs, and so on. The SFP dictates the flow of traffic and ensures that it passes through each designated service function in the correct sequence. The SFP can be used for implementing policy-based routing and network services in a flexible and dynamic manner. The SFF is a component within the SFC architecture that is responsible for the actual forwarding of network traffic data to the designated service functions as specified by the SFP. The SFF acts as a router or switch that directs traffic between different service functions and ensures that the network traffic data follows the prescribed path defined by the SFP. The SFF makes decisions on where to send the network traffic data next based on SFC encapsulation information and the SFP. It handles the routing and forwarding between service functions and deals with any traffic encapsulation and de-encapsulation used for SFC operation. For example, when a packet enters a network, it is classified based on its attributes (such as source/destination Internet Protocol (IP) addresses, protocols, ports, etc.), and the appropriate SFP is selected to determine the path through the appropriate SFs. The packet is then steered along the SFP by SFFs.

Service Function Chaining offers several benefits, including increased flexibility, scalability, and agility in deploying and managing network services. It enables dynamic creation of service chains based on application requirements, traffic conditions, or policy changes, leading to more efficient and customizable network service delivery.

Current solutions in SFC architectures do not support the creation and use of flexible steering rules in a single accelerated data plane on a DPU. Current solutions in SFC architectures do not support configurable and dynamic interface mappings on the DPU. Current solutions do not always support acceleration of all operations of an SFC architecture.

Aspects and embodiments of the present disclosure address these problems and others by providing technologies for providing hardware-accelerated flexible steering rules over SFC architectures of a DPU, providing configurable and dynamic SFC interfaces on a DPU, and/or optimizing network acceleration using a network pipeline abstraction layer as described in more detail below. Aspects and embodiments of the present disclosure can provide and enable virtual bridges with different steering rules to acceleration hardware engine to process network traffic data in a single accelerated data plane using a combined set of network rules from different steering rules from different virtual bridges. Aspects and embodiments of the present disclosure can provide and enable a network pipeline abstraction layer (NPAL) that supports multiple network protocols and network functions in a network pipeline, where the pipeline includes a set of tables and logic organized in a specific order to be accelerated by the acceleration hardware engine. Aspects and embodiments of the present disclosure can provide and enable a first virtual bridge, a second virtual bridge, and a virtual port between the first virtual bridge and the second virtual bridge, where the first virtual bridge is controlled by a first network service hosted on the DPU and the second virtual bridge is controlled by a user-defined logic. Aspects and embodiments of the present disclosure can provide and enable an NPAL that supports split interfaces. Aspects and embodiments of the present disclosure can provide and enable an NPAL that supports fast link recovery. Aspects and embodiments of the present disclosure can provide and enable a first virtual bridge, a second virtual bridge, and a virtual port between the first virtual bridge and the second virtual bridge, where the first virtual bridge is controlled by a first network service hosted on the DPU and the second virtual bridge is controlled by a policy-based routing policy (PBR policy).

### Data Processing Units (DPUs)

In modern network architectures, a DPU can be used to provide a set of software-defined networking, storage, security, and management services at a data-center scale with the ability to offload, accelerate, and isolate data center infrastructure. The DPU can offload processing tasks that a server's central processing unit (CPU) normally handles, such as any combination of encryption/decryption, firewall, transport control protocol/Internet Protocol (TCP/IP), and HyperText Transport Protocol (HTTP) processing, networking operations. A DPU can be an integrated circuit or a System on a Chip (SoC) that is considered a data center infrastructure on a chip. The CPU can include DPU hardware and DPU software (e.g., software framework with acceleration libraries). The DPU hardware can include a CPU (e.g., a single-core or multi-core CPU), one or more hardware accelerators, memory, one or more physical host interfaces that operatively couple to one or more host devices (e.g., a CPU of a host device), and one or more physical network interfaces that operatively couple to a network (e.g., a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, network adapters, NVLink switches, and/or a combination thereof). The DPU can handle network data path processing of network traffic data, whereas a host device can control path initialization and exception processing. The acceleration hardware engine (e.g., DPU hardware) can be used to offload and filter network traffic based on predefined filters using the hardware capabilities of the acceleration hardware engine. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services.

A DPU can provide accelerated networking services (also referred to as Host Based Network service (HBN) service to one or more host devices. The DPU network services can be used for accelerating Layer 2 (L2) protocols, Layer 3 (L3) protocols, tunneling protocols, or the like, on the DPU hardware. The HBN infrastructure is based on SFC topology, where a single virtual bridge (e.g., Open vSwitch (OVS) bridge) is controlled by the HBN service, providing all accelerated networking capabilities. The HBN service can support different protocols and different network capabilities, such as Access Control Lists (ACLs), an Equal-Cost Multi-Path (ECMP), tunneling, Connection Tracking (CT), Quality of Service (QOS) rule, Spanning Tree Protocol (STP), virtual local area network (VLAN) mapping, network address translations (NATs), software-defined networking (SDN), multi-protocol label switching (MPLS), etc.

### Configurable and Dynamic SFC Interfaces Mapping on DPU

Aspects and embodiments of the present disclosure can provide, in addition to a first virtual bridge that is controlled by an HBN service, a second virtual bridge that can be controlled by user-defined logic. The second virtual bridge can be programmable by a user, a customer, a controller, such as an Open Virtual Network (OVN) controller. OVN is an open-source project designed to provide network virtualization to virtual machines (VMs) and container instances. OVN acts as an extension to OVS, which is a virtual switch primarily used to enable network automation in large-scale network environments. OVN complements OVS by adding native support for virtual network abstractions, such as virtual L2 and L3 overlays and security groups. Aspects and embodiments of the present disclosure can support configurable and dynamic interfaces mapping on the DPU based on SFC infrastructure. The configuration can be supported as part of the DPU's operating system (OS) installation, as well as dynamically for DPUs in production. The configuration can be done in deployed DPUs without reinstallation of the DPU OS. The interface configuration in the configuration file can support different use-cases for network acceleration on the DPU.

In at least one embodiment, the DPU includes memory to store a configuration file that specifies multiple virtual bridges, such as the first and second virtual bridges described above. The configuration file also specifies interface mappings for the multiple virtual bridges. The DPU includes a processing device that is operatively coupled to the memory. The processing device generates a first virtual bridge and a second virtual bridge according to the configuration file. The first virtual bridge is controlled by a first network service hosted on the DPU and the second virtual bridge is controlled by a user-defined logic. The processing device adds one or more host interfaces to the second virtual bridge, adds a first service interface to the first virtual bridge to operatively couple to the first network service, and adds one or more virtual ports between the first virtual bridge and the second virtual bridge, all according to the configuration file. The second virtual bridge provides flexibility to the user, customer, or controller to define additional network functions, different network functions, than those performed by the first network service. In one implementation, a second network service includes the user-defined logic. The processing device adds a second service interface to the second virtual bridge to operatively couple to the second network service. Alternatively, the user-defined logic can be implemented in the second virtual bridge itself or logic operatively coupled to the second virtual bridge.

### Hardware-Accelerated Flexible Steering Rules of SFC Architecture of DPU

Aspects and embodiments of the present disclosure can provide a second virtual bridge to allow a user, a customer, or a controller to specify flexible steering rules over SFC architecture of a DPU. Using an SFC on the DPU, a user (or controller) can create flexible and dynamic network steering rules which are accelerated by DPU hardware as single data plane on the DPU. In particular, the user-defined rules can be accelerated with the existing networking rules in the HBN service in a single accelerated data plane as described in more detail herein. The user (or controller) can program in a flexible manner different steering rules over the SFC in parallel to the HBN service, which will result with a single accelerated data plane by the DPU hardware and DPU software. The hardware-accelerated service of the DPU can include an OVS infrastructure that is based on the open-source OVS with additional features, new acceleration capabilities. For example, the hardware-accelerated service can include the OVS-DOCA technology, developed by Nvidia Corporation of Santa Clara, California. OVS-DOCA, which is an OVS infrastructure for DPU, is based on the open-source OVS with additional features, new acceleration capabilities, and the OVS backend is purely DOCA based. The hardware-accelerated service can also support OVS-Kernel and OVS-DPDK, which are the common modes. All three operation modes make use of flow offloads for hardware acceleration, but due to its architecture and use of DOCA libraries, the OVS-DOCA mode provides the most efficient performance and feature set among them. The OVS-DOCA mode can leverage the DOCA Flow library to configure and use the hardware offload mechanisms and application techniques to generate a combined set of network rules that is used by the acceleration hardware engine to process network traffic data in a single accelerated data plane. Using a defined SFC infrastructure in a configuration file, users and customers can leverage the DPU as a networking accelerator on an edge device without the need for sophisticated and smart switches in different network topologies in data center (DC) networks and in Service Provider (SP) networks.

In at least one embodiment, the DPU includes an acceleration hardware engine to provide a single accelerated data plane. The DPU includes memory store a configuration file specifying at least a first virtual bridge, a second virtual bridge, and a virtual port between the first virtual bridge and the second virtual bridge. A processing device of the DPU is operatively coupled to the memory and the acceleration hardware engine. The processing device generates the first virtual bridge and the second virtual bridge according to the configuration file. The first virtual bridge is controlled by a first network service hosted on the DPU and has a first set of one or more network rules. The second virtual bridge has a second set of one or more user-defined network rules. The processing device adds the virtual port between the first virtual bridge and the second virtual bridge according to the configuration file. The processing device generates a combined set of network rules based on the first set of one or more network rules and the second set of one or more user-defined network rules. The acceleration hardware engine can process network traffic data in the single accelerated data plane using the combined set of network rules.

### Network Pipeline Abstraction Layer (NPAL) Optimized Pipeline for Network Acceleration

Aspects and embodiments of the present disclosure can provide NPAL, which is a software programmable layer, to provide an optimized network pipeline that supports different accelerated network capabilities, such as L2 bridging, L3 routing, tunnel encapsulation, tunnel decapsulation, hash calculations, ECMP operations, static and dynamic ACLs, CT, etc. That is, the NAPL is an accelerated programmable network pipeline to provide an abstraction of the underlying functionality of a network pipeline that is optimized for hardware acceleration on the DPU hardware. The NPAL can be, or similar to, a database abstraction layer (DAL). DAL is a programming concept used in software engineering to provide an abstraction over the underlying database systems, allowing applications to interact with different databases, low-level software layers or hardware directly without needing to change the application code. The DAL typically includes a set of applications programming interfaces (APIs) or classes that provide a unified interface for performing common database operations, such as querying, inserting, updating, and deleting data. By using the DAL, developers can write database-independent code, reducing the coupling between the application and the specific database implementation. Similarly, the NPAL can include a set of APIs or classes that provide a unified interface for performing common networking operations in a network pipeline that is optimized for hardware acceleration on the DPU hardware. In particular, the NPAL can provide a unified interface to one or more applications, network services, or the like, executed by the DPU or host device. NPAL can provide an optimized network pipeline that supports multiple network protocols and functionalities. The network pipeline can include a set of tables and logic in a specific order, the network pipeline being optimized to be accelerated by the DPU hardware, providing customers and users a rich set of capabilities and high performance.

Using an NPAL in the DPU can provide various benefits, including operational independence, encapsulation of logic, performance, code reusability, platform independence, or the like. For example, developers can write agnostic code, allowing applications (e.g., network services) to work with different underlying access logic and network functionality. The NPAL can encapsulate the access or network function-related logic, making it easier to manage and maintain the codebase. systems. Changes to the schema or underlying technology can be isolated within the NPAL implementation. The NPAL can provide optimized and high-performance pipeline to address different networking requirements and functionality. By separating access logic from application logic, developers can reuse the NPAL components across multiple parts of the application (network service), promoting code reuse and maintainability. The NPAL can abstract away platform-specific differences, data types, and other access or network function-related features, enabling the application (network service) to run on different platforms and environments seamlessly. Overall, the NPAL can be a powerful tool for building flexible, scalable, and maintainable network function-driven applications, offering a level of abstraction that simplifies interactions between network functions and promotes code efficiency and portability.

In at least one embodiment, the DPU includes DPU hardware, including a processing device and an acceleration hardware engine. The DPU includes memory operatively coupled to the DPU hardware. The memory can store DPU software including an NPAL that supports multiple network protocols and network functions in a network pipeline. The network pipeline includes a set of tables and logic organized in a specific order to be accelerated by the acceleration hardware engine. The acceleration hardware engine can process network traffic data using the network pipeline. The network pipeline can be optimized for network services running on the DPU.

### OVS and OVS Bridges

Open vSwitch (OVS) is an open-source, multi-layer virtual switch that is used to manage network traffic in virtualized environments, particularly in data centers and cloud computing platforms. OVS provides network connectivity between virtual machines (VMs), containers, and physical devices. OVS is widely used in virtualization and cloud technologies and is a typical component of many software-defined networking (SDN) and network virtualization solutions.

A virtual switch, often found in virtualized computing environments, is a software application that allows virtual machines (VMs) on a single physical host to communicate with each other and with the external network. The virtual switch can provide network connectivity between VMs, containers, and physical devices. The virtual switch can emulate the functionality of a physical network switch but operate at a software level within a hypervisor or a host operating system. The virtual switch can manage network traffic, directing data packets between VMs on the same host or between VMs and the physical network using ports. These ports can be configured for various policies like security settings, Quality of Service (QOS) rules, etc. The virtual switch can segment network traffic to provide isolation between different virtual networks. The virtual switch can provide an interface between the virtualized environment and the physical network, allowing VMs to communicate outside their host. The virtual switch can support standard networking protocols and features, such as virtual local area network (VLAN) tagging, Layer 2 forwarding, Layer 3 capabilities, and the like. OVS can support the OpenFlow Protocol, allowing the virtual switch to be controlled by a network controller to make decisions about how traffic should be routed through the network. A network controller, such as a software-defined networking (SDN) controller, is a centralized entity that manages flow control to the networking devices. It is the “brain” of the network, maintaining a comprehensive view of the network and making decisions about where to send packets. The OpenFlow (OF) Protocol enables the controller to interact directly with the forwarding plane of network devices, such as switches and routers, both physical and virtual. An OF configuration refers to the setup and management of network behavior using the OpenFlow protocol within an SDN environment. It involves defining flow rules and actions to control how traffic is handled by network devices, usually managed centrally by an SDN controller. An OF configuration can include flow tables that contain rules for how packets should be handled. Each flow table contains a set of flow entries. The flow entry defines what to do with packets that match certain criteria. An entry can have three parts: match fields, actions, and counters. The match fields define packet attributes to match, such as source/destination Internet Protocol (IP) addresses, Media Access control (MAC) addresses, port numbers, VLAN tags, etc. The Actions can define what to do with a matching packet, such as forwarding it to a specific port, modifying fields in the packet, or dropping it. The counters can be used to keep track of the number of packets and bytes for each flow. The network controller can use control messages to manage flow entries in the switches. It can add, update, or delete flow entries. Optional configurations can include group tables for more advanced forwarding actions like multicasting, load balancing, etc. It should be noted that OVS is one type of virtual switch technology, but there are other virtual switch technologies, such as SDN-based switches.

An OVS bridge acts like a virtual network switch at the software level, allowing multiple network interfaces to be connected and managed as if they were ports on a physical switch. The OVS bridge can enable the creation and management of virtual networks within a server or across multiple servers in a data center or cloud environment. An OVS bridge connects virtual and physical network interfaces, facilitating communication between them. This can include interfaces from VMs, containers, physical network interfaces, or even other virtual bridges. Similar to a physical Ethernet switch, an OVS bridge operates at Layer 2 (L2) of the Open Systems Interconnection model (referred to as the OSI model), forwarding, filtering, and managing traffic based on Media Access Control (MAC) addresses. An OVS bridge can support advanced features such as virtual local area network (VLAN) tagging, Quality of Service (QOS), traffic mirroring, and Access Control Lists (ACLs), among others. An OVS bridge can be controlled by a controller using protocols like OpenFlow (OF), allowing for dynamic and programmable network configurations.

Some aspects and embodiments of the present disclosure are described herein with respect to OVS and include terminology that is specific to OVS and OpenFlow. However, some aspects and embodiments of the present disclosure can be used in other virtual switching and bridging technologies. Similarly, various embodiments are described in the context of a DPU, but can also be used in other virtual switch environments, including virtual bridges, switches, network interface cards (NICs) (also referred to as network interface controller), smart NICs, network interface devices, network switches, network adapters, intelligence processing units (IPUs), or other specialized computing devices designed to offload specific tasks from the CPU of a computer or server.

DPUs are specialized semiconductor devices designed to offload and accelerate networking, security, and storage tasks that traditionally run on server CPUs. By taking over these functions, DPUs aim to significantly improve overall data center efficiency and performance. They are equipped with their own processors and memory, enabling them to handle complex data processing tasks independently of the host CPU. DPUs are embedded into the data center infrastructure, where they manage data movement and processing across networks, freeing up CPU resources to focus more on application and workload processing. This architectural shift allows for increased workload density, improved data throughput, and enhanced security measures at the hardware level. DPUs play a pivotal role in software-defined networking (SDN), providing hardware acceleration for advanced functions such as encryption, traffic management, and virtualization. By optimizing these crucial operations, DPUs contribute to the creation of more agile, secure, and efficient data centers.

IPUs are specialized hardware accelerators designed to optimize the performance of machine learning algorithms and artificial intelligence (AI) workloads. Unlike general-purpose CPUs or Graphics Processing Units (GPUs) which are versatile but may not be optimized for AI tasks, IPUs are engineered specifically to handle the high computational demands and data throughput requirements of deep learning models and neural network processing. They achieve this by implementing highly parallel computation architectures and memory systems that can efficiently process the large volumes of data associated with AI applications. IPUs aim to reduce the latency and increase the speed of AI computations, enabling more complex models to be trained more quickly and efficiently.

Smart NICs are advanced network interface cards equipped with built-in processing power to offload networking tasks from the CPU, thereby enhancing the efficiency and performance of data processing within servers. Unlike traditional NICs, which primarily serve as conduits for data between servers and networks, Smart NICs can execute a wide range of network functions directly on the card, such as traffic management, encryption/decryption, and network virtualization tasks. These capabilities allow Smart NICs to significantly reduce CPU load, freeing up resources to improve the overall processing capabilities of the server for application workloads. By handling complex networking functions, Smart NICs can lead to lower latency and higher throughput in data center environments, making them particularly valuable in scenarios requiring real-time processing and high-speed networking, such as cloud computing, high-performance computing (HPC), and enterprise data centers. The intelligence and programmability of Smart NICs provide a flexible solution to meet the evolving demands of modern networking infrastructures, contributing to more efficient and customizable networking operations.

### NPAL Split Interfaces

As described above, the NPAL is a powerful accelerated network pipeline for building flexible, scalable, and maintainable database-driven applications, offering a level of abstraction that simplifies database interactions and promotes code efficiency and portability. Aspects and embodiments of the present disclosure can provide a NPAL that supports hardware and software port splitting. The physical ports can be physically split into multiple ports, which required advanced software to support it. Splitting a host's NIC physical port into multiple ports (also known as port splitting or physical NIC port breakout) involves taking a single high-bandwidth physical NIC port and splitting it into multiple, lower-bandwidth logical or physical ports. This can be done at the physical level or via software configuration. There are multiple use cases and advantages for splitting NIC physical ports, especially in environments where network bandwidth and redundancy requirements vary.

One use case for splitting NIC physical ports include bandwidth optimization and efficient resource usage, network redundancy and high availability. When a system has a high-speed NIC (e.g., 100 Gbps), many workloads or applications may not need the full bandwidth of the NIC. In such cases, splitting a 100 Gbps port into four 25 Gbps ports, for example, allows the host to make more efficient use of available bandwidth. This is especially useful in cases where multiple applications or services have varying bandwidth requirements but do not need the full capacity of a single port.

Another use case and advantage for splitting NIC physical ports include network redundancy and high availability. Splitting a NIC's physical port into multiple ports allows for better redundancy and failover. By having multiple physical links, an operator can configure active-active or active-backup redundancy strategies. This setup ensures that if one link fails, traffic can be rerouted through another, enhancing reliability and uptime.

Another use case and advantage for splitting NIC physical ports include better network segmentation and isolation. By physically splitting a NIC port, different physical interfaces can be dedicated for different types of traffic (e.g., management, production, backup). This physical isolation improves security by preventing traffic from one network type (e.g., management traffic) from mixing with another type (e.g., production traffic).

Another use case and advantage for splitting NIC physical ports include increased port density. Splitting physical NIC ports increases the overall port density available to the host without requiring additional NIC hardware. If the number of available PCIe slots in the server is limited, splitting one high-speed port into multiple lower-speed ports helps maximize the number of network connections available to the host.

Another use case and advantage for splitting NIC physical ports include cost savings. Splitting a physical NIC port into multiple logical ports reduces the need for purchasing additional physical NICs. Instead of buying additional NIC cards to provide more network ports, the host can split an existing port to achieve the same result at a lower cost.

Another use case and advantage for splitting NIC physical ports include enhanced control and traffic shaping. With split physical ports, different levels of priority or apply traffic shaping policies can be applied to each port individually. This is useful in environments where different services need different levels of Quality of Service (QOS) or bandwidth control.

Another use case and advantage for splitting NIC physical ports include multi-homing and diverse paths. Splitting a NIC port allows a server to be multi-homed with different uplinks to separate networks. This can improve fault tolerance and provide diverse paths for outbound and inbound traffic, ensuring better load balancing and failover mechanisms.

When a NIC's physical port is split into multiple ports, it results with multiple Physical Functions (PFs) being created for the host. Each PF can be managed independently by the host operating system. This can lead to improved resource allocation. Each PF acts like a separate NIC interface, which means you can allocate resources (e.g., bandwidth, CPU, memory) more efficiently across the system. Multiple PFs can ensure that specific applications or virtual machines (VMs) have dedicated resources and are not competing for the same network interface, improving performance isolation. Also, with multiple PFs, network administrators can assign different policies and configurations to each PF. This could include VLAN tagging, firewall rules, or QoS settings for different workloads, traffic types, or security zones. In addition, when splitting a physical NIC into multiple PFs, Single Root I/O Virtualization (SR-IOV) can be used to assign each PF to a different VM or container. SR-IOV enables near-native I/O performance by allowing VMs to bypass the hypervisor for network communication, reducing latency and increasing throughput.

To support NIC/DPU port splitting, the NIC/DPU needs both hardware (HW) and software (SW) support. From the HW perspective, special cables are needed to split the physical port physically. The cables are called breakout cables. In high-speed networking environments, especially in data centers, it is common to use breakout cables that allow a single high-speed port (such as 40 Gbps or 100 Gbps) to be “split” into multiple lower-speed ports (e.g., 4×10 Gbps or 4×25 Gbps). These cables physically separate the data streams and allow multiple devices or ports to connect to a single high-speed interface. From SW perspective, the NIC/DPU needs to support port splits in all software stacks, including the NIC/DPU firmware (FW), drivers, a virtual switch, and the NPAL on top of the virtual switch. In general, the FW and driver can present multiple physical functions (PFs) to the virtual switch and the NPAL. The NPAL can be used to configure different policies to different PFs, isolate networking between PFs, have better resource utilization and eventually support multiple PFs instead of one or two. As described herein, the NPAL includes set of tables in specific order and logic which is optimized to be accelerated by NIC/DPU HW, providing customers and users rich set of capabilities and high performance. Once the physical port is split into multiple logical ports, the network pipeline can send network traffic data to any PF as part of the output port logic. Also, the network pipeline can be configured with different policies per PF, like different QOS or different traffic management.

### NPAL Fast Link Recovery

Aspects and embodiments of the present disclosure can provide a NPAL that provides an optimized network pipeline that supports fast link recovery when there is a link failure and an Equal-Cost Multi-Path (ECMP) group needs to be updated to reflect a new network topology. Link failure in network topologies refers to a situation where a communication link between two network devices, such as routers, NICs, switches, or hosts, becomes unavailable due to various reasons such as hardware failure, cable disconnection, or network congestion. Link failures can significantly impact the performance, availability, and reliability of network services, especially in large-scale or critical environments like data centers or enterprise networks. The are several reasons which might cause link failure, such as physical link failures (e.g., damage or disconnection of cables due to fiber cuts, broken Ethernet cables, etc.), device failures (e.g., hardware failures causing interfaces to go down), congestion or overload (i.e., network links overloaded with too much traffic causing timeouts or packet drops), software bugs or misconfigurations that cause a network device to drop connections, power failures, maintenance activities (e.g., planned outages for maintenance or upgrades might also cause temporary link failures), or the like.

There can be different implications for link failures. When a link goes down, packets that were being transmitted over that link are lost. This can result in transmission delays and affect real-time applications (e.g., VOIP, streaming). Connections between devices relying on the failed link will become unavailable until rerouting occurs. With the link down, traffic may need to be routed through alternative, longer paths that introduce higher latency, negatively impacting application performance. If the failed link were part of a redundant configuration (like in ECMP, Spanning Tree Protocol (STP), or dual-homed devices), traffic could be rerouted to an alternate link. However, this can result in a reduced level of redundancy. In networks running dynamic routing protocols (e.g., Open Shortest Path First (OSPF), Border Gateway Protocol (BGP), Intermediate System to Intermediate System (IS-IS)), when a link fails, the network must re-converge by recalculating new routes. This convergence can take time, during which the affected parts of the network may be unreachable. Rerouting traffic from a failed link may lead to congestion on alternative paths if the rerouted traffic exceeds the capacity of those paths. Mission-critical applications, like financial services or online gaming, may experience downtime or degraded performance due to a link failure. TCP connections may experience retransmissions, which can increase latency, while UDP connections may suffer from data loss without retries. Point-to-point communication may stop altogether until the network converges or the failed link is restored, potentially causing outages. Services relying on high availability (HA) solutions may be impacted if there is no failover path or the failover mechanism takes too long to activate.

One routing strategy is called ECMP. ECMP is a routing strategy that allows multiple forwarding paths for a packet towards a destination when multiple paths have the same routing cost (or metric). By leveraging ECMP, networks can balance traffic across multiple paths, increase bandwidth utilization, improve redundancy, and provide fault tolerance. Due to the implications for link failure mentioned above, it is important to have fast recovery when link goes down. In particular, when link goes down, an ECMP group must be updated immediately to reflect that a specific link is no longer available. Also, when link goes up, the ECMP group must be updated immediately with the recovered link to allow better network utilization.

As described below in more detail, the NPAL can operate as an accelerated network pipeline and virtual switching hardware offload mechanism that periodically monitors links. In at least one embodiment, a user can configure the NPAL to support fast link recovery, enabling link monitoring by the virtual switch. For example, all ports in a specific ECMP group can be monitored using inter-process communication (IPC) messages, such as Linux Netlink messages from a Linux kernel.

If a link goes down (i.e., experiences a link failure), the virtual switch identifies the link as being down and updates the ECMP group immediately by removing the link from the ECMP group. That is, the virtual switch updates the ECMP group in the tables in a bridge and/or a router of the network pipeline to remove the failed link. Once the ECMP group is updated, the traffic can be distributed to other links in the ECMP group.

If a link goes up (i.e., no longer experiences a link failure), the virtual switch identifies the link as being up and updates the ECMP group immediately by adding the link from the ECMP group. That is, the virtual switch updates the ECMP group in the tables in the bridge and/or the router of the network pipeline to add the recovered link (also referred to as a new link). Once the ECMP group is updated, the traffic can be distributed to the new link along with the other links in the ECMP group.

Hardware-accelerated Policy-Based Routing (PBR) over SFC

Aspects and embodiments of the present disclosure can provide hardware-accelerated Policy-Based Routing (PBR) over SFC architecture of a DPU. Using an SFC on the DPU, a user (or controller) can add different PBR policies, which are accelerated by DPU hardware as single data plane on the DPU.

As described above, a DPU can provide accelerated networking services (also referred to as HBN service or network service) to one or more host devices. The DPU network services can be used for accelerating L2 protocols, L3 protocols, tunneling protocols, or the like, on the DPU hardware. The network service infrastructure is based on SFC topology, where a first virtual bridge (e.g., Open vSwitch (OVS) bridge) is controlled by the network service, providing all accelerated networking capabilities, and a second virtual bridge (e.g., OVS bridge) is programmable by a user or any other controller. The network service can support different protocols and different network capabilities, such as ACLs, ECMP, tunneling, CT, QOS, STP, VLAN mapping, NATs, SDN, MPLS, etc.

Policy-Based Routing (PBR) is a technique that allows network administrators to make routing decisions based on policies set by the network administrator, rather than relying on the default routing table, which uses destination IP addresses to determine the next hop. With traditional routing, a router decides how to forward packets based on the destination IP address and the routing table. PBR allows the router to make routing decisions based on other criteria, such as: Source IP address or subnet; IP protocol type; Port number; Ingress interface; Packet size, QoS parameters, etc. PBR is useful for controlling the path that traffic takes through a network. It gives network administrators greater flexibility to implement routing rules that depend on more than just the destination IP address.

Common use-cases for PBR include traffic engineering, load balancing, network preference, security and compliance, QoS, or the like. For example, a network administrator may want to route specific types of traffic over a preferred or more optimal path to achieve better performance. PBR can be used to distribute traffic across multiple network links to balance the load on network resources. PBR can be used to route traffic destined for certain websites (e.g., YouTube or Netflix) over a less expensive internet connection, while routing critical business applications over a more reliable or faster connection (e.g., MPLS). PBR can be used to enforce security policies by ensuring traffic from specific users or networks is routed through security devices such as firewalls or IDS. PBR can be used to help enforce Qos policies by routing traffic based on certain QoS markings.

PBR typically works by providing a policy definition. The policy definition is a set of rules or conditions that are used to classify the traffic. These rules typically match on criteria such as source address, destination address, protocol type, or port number. The defined policy is applied to incoming traffic on a specific interface for policy enforcement. When a packet arrives on that interface, the router checks if the packet matches the conditions defined in the policy. For data path traffic routing according to the policy, if the packet matches the policy, it is routed according to the policy's routing table or next-hop information, rather than the default routing table. Below are some PBR examples:

### Example 1: Match Source IP and Set Next Hop

Match: SRC_IP=1.1.1.1
Action: Next_Hop=2.2.2.2

### Example 2: Match Protocol (HTTP) and Route Through a Specific Interface

Match: PROTOCOL=TCP
Action: OUTPUT_PORT=PORT1.

### Example 3: Match Ingress Interface and Mark for QoS

Match: INGRESS_INTERFACE=PORT1
Action: SET_QOS=VALUE1

In particular, the user (or controller) can program a PBR policy over the SFC in parallel to network service, which will result with a single accelerated data plane by the virtual switch and the DPU hardware. That us, the PBR policy can be accelerated with the existing networking rules in the network service in the single accelerated data plane. As described above, the hardware-accelerated service of the DPU can include an OVS infrastructure (e.g., OVS-DOCA technology) to configure and use the hardware offload mechanisms and application techniques to generate a combined set of network rules that is used by the acceleration hardware engine to process network traffic data in a single accelerated data plane. Using a defined SFC infrastructure in a configuration file, users and customers can leverage the DPU as a networking accelerator on an edge device without the need for sophisticated and smart switches in different network topologies in data center (DC) networks and in Service Provider (SP) networks.

### NPAL Emulation

Aspects and embodiments of the present disclosure can provide NPAL emulation. In general, emulation involves replicating the behavior of one system on another system. The goal of emulation is to make the second system behave as if it were the original, often to replace or recreate the original system's environment. NPAL emulation is used to provide a simulated network pipeline rather than a real hardware device running NPAL. In particular, NPAL emulation is used to simulate a DPU running a network service with NPAL along with full DPU environment, including virtual bridge, SFC, etc. To support an emulated NPAL with networking services and full environment including a virtual switch and SFC, a software-based module can be used to support all the different components, such as a network service, NPAL (used by the network service), a virtual bridge, SFC, etc. Each of these components are implemented in software to emulate the exact same behavior as a real hardware device with a hardware-accelerated network pipeline as described herein. The emulated network pipeline can be similar to the hardware network pipeline described herein.

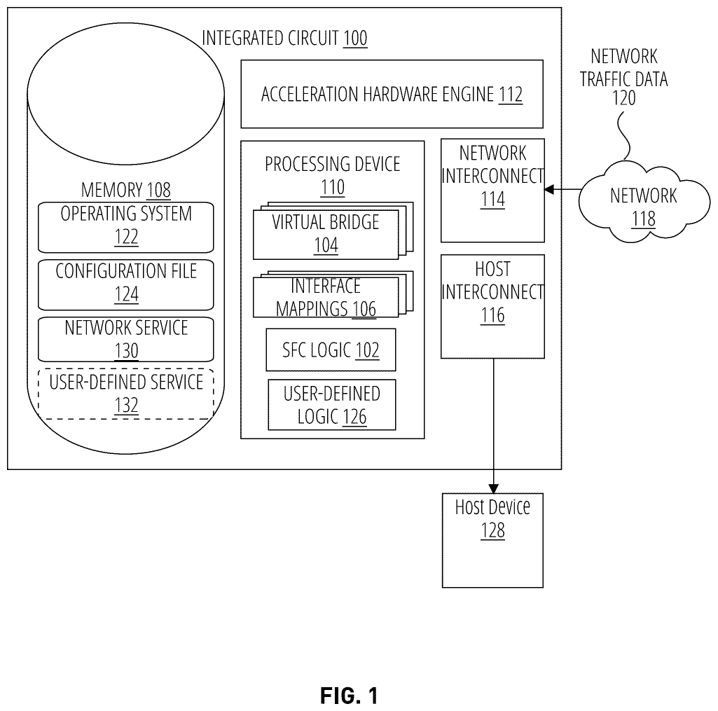

FIG. 1 is a block diagram of an integrated circuit 100 with an SFC logic 102 for generating virtual bridges 104 and interface mappings 106 in an SFC architecture according to at least one embodiment. The integrated circuit 100 can be a DPU, a NIC, a Smart NIC, a network interface device, or a network switch. The integrated circuit 100 includes a memory 108, a processing device 110, acceleration hardware engine 112, a network interconnect 114, and a host interconnect 116. The processing device 110 is coupled to the memory 108, the acceleration hardware engine 112, the network interconnect 114, and the host interconnect 116. The processing device 110 hosts the virtual bridges 104 generated by the SFC logic 102. A virtual bridge 104 (also referred to as a virtual switch) is software that operates within a computer network to connect different segments or devices, much like a physical network bridge, but in a virtualized environment. It is a core component in network virtualization, enabling the connection of virtual machines (VMs), containers, and other virtual network interfaces to each other and to the physical network, simulating traditional Ethernet network functions purely in software. Virtual bridges 104 allow for the creation and management of isolated network segments within a single physical infrastructure, facilitating communication, enforcing security policies, and providing bandwidth management, all while offering the flexibility and scalability needed in dynamic virtualized and cloud environments. The virtual bridges 104 can be Open vSwitch (OVS) bridges. An OVS bridge functions as a virtual switch at the heart of the Open vSwitch architecture, enabling advanced network management and connectivity in virtualized environments. It operates by aggregating multiple network interfaces into a single logical interface, managing the traffic flow between VMs on the same physical host, as well as the external network. Unlike traditional virtual bridges, the OVS bridge supports a wide array of networking features, such as VLAN tagging, traffic monitoring with sFlow and NetFlow, Quality of Service (QOS), and Access Control Lists (ACLs), offering enhanced flexibility and control for network administrators. The OVS bridge efficiently directs network traffic, based on pre-defined policies and rules, providing an essential tool for building complex, multi-tenant cloud and data center networks.

In particular with respect to FIG. 1, the virtual bridges 104 can provide network connectivity between VMs executed on the same integrated circuit 100 or a separate host device, containers, and/or physical devices. In short, the virtual bridges 104 allows VMs on a single physical host to communicate with each other and with the external network 118. The virtual bridges 104 can emulate the functionality of a physical network switch but operates at a software level within the integrated circuit 100. The virtual bridges 104 can manage network traffic data 120, directing data packets between VMs on the same host or between VMs and the physical network using ports. These ports can be configured for various policies like security settings, QoS rules, etc. The virtual bridges 104 can segment network traffic to provide isolation between different virtual networks. The virtual bridges 104 can provide an interface between the virtualized environment and the physical network, allowing VMs to communicate outside their host. The virtual bridges 104 can support standard networking protocols and features, such as VLAN tagging, Layer 2 (L2) forwarding, Layer 3 (L3) capabilities, tunneling protocols (e.g., Virtual Extensive LAN (VXLAN), Generic Routing Encapsulation (GRE), and the Geneve protocol), flow-based forwarding, OpenFlow Support, integration with virtualization platforms (e.g., VMware, KVM, Xen, and others, enabling network connectivity for virtual machines and containers), extensibility, traffic monitoring and mirroring, security, multi-platform support (e.g., Linux, FreeBSD, Windows, etc.), and the like. For Layer 2 Switching, one or more of the virtual bridges 104 acts as a Layer 2 Ethernet switch, enabling the forwarding of Ethernet frames between different network interfaces, including virtual and physical ports. For Layer 3 Routing, one or more of the virtual bridges 104 supports Layer 3 IP routing, allowing it to route traffic between different IP subnets and perform IP-based forwarding. The virtual bridges 104 can support VLAN tagging and allow for the segmentation of network traffic into different VLANs using VLAN tagging. The virtual bridges 104 can use flow-based forwarding where network flows are classified based on their characteristics, and packet forwarding decisions are made based on flow rules, as well as enforce security policies and access control. OVS is commonly used in data center and cloud environments to provide network agility, flexibility, and automation. It plays a vital role in creating and managing virtual networks, enabling network administrators to adapt to the changing demands of modern, dynamic data centers.

In at least one embodiment, the virtual bridges 104 can use the OVS and OF technologies. The virtual bridges 104 can be controlled by a network controller (also referred to as a network service) to make decisions about how traffic should be routed through the network. As described herein, a network controller (e.g., SDN controller) is a centralized entity that manages flow control to the networking devices. The OF protocol can be used to interact directly with the forwarding plane of network devices, such as virtual or physical switches and routers. In at least one embodiment, the virtual bridges 104 can use flow tables that contain rules for how packets should be handled. Each flow table contains a set of flow entries. The flow entry defines what to do with packets that match certain criteria. An entry can have three parts: match fields, actions, and counters. The match fields define packet attributes to match, such as source/destination Internet Protocol (IP) addresses, Media Access control (MAC) addresses, port numbers, VLAN tags, etc. The actions can define what to do with a matching packet, such as forwarding it to a specific port, modifying fields in the packet, or dropping it. The counters can be used to keep track of the number of packets and bytes for each flow. Since the virtual bridges 104 is virtualized, the virtual bridges 104 can create rules at a software level, a data path (DP) level, and at a hardware level. A rule created at the software level is referred to as a software (SW) rule or an OF rule. A rule created at the DP level is referred to as a DP rule. A rule created at the hardware level is referred to as a hardware (HW) rule. When a SW rule is created, corresponding DP and HW rules are created. A network controller can add, update, or delete flow entries, changing the configuration settings.

In another embodiment, the virtual bridges 104 is a Standard Virtual Switch or a Distributed Virtual Switch. In another embodiment, the virtual bridges 104 is an SDN-based switch that is integrated with an SDN controller. The integrated circuit 100 can be used in data centers, cloud computing environments, development and testing environments, network function virtualization (NFV) environments, or the like. The virtual bridges 104 can be used in a data center where server virtualization is common to facilitate communication within and between servers efficiently. The virtual bridges 104 in the cloud computing environment can enable multi-tenant networking, allowing different clients to have isolated network segments. The virtual bridges 104 can allow network function virtualizations (e.g., NFVs) to be connected and managed within virtual infrastructures. Some advantages of the virtual bridges 104 is that the virtual bridges 104 can be easily configured or reconfigured without physical intervention, can reduce the need for physical network hardware and associated maintenance, offers the ability to create isolated networks for different applications or tenants. In summary, the virtual bridges 104 is a software-based device that performs the networking functionalities of a physical switch in a virtualized environment (e.g., data centers and cloud computing environments) and provides flexibility, isolation, and efficient network management in the virtualized environment.

In at least one embodiment, the integrated circuit 100 can also host one or more hypervisors and one or more virtual machines (VMs). The network traffic data 120 can be directed to the respective VM by the virtual bridges 104.

During operation, the SFC logic 102 can use a configuration file 124 to generate the virtual bridges 104 and interface mappings 106 between the virtual bridges 104, the network interconnect 114, and the host interconnect 116. The configuration file 124 can specify the virtual bridges 104, the interface mappings 106, and the configurations for each. The SFC logic 102 can generate, according to the configuration file 124, a first virtual bridge and a second virtual bridge, the first virtual bridge to be controlled by a first network service 130 hosted on the integrated circuit 100 and the second virtual bridge to be controlled by a user-defined logic 126. The SFC logic 102 can add one or more host interfaces to the second virtual bridge, a first service interface to the first virtual bridge to operatively couple to the first network service 130. The SFC logic 102 can add one or more virtual ports between the first virtual bridge and the second virtual bridge.

In at least one embodiment, the user-defined logic 126 is part of a user-defined service 132, such as a user-defined network service, hosted on the 100. The SFC logic 102 can add, according to the configuration file 124, a second service interface to the second virtual bridge to operatively couple to the user-defined service 132. The user-defined service 132 can be a user-defined security service, a user-defined telemetry service, a user-defined storage service, or the like.

In at least one embodiment, the integrated circuit 100 stores an operating system 122 (OS 122) in memory 108. The integrated circuit 100 can execute on the processing device 110. In at least one embodiment, the SFC logic 102 generates the virtual bridges 104 and the interface mappings 106 as part of installation of the OS 122 on the integrated circuit 100. In another embodiment, the SFC logic 102 can generate the virtual bridges 104 and the interface mappings 106 as part of runtime of the integrated circuit 100 and without reinstallation of the OS 122 on the integrated circuit 100. In at least one embodiment, the SFC logic 102 can configure, according to the configuration file 124, configure an OS property (e.g., page size), associated with the OS 122, in one of the virtual bridges 104.

In at least one embodiment, the SFC logic 102 can perform and facilitate operations for identifying a change to a configuration setting of the virtual bridges 104 in the configuration file 124 (or a new configuration file). The SFC logic 102 can configure the virtual bridges 104 and interface mappings 106, accordingly, during installation or during runtime and without reinstallation of the operating system 122.

As illustrated in FIG. 1, the SFC logic 102 is implemented in the integrated circuit 100 with memory 108, processing device 110, the acceleration hardware engine 112, the network interconnect 114, and the host interconnect 116. In other embodiments, the SFC logic 102 can be implemented in processors, computing systems, CPUs, DPUs, smart NICs, IPUs, or the like. The underlying hardware can host the virtual bridges 104 and interface mappings 106.

In at least one embodiment, the integrated circuit 100 can be deployed in a Data Center (DC) network or a Service Provider (SP) network. A data center (DC) network is the foundational infrastructure that facilitates communication, data exchange, and connectivity between different computational resources, storage systems, and networking devices within a data center. It is designed to support high-speed data transmission, reliable access to distributed resources, and efficient management of data flows across various physical and virtual platforms. At its core, a DC network integrates a multitude of switches, routers, firewalls, and load balancers, orchestrated by advanced networking protocols and software-defined networking (SDN) technologies to ensure optimal performance, scalability, and security. The architecture of a DC network typically includes both the physical backbone, with high-capacity cables and switches ensuring bandwidth and redundancy, and the virtual overlay, which enables flexibility, quick provisioning, and resource optimization through virtual networks. A well-designed DC network supports a range of applications, from enterprise services to cloud computing and big data analytics, by providing the infrastructure to handle the massive amounts of data, complex computations, and application workloads typical of modern data centers. It plays a crucial role in disaster recovery, data replication, and high availability strategies, ensuring that data center services remain resilient against failures and efficient under varying loads. A Service Provider (SP) network refers to the expansive, high-capacity communication infrastructure operated by organizations that offer various telecommunications, internet, cloud computing, and digital services to businesses, residential customers, and other entities. These networks are engineered to provide wide-ranging coverage, connecting numerous geographical locations, including urban centers, remote areas, and international destinations, to facilitate global communication and data exchange. The architecture of an SP network is multi-layered, incorporating a mix of technologies such as fiber optics, wireless transmission, satellite links, and broadband access to achieve widespread connectivity. Central to these networks are high-performance backbone networks, which are responsible for the high-speed transmission of massive volumes of data across long distances. On top of the physical infrastructure, SP networks deploy advanced networking technologies, including MPLS, software-defined networking (SDN), and network function virtualization (NFV), to enhance the efficiency, flexibility, and scalability of service delivery. Service Provider networks are designed to support a vast array of services, from conventional voice and data services to modern cloud-based applications and streaming services, addressing the evolving demands of consumers and businesses alike. They are crucial for the implementation of the internet, mobile communications, enterprise networking solutions, and the emerging Internet of Things (IoT) ecosystem, ensuring connectivity and accessibility to digital resources and services on a global scale.

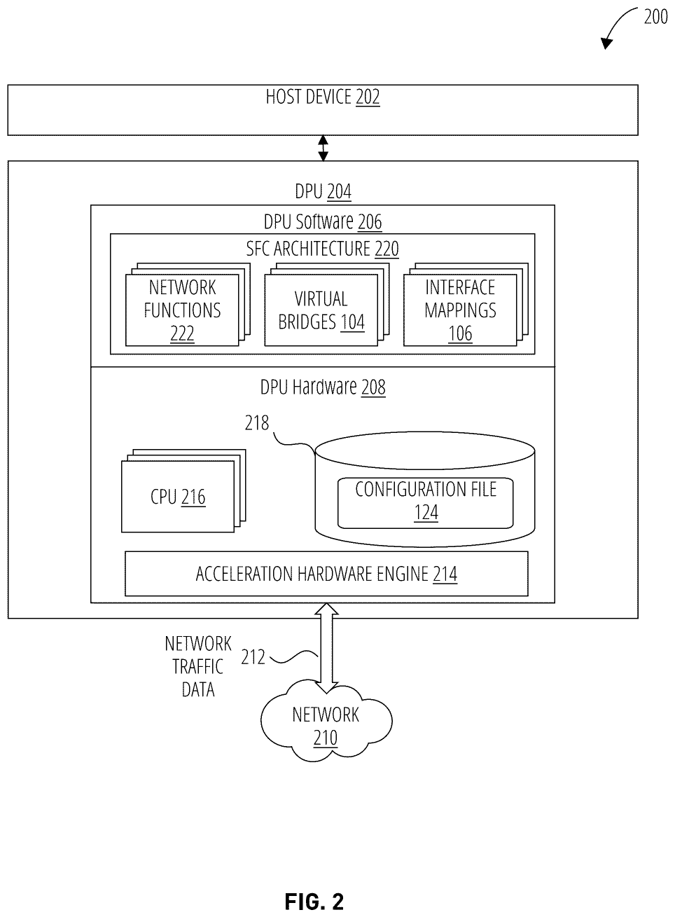

In at least one embodiment, the virtual bridges 104 and interface mappings 106 are part of a service function chaining (SFC) architecture implemented in at least one of a DPU, a NIC, a smart NIC, a network interface device, or a network switch. In at least one embodiment, the SFC logic 102 can be implemented as part of a hardware-accelerated service on an agentless hardware product, such as a DPU, as illustrated and described below with respect to FIG. 2. That is, the integrated circuit 100 can be a DPU. The DPU can be a programmable data center infrastructure on a chip. The hardware-accelerated service can be part of the NVIDIA OVS-DOCA, developed by Nvidia Corporation of Santa Clara, California. OVS-DOCA, which is the new OVS infrastructure for DPU, is based on the open-source OVS with additional features, new acceleration capabilities, and the OVS backend is purely DOCA based. Alternatively, the SFC logic 102 can be part of other services.

### Service Function Chaining (SFC) Infrastructures

SFC infrastructure refers to the networking architecture and framework that enables the creation, deployment, and management of service chains within a network. Service function chaining is a technique used to define an ordered list of network services (such as firewalls, load balancers, and intrusion detection systems) through which traffic is systematically routed. This ordered list is known as a “chain,” and each service in the chain is called a “service function.” The SFC infrastructure is designed to ensure that network traffic flows through these service functions in a specified sequence, improving efficiency, security, and flexibility of network service delivery. An SFC infrastructure can include Service Function Forwarders, Service Functions (SFs), Service Function Paths (SFPs), etc. SFFs are the network devices responsible for forwarding traffic to the desired service functions according to the defined service chains. SFFs ensure that packets are directed through the correct sequence of service functions. SFs are the actual network services that process the packets. These can be physical or virtual network functions, such as firewalls, wide area network (WAN) optimizers, load balancers, intrusion detection/prevention systems, or the like. An SFP is the defined path that traffic takes through the network, including the specific sequence of service functions it passes through. SFPs are established based on policy rules and can be dynamically adjusted to respond to changing network conditions or demands. The SFC infrastructure can use one or more SFC descriptors, which are policies or templates that describe the service chain, including the sequence of service functions, performance requirements, and other relevant metadata. The SFC descriptor(s) can serve as a blueprint for the instantiation and management of service chains within the network. The SFC infrastructure can include a classification function that is responsible for the initial inspection and classification of incoming packets to determine the appropriate service chain to which the traffic should be steered. Classification can be based on various packet attributes, such as source and destination IP addresses, port numbers, and application identifiers. Often part of a larger software-defined networking (SDN) or NFV framework, one or more network controllers can manage the SFC infrastructure. They can be responsible for orchestrating and deploying service chains, configuring network elements, and ensuring the real-time adjustment and optimization of traffic flows. The SFC infrastructure offers numerous benefits, including enhanced network agility, optimized resource utilization, and improved overall security. By decoupling the network's control plane from the data plane and leveraging virtualization technologies, SFC infrastructures can dynamically adjust to the network's changing needs, enabling more efficient and scalable service delivery models. As illustrated and described with respect to FIG. 2, the SFC infrastructure can be deployed as a DPU-based SFC infrastructure 200.

FIG. 2 is a block diagram of an example DPU-based SFC infrastructure 200 for providing an SFC architecture 220 according to at least one embodiment. The DPU-based SFC infrastructure 200 includes a DPU 204 coupled between a host device 202 and a network 210. In at least one embodiment, the DPU 204 is a System on a Chip (SoC) that is considered a data center infrastructure on a chip. The DPU 204 is a specialized processor designed to offload and accelerate networking, storage, and security tasks from the central processing unit (CPU) of the host device 202, thus enhancing overall system efficiency and performance. The DPU 204 can be used in data centers and cloud computing environments to manage data traffic more efficiently and securely.

The DPU 204 can include a network interconnect (e.g., one or more Ethernet ports) operatively coupled to the network 210. The network interconnect can be high-speed network interfaces that enable them to connect directly to the data center network infrastructure. These interfaces can support various speeds (e.g., 10 Gbps, 25 Gbps, 40 Gbps, or higher), depending on the model and deployment requirements. The network 118 may include a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, and/or a combination thereof.

The DPU 204 can be coupled to a CPU of the host device 202 (or multiple host devices or servers) via one or more host interconnects (e.g., Peripheral Component Interconnect Express (PCIe)). PCIe provides a high-speed connection between the DPU 204 and the host device's CPU, allowing for the fast transfer of data and instructions. This connection is used for offloading tasks from the CPU and for ensuring that the DPU 204 can access system memory and storage resources efficiently. To enable communication between the host device 202 and the DPU 204, specialized software drivers and firmware are installed on the host device 202. These software components allow the host's operating system and applications to interact with the DPU 204, offloading specific tasks to it and retrieving processed data. In virtualized environments, the DPU 204 can also interface with hypervisors or container management systems. This allows the DPU to support multiple virtual machines (VMs) or containers by providing them with virtualized network functions, network isolation, and security features without burdening the host device's CPU. 4. The DPU 204 can utilize Direct Memory Access (DMA) to read from and write to the host device's memory directly, bypassing the CPU to reduce latency and free up CPU resources for other tasks. This enables efficient data movement between the host memory, the DPU 204, and the network 210. In at least one embodiment, the DPU 204 includes a direct memory access (DMA) controller (not illustrated in FIG. 2) coupled to a host interface. The DMA controller can read the data from the host's physical memory via a host interface. In at least one embodiment, the DMA controller reads data from the host's physical memory using the PCIe technology. Alternatively, other technologies can be used to read data from the host's physical memory. In other embodiments, the DPU 204 may be any computing system or computing device capable of performing the techniques described herein.

Once physically connected, the DPU 204 is configured to communicate with the network 210. This involves setting up IP addresses, VLAN tags (if using virtual networks), and routing information to ensure the DPU 204 can send and receive data packets to and from other devices on the network 210. As described herein, the DPU 204 executes network-related tasks, such as packet forwarding, encryption/decryption, load balancing, and Quality of Service (QOS) enforcement. By doing so, it effectively becomes an intelligent network interface controller with enhanced capabilities, capable of sophisticated data processing and traffic management.

In at least one embodiment, the DPU 204 includes DPU hardware 208 and DPU software 206 (e.g., software framework with acceleration libraries). The DPU hardware 208 can include one or more CPUs (e.g., a single-core or multi-core CPU), an acceleration hardware engine 214 (or multiple hardware accelerators), memory 218, and the network and host interconnects. In at least one embodiment, the DPU 204 includes DPU software 206, including software framework and acceleration libraries. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services.

In at least one embodiment, the memory 218 stores the configuration file 124. The 124 specifies the virtual bridges 104, the interface mappings 106 (host interfaces and network ports) between the virtual bridges 104, and the network functions 222 in the SFC architecture 220. For example, a CPU of the one or more CPU 216 can generate, according to the configuration file 124, a first virtual bridge and a second virtual bridge, the first virtual bridge to be controlled by a first network service hosted on the DPU 204 and the second virtual bridge to be controlled by a user-defined logic. The CPU can add, according to the configuration file, one or more host interfaces to the second virtual bridge, a first service interface to the first virtual bridge to operatively couple to the first network service, and one or more virtual ports between the first virtual bridge and the second virtual bridge. The SFC logic 102, as described above with respect to FIG. 1, can be implemented in the DPU software 206 to generate and manage the SFC architecture 220. The SFC logic 102 can leverage the acceleration hardware engine 214 (e.g., DPU hardware 208) to offload and filter network traffic data 212 based on predefined filters using the hardware capabilities of the acceleration hardware engine 214. The DPU hardware 208 can receive network traffic data 212 over the network ports from a second device (or multiple devices) on the network 210.

In at least one embodiment, the DPU software 206 can perform several actions when creating the virtual bridges 104 and the corresponding interface mappings 106 to ensure proper configuration and integration within the virtualized environment. The DPU software 206 can initialize the creation of a virtual bridge by allocating the resources and setting up the initial configuration parameters. These configurations can be stored in the configuration file 124. The configuration parameters can define the bridge name, network protocols to be supported, and any specific settings related to performance or security. A virtual network interface is created to act as the virtual bridge. This interface serves as the anchor point for all the virtual and physical interfaces that will be connected to the virtual bridge. The DPU software 206 can identify and link the designated physical (e.g., Ethernet ports) and virtual interfaces (e.g., virtual machine network adapters) to the newly created virtual bridge. This action involves configuring each interface's settings to ensure compatibility and optimal communication within the virtual bridge. The DPU software 206 can configure the networking protocols. Networking protocols and services, such as Spanning Tree Protocol (STP) for loop prevention, are configured on the virtual bridge. The DPU software 206 may also set up VLAN tagging for traffic segmentation, QoS policies for traffic prioritization, and security features like Access Control Lists (ACLs). The DPU software 206 can assign IP addresses to the bridge interfaces. If the virtual bridge acts as a layer 3 (L3) switch, the DPU software 206 assigns IP addresses to the bridge interface, enabling it to participate in IP routing between the different connected networks or devices. The DPU software 206 can provide a unified interface to allow for centralized control and monitoring of the network. Network administrators can manage the virtual bridge alongside other virtual network components through the unified interface. The DPU software 206 can enable monitoring and management features for the virtual bridge, allowing network administrators to observe traffic flow, identify potential issues, and make adjustments, as needed, to optimize network performance and security. Throughout these steps, the software ensures that the virtual bridge is seamlessly integrated into the existing network architecture, providing a flexible and efficient way to connect various network segments within virtualized environments.

In addition to generating the virtual bridges 104, the DPU software 206 can generate one or more virtual ports between the virtual bridges 104. A virtual port, often referred to as a patch port in the context of virtual networking, is a software-defined networking component that facilitates the connection and communication between different virtual devices or between virtual and physical devices within a network. Unlike physical ports on a network switch or router, virtual ports are not bound to a specific hardware interface; instead, they are created and managed through software, providing a flexible and efficient means to route traffic within virtualized environments. Virtual ports play a crucial role in creating complex network topologies within VMs, containers, and virtual networks. They can be used to configure virtual switches (vSwitches) or bridges, allowing virtual machines on the same host or across different hosts to communicate as if they were connected to the same physical network switch. Additionally, patch ports can connect virtual networks to physical networks, enabling VMs to access external network resources. The virtual ports can be dynamically created, configured, and deleted based on network requirements, making it easier to adapt to changes in the network topology or workload demands. By optimizing the use of underlying physical network infrastructure, virtual ports can help improve overall network efficiency, reducing the need for additional physical hardware. Virtual ports support advanced networking features like VLAN tagging, QoS settings, and ACL configurations, enabling precise management of network traffic. The virtual ports can also provide visibility into virtual network traffic, allowing for detailed monitoring, logging, and troubleshooting activities.

In addition to generating the virtual bridges 104, the DPU software 206 can configure link state propagation of the virtual bridges 104. Link propagation in the context of virtual bridges or virtual switches, such as Open vSwitch (OVS), refers to the process by which state changes in physical or virtual network interfaces are communicated across the network. This ensures that the entire network topology is aware of connectivity status and can adjust routing and switching behavior accordingly. Link propagation is used for maintaining the accuracy of the network's operational state, enabling efficient data flow, and ensuring high availability and reliability of network services. In OVS, OVS monitors the state of physical ports and virtual interfaces connected to it. This includes tracking when ports go up (become active) or down (become inactive) due to changes in the physical link status or virtual interface configuration. Upon detecting a change in the state of a port, OVS propagates this information throughout the network. This is done by sending notifications to relevant components within the network infrastructure, such as other switch instances, network controllers, or virtual machines connected to the virtual switch. Based on the propagated link state information, network devices and protocols can adjust their operation. This might involve recalculating routes, redistributing network traffic, or initiating failover procedures to alternative paths or interfaces to maintain network connectivity and performance. Link propagation helps maintain consistency across the network's view of the topology. By ensuring that all elements of the network have up-to-date information about link states, it enables coherent and coordinated network behavior, particularly in dynamic environments with frequent changes. OVS can integrate link propagation with standard network protocols and mechanisms, such as the Spanning Tree Protocol (STP) for loop prevention and the Link Layer Discovery Protocol (LLDP) for network discovery. This integration enhances the switch's ability to participate in a broader network ecosystem, conforming to and benefiting from established network management practices. Link propagation plays a foundational role in the adaptive and resilient behavior of networks utilizing virtual bridges or switches like OVS, ensuring that changes in the network infrastructure are quickly and accurately reflected across the entire network. This capability is especially important in virtualized and cloud environments, where the topology can be highly dynamic, and the efficiency and reliability of network connectivity are important.

In at least one embodiment, the DPU software 206 can configure link state propagation in a virtual bridge by setting up mechanisms to monitor and communicate the operational states of links (such as UP or DOWN) across the network. This allows the virtual bridge and its connected entities to dynamically adjust to changes in network topology, such as when interfaces are added, removed, or experience failures. The DPU software 206 can activate the monitoring capabilities on the virtual bridge for all connected interfaces, both physical and virtual. This typically includes enabling the detection of link status changes so that the bridge can identify when a port becomes active or inactive. Once monitoring is enabled, the system needs to be configured to notify the relevant components within the network about any changes. This might involve setting up event listeners or subscribers that can respond to notifications about link state changes. For virtual bridges managed by a controller (in SDN environments), this could also mean configuring the communication between the bridge and the controller to ensure it receives timely updates about the network state. Configuring link propagation also involves specifying the actions that should be triggered by changes in link states. For example, this could include automatically recalculating routing tables, redistributing traffic to available paths, or even triggering alerts and logging events for network administrators. The virtual bridge's forwarding database (FDB) or MAC table may need to be dynamically updated based on link state changes to ensure that traffic is efficiently routed within the network. This ensures that packets are not sent to interfaces that are down.

In at least one embodiment, the DPU software 206 can configure the virtual bridge to filter the network traffic data 212. For example, the configuration file 124 can specify what data should be extracted from the network traffic data 212 by the virtual bridge. The configuration file 124 can specify one or more filters that extract for inclusion or remove from inclusion specified types of data from the network traffic data 212. The network traffic that meets the filtering criteria can be structured and streamed to one of the network functions 222 for processing. For example, the configuration file 124 can specify that all HyperText Transport Protocol (HTTP) traffic be extracted from the network traffic data 212 and routed to one of the network functions 222. The configuration file 124 can specify that all traffic on specific ports should be extracted from the network traffic data 212 for processing by the network functions 222, which are described in more detail below.

As described herein, the SFC architecture 220 can provide support for different network protocols and capabilities in network functions 222. Different network protocols and capabilities serve as the backbone of modern networking, enabling a wide array of functionalities from basic connectivity to advanced security and traffic optimization. The network functions 222 can include network functions, including a set of tables and logic to perform the corresponding network function, such as ACL, ECMP routing, tunneling, Connection Tracking (CT), NAT, QOS, or the like. ACLs are a fundamental network security feature that allows or denies traffic based on a set of rules. These lists are applied to network interfaces, controlling the flow of packets either at the ingress or egress point. The rules can specify various parameters such as source and destination IP addresses, port numbers, and the protocol type to finely tune the traffic filtering process, enhancing security and compliance. ECMP is a routing strategy used to distribute outgoing network traffic across multiple paths that have the same cost. By balancing the load evenly across these paths, ECMP can significantly increase the bandwidth and reliability of the network. This protocol is particularly useful in data center and cloud environments, where high availability and scalability are important. Tunneling encapsulates one protocol or session inside another protocol, allowing data to traverse networks with incompatible address spaces or architectures. It is widely used in implementing Virtual Private Networks (VPNs), where secure tunnels over the internet enable private communications. Protocols like IPsec and GRE are common examples that facilitate tunneling for security and protocol encapsulation purposes. CT refers to the ability of a network device (such as a firewall or a router) to maintain the state information of network connections passing through it. This capability enables the device to make more informed decisions about which packets to allow or block, based on the context of the session to which they belong. CT is crucial for implementing stateful firewalls and NAT (Network Address Translation) functionalities. QoS capabilities refers to mechanisms that prioritize certain types of traffic to ensure the performance of applications, especially in congested network scenarios. The network functions 222 can include other types of network functions, such as Segment Routing (SR), Multiprotocol Label Switching (MPLS), Network Virtualization, Software-Defined Networking (SDN), or the like. SR enables the source of a packet to define the path that the packet takes through the network using a list of segments, improving the efficiency and flexibility of routing. MPLS is a method for speeding up and shaping network traffic flows, where data packets are labeled and quickly routed through pre-determined paths in the network. Network Virtualization involves abstracting physical network equipment and resources into a virtual network, allowing for more flexible and efficient resource management. Software-Defined Networking (SDN) decouples the network control and forwarding functions, enabling programmable network management and the efficient orchestration of network services. These protocols and capabilities represent just a fraction of the vast array of technologies that underlie modern networking, each playing a specific role in ensuring that data is transported efficiently, securely, and reliably across the digital infrastructure.

The integration of a DPU 204 into the network 210 and the host device 202 thus represents a powerful approach to optimizing data processing tasks, significantly enhancing the performance, and security of data center and cloud computing environments. By handling a substantial portion of the networking, storage, and security workload, the DPU 204 can enable CPUs to focus more on application processing, improving overall system efficiency and throughput. For example, the DPU 204 can handle network data path processing of network traffic data 212. The CPU can control path initialization and exception processing. The DPU 204 can be part of a data center and include one or more data stores, one or more server machines, and other components of data center infrastructure. It should be noted that, unlike a CPU or a GPU, the DPU 204 is a new class of programmable processor that combines three key elements, including, for example: 1) an industry-standard, high-performance, software-programmable CPU (single-core or multi-core CPU), tightly coupled to the other SoC components; 2) a high-performance network interface capable of parsing, processing and efficiently transferring data at line rate, or the speed of the rest of the network, to GPUs and CPUs; and 3) a rich set of flexible and programmable acceleration engines that offload and improve applications performance for AI and machine learning, security, telecommunications, and storage, among others. These capabilities can enable an isolated, bare-metal, cloud-native computing platform for cloud-scale computing. In at least one embodiment, DPU 204 can be used as a stand-alone embedded processor. In at least one embodiment, DPU 204 can be incorporated into a network interface controller (also called a Smart Network Interface Card (SmartNIC)) used as a server system component. A DPU-based network interface card (network adapter) can offload processing tasks that the server system's CPU normally handles. Using its processor, a DPU-based SmartNIC may be able to perform any combination of encryption/decryption, firewall, transport control protocol/Internet Protocol (TCP/IP), and HyperText Transport Protocol (HTTP) processing. SmartNICs can be used for high-traffic web servers, for example.

In at least one embodiment, DPU 204 can be configured for traditional enterprises' modern cloud workloads and high-performance computing. In at least one embodiment, DPU 204 can deliver a set of software-defined networking, storage, security, and management services at a data-center scale with the ability to offload, accelerate, and isolate data center infrastructure. In at least one embodiment, DPU 204 can provide multi-tenant, cloud-native environments with these software services. In at least one embodiment, DPU 204 can deliver data center services of up to hundreds of CPU cores, freeing up valuable CPU cycles to run business-critical applications. In at least one embodiment, DPU 204 can be considered a new type of processor that is designed to process data center infrastructure software to offload and accelerate the compute load of virtualization, networking, storage, security, cloud-native AI/ML services, and other management services.

In at least one embodiment, the DPU 204 can include connectivity with packet-based interconnects (e.g., Ethernet), switched-fabric interconnects (e.g., InfiniBand, Fibre Channels, Omni-Path), or the like. In at least one embodiment, DPU 204 can provide a data center that is accelerated, fully programmable, and configured with security (e.g., zero-trust security) to prevent data breaches and cyberattacks. In at least one embodiment, the DPU 204 can include a network adapter, an array of processor cores, and infrastructure offload engines with full software programmability. In at least one embodiment, the DPU 204 can sit at an edge of a server to provide flexible, secured, high-performance cloud and AI workloads. In at least one embodiment, the DPU 204 can reduce the total cost of ownership and increase data center efficiency. In at least one embodiment, the DPU 204 can provide the software framework and acceleration libraries (e.g., NVIDIA DOCA™) that enable developers to rapidly create applications and services for the DPU 204, such as security services, virtualization services, networking services, storage services, AI/ML services, and management services. In at least one embodiment, the software framework and acceleration libraries make it easy to leverage hardware accelerators of the DPU 204 to provide data center performance, efficiency, and security. In at least one embodiment, the DPU 204 can be coupled to a GPU. The GPU can include one or more accelerated AI/ML pipelines.

In at least one embodiment, the DPU 204 can provide networking services with a virtual switch (vSwitch), a virtual router (vRouter), network address translation (NAT), load balancing, and network virtualization (NFV). In at least one embodiment, the DPU 204 can provide storage services, including NVME™ over fabrics (NVMe-oF™) technology, elastic storage virtualization, hyper-converged infrastructure (HCl) encryption, data integrity, compression, data deduplication, or the like. NVM Express™ is an open logical device interface specification for accessing non-volatile storage media attached via the Peripheral Component Interconnect Express® (PCIe) interface. NVMe-oF™ provides an efficient mapping of NVMe commands to several network transport protocols, enabling one computer (an “initiator”) to access block-level storage devices attached to another computer (a “target”) very efficiently and with minimum latency. The term “Fabric” is a generalization of the more specific ideas of network and input/output (I/O) channel. It essentially refers to an N: M interconnection of elements, often in a peripheral context. The NVMe-oF™ technology enables the transport of the NVMe command set over a variety of interconnection infrastructures, including networks (e.g., Internet Protocol (IP)/Ethernet) and I/O Channels (e.g., Fibre Channel). In at least one embodiment, the DPU 204 can provide hardware-accelerated services using Next-Generation Firewall (NGFW), Intrusion Detection Systems (IDS), Intrusion Prevention System (IPS), a root of trust, micro-segmentation, distributed denial-of-service (DDoS) prevention technologies, and ML detection. NGFW is a network security device that provides capabilities beyond a stateful firewall, like application awareness and control, integrated intrusion prevention, and cloud-delivered threat intelligence. In at least one embodiment, one or more network interfaces can include an Ethernet interface (single or dual ports) and an InfiniBand interface (single or dual ports). In at least one embodiment, the one or more host interfaces can include a PCIe interface and a PCIe switch. In at least one embodiment, the one or more host interfaces can include other memory interfaces. In at least one embodiment, the CPU can include multiple cores (e.g., up to 8 64-bit core pipelines) with L2 cache per two one or two cores and L3 cache with eviction policies support for double data rate (DDR) dual in-line memory module (DIMM) (e.g., Double Data Rate 4 (DDR4) DIMM support), and a DDR4 Dynamic Random Access Memory (DRAM) controller. Memory can be on-board DDR4 memory with error correction code (ECC) error protection support. In at least one embodiment, the CPU can include a single core with L2 and L3 caches and a DRAM controller. In at least one embodiment, the one or more hardware accelerators can include a security accelerator, a storage accelerator, and a networking accelerator. In at least one embodiment, the security accelerator can provide a secure boot with hardware root-of-trust, secure firmware updates, Cerberus compliance, Regular expression (RegEx) acceleration, IP security (IPsec)/Transport Layer Security (TLS) data-in-motion encryption, Advanced Encryption Standard Galois/Counter Mode (AES-GCM) 512/256-bit key for data-at-rest encryption (e.g., AES with ciphertext stealing (XTS) (e.g., AES-XTS 256/512), secure hash algorithm (SHA) 256-bit hardware acceleration, Hardware public key accelerator (e.g., Rivest-Shamir-Adleman (RSA), Diffie-Hellman, Digital Signal Algorithm (DSA), ECC, Elliptic Curve Cryptography Digital Signal Algorithm (ECC-DSA), Elliptic-curve Diffie-Hellman (EC-DH)), and True random number generator (TRNG). In at least one embodiment, the storage accelerator can provide BlueField SNAP-NVMe™ and VirtIO-blk, NVMe-oF™ acceleration, compression and decompression acceleration, and data hashing and deduplication. In at least one embodiment, the network accelerator can provide remote direct memory access (RDMA) over Converged Ethernet (ROCE) ROCE, Zero Touch ROCE, Stateless offloads for TCP, IP, and User Datagram Protocol (UDP), Large Receive Offload (LRO), Large Segment Offload (LSO), checksum, Total Sum of Squares (TSS), Residual Sum of Squares (RSS), HTTP dynamic streaming (HDS), and virtual local area network (VLAN) insertion/stripping, single root I/O virtualization (SR-IOV), virtual Ethernet card (e.g., VirtIO-net), Multi-function per port, VMware NetQueue support, Virtualization hierarchies, and ingress and egress Quality of Service (QOS) levels (e.g., 1K ingress and egress QoS levels). In at least one embodiment, the DPU 204 can also provide boot options, including secure boot (RSA authenticated), remote boot over Ethernet, remote boot over Internet Small Computer System Interface (ISCSI), Preboot execution environment (PXE), and Unified Extensible Firmware Interface (UEFI).

In at least one embodiment, the DPU 204 can provide management services, including a 1 GbE out-of-band management port, network controller sideband interface (NC-SI), Management Component Transport Protocol (MCTP) over System Management Bus (SMBus), and Monitoring Control Table (MCT) over PCIe, Platform Level Data Model (PLDM) for Monitor and Control, PLDM for Firmware Updates, Inter-Integrated Circuit (I2C) interface for device control and configuration, Serial Peripheral Interface (SPI) interface to flash, embedded multi-media card (eMMC) memory controller, Universal Asynchronous Receiver/Transmitter (UART), and Universal Serial Bus (USB).

The host device 202 may be a desktop computer, a laptop computer, a smartphone, a tablet computer, a server, or any suitable computing device capable of performing the techniques described herein. In some embodiments, the host device 202 may be a computing device of a cloud-computing platform. For example, the host device 202 may be a server machine of a cloud-computing platform or a component of the server machine. In such embodiments, the host device 202 may be coupled to one or more edge devices (not shown) via the network 210. An edge device refers to a computing device that enables communication between computing devices at the boundary of two networks. For example, an edge device may be connected to host device 202, one or more data stores, one or more server machines via network 210, and may be connected to one or more endpoint devices (not shown) via another network. In such an example, the edge device can enable communication between the host device 202, one or more data stores, one or more server machines, and one or more client devices. In other or similar embodiments, host device 202 may be an edge device or a component of an edge device. For example, host device 202 may facilitate communication between one or more data stores, one or more server machines connected to host device 202 via network 210, and one or more client devices connected to host device 202 via another network.

In still other or similar embodiments, the host device 202 can be an endpoint device or a component of an endpoint device. For example, host device 202 may be, or may be a component of, devices, such as televisions, smartphones, cellular telephones, data center servers, data DPUs, personal digital assistants (PDAs), portable media players, netbooks, laptop computers, electronic book readers, tablet computers, desktop computers, set-top boxes, gaming consoles, a computing device for autonomous vehicles, a surveillance device, and the like. In such embodiments, host device 202 may be connected to the DPU 204 over one or more network interfaces via network 210. In other or similar embodiments, host device 202 may be connected to an edge device (not shown) via another network, and the edge device may be connected to the DPU 204 via network 210.

In at least one embodiment, the host device 202 executes one or more computer programs. One or more computer programs can be any process, routine, or code executed by the host device 202, such as a host OS, an application, a guest OS of a virtual machine, or a guest application, such as executed in a container. host device 202 can include one or more CPUs of one or more cores, one or more multi-core CPUs, one or more GPUs, one or more hardware accelerators, or the like.

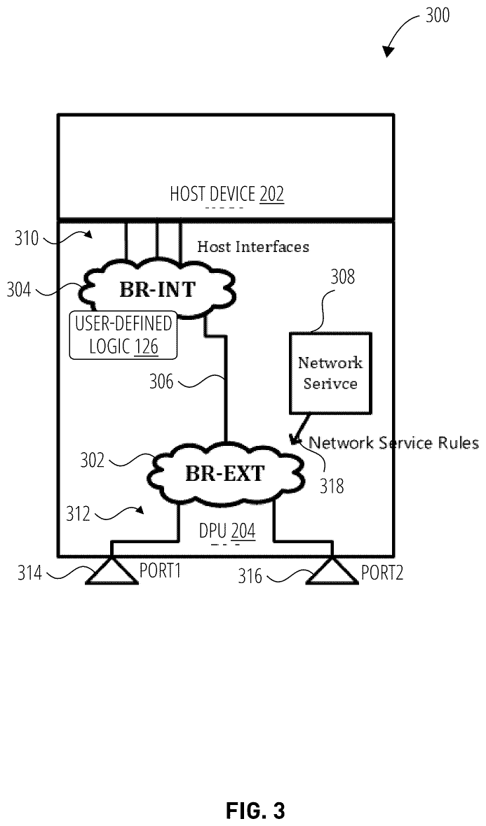

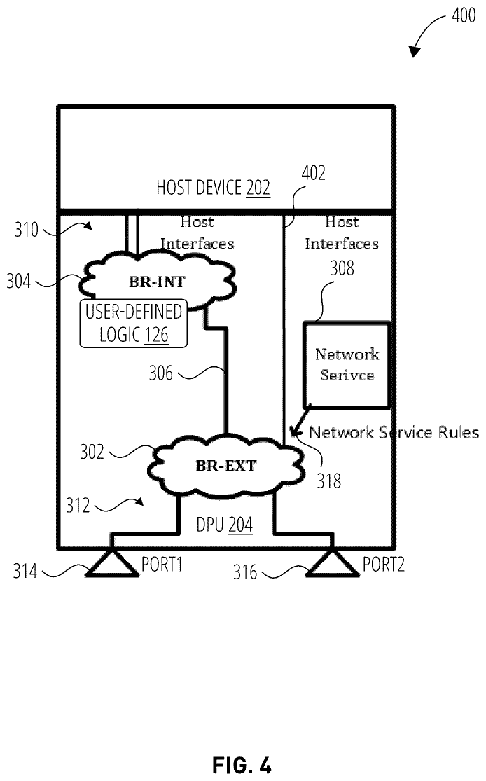

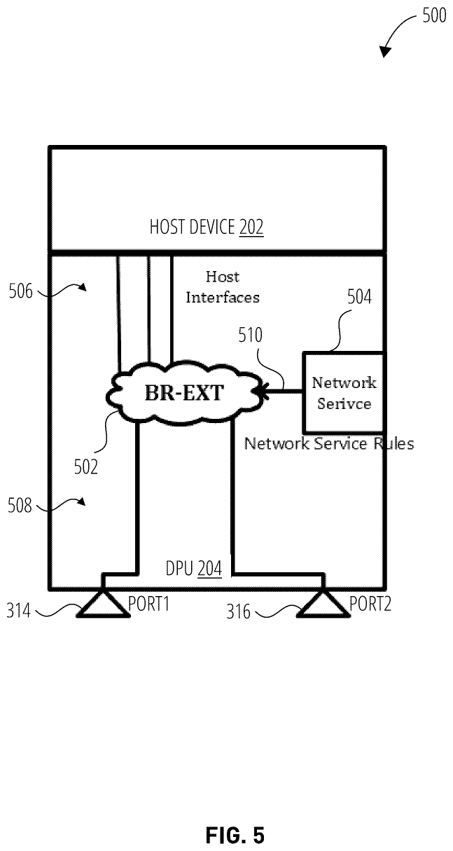

As described above, the DPU 204 can generate and configure the SFC architecture 220 of network functions 222 with configurable and dynamic SFC interface mappings of multiple virtual bridges 104. Examples of the SFC architectures are illustrated and described below with respect to FIG. 3, FIG. 5, and FIG. 4.

FIG. 3 is a block diagram of an SFC architecture 300 with a first virtual bridge 302 (labeled “BR-EXT” for external bridge), a second virtual bridge 304 (labeled “BR-INT” for internal bridge), a virtual port 306, and a network service 308, according to at least one embodiment. As described herein, the SFC logic 102 can generate the first virtual bridge 302, the second virtual bridge 304, and the virtual port 306 in the SFC architecture 300. The SFC logic 102 can configure the first virtual bridge 302 to be controlled by the network service 308 hosted on the DPU 204 and the second virtual bridge 304 to be controlled by the user-defined logic 126. The SFC logic 102 adds a service interface to the first virtual bridge 302 to operatively couple the network service 308 to the first virtual bridge 302. The SFC logic 102 adds the virtual port 306 between the first virtual bridge 302 and second virtual bridge 304. The network service 308 can provide one or more network service rules 318 to the first virtual bridge 302. The SFC logic 102 can add one or more host interfaces 310 to the second virtual bridge 304.

As illustrated, three separate host interfaces can be added to connect the second virtual bridge 304 to hosts, such as three separate VMs hosted on the host device 202. For example, one VM can host a firewall application, another VM can host a load balancer application, and another VM can host an IDS application. The SFC logic 102 can add one or more network interfaces 312 to the first virtual bridge 302. In particular, the SFC logic 102 can add to the first virtual bridge 302, a first network interface to operatively couple to a first network port 314 (labeled PORT1) of the DPU 204, and a second network interface to operatively couple to a second network port 316 (labeled PORT2) of the DPU 204. The first virtual bridge 302 can receive network traffic data from the first network port 314 and the second network port 316. The first virtual bridge 302 can receive network traffic data from the first network port 314 and the second network port 316. The first virtual bridge 302 can direct the network traffic data to the second virtual bridge 304 via the virtual port 806. The second virtual bridge 304 can direct the network traffic data to the corresponding host via the host interfaces 310.

In at least one embodiment, the user-defined logic 126 is part of the second virtual bridge 304. In at least one embodiment, the user-defined logic 126 is part of a user-defined service hosted on the DPU 204, such as a user-defined network service, a user-defined security service, a user-defined telemetry service, a user-defined storage service, or the like. The SFC logic 102 can add another service interface to the second virtual bridge 304 to operatively couple the user-defined service to the second virtual bridge 304.

In at least one embodiment, the SFC logic 102 can configure, in the second virtual bridge 304, a first link state propagation between a first host interface and the virtual port 306, and a second link state propagation between a second host interface and the virtual port 306. Similarly, the SFC logic 102 can configure, in the second virtual bridge 304, a third link state propagation between a third host interface and the virtual port 306. Similar link state propagations can be configured in the first virtual bridge 302 for links between the virtual port 306 and the network interfaces 312.

In at least one embodiment, the SFC logic 102 can configure an operating system (OS) property in the second virtual bridge 304. In at least one embodiment, the SFC logic 102 can configure an OS property for each of the host interfaces 310.

As described herein, the SFC architecture 300 can be created as part of installation of the OS on the DPU 204 or as part of runtime of the DPU 204. This can be done using a second configuration file or a modification to the original configuration file. The re-configuration of the DPU as part of runtime can be done without reinstallation of the OS on the DPU 204.

It should be noted that the SFC logic 102 can generate different combinations of virtual bridges and interface mappings in different SFC architectures, such as illustrated in FIG. 4.

FIG. 4 is a block diagram of an SFC architecture 400 with a first virtual bridge 302, a second virtual bridge 304, a virtual port 306, and a network service 308, according to at least one embodiment. The SFC architecture 400 is similar to SFC architecture 300 as noted by similar reference numbers, except the SFC architecture 400 includes additional host interfaces 402 as described in more detail below.

As described above, the SFC logic 102 can generate the first virtual bridge 302, the second virtual bridge 304, and the virtual port 306 in the SFC architecture 400. The SFC logic 102 can configure the first virtual bridge 302 to be controlled by the network service 308 hosted on the DPU 204 and the second virtual bridge 304 to be controlled by the user-defined logic 126 (on the second virtual bridge 304 or on a user-defined service as described above). The SFC logic 102 adds a service interface to the first virtual bridge 302 to operatively couple the network service 308 to the first virtual bridge 302. The SFC logic 102 adds the virtual port 306 between the first virtual bridge 302 and second virtual bridge 304. The network service 308 can provide one or more network service rules 318 to the first virtual bridge 302. The SFC logic 102 can add one or more host interfaces 310 to the second virtual bridge 304 and one or more host interfaces 402 to the first virtual bridge 302.

As illustrated, two separate host interfaces can be added to connect the second virtual bridge 304 to one or more hosts (e.g., VMs or containers hosted on the host device 202), and one host interface can be added to connect the first virtual bridge 302 to a host (e.g., a VM or container hosted on the host device 202). In other embodiments, different number of host interfaces can be added to multiple virtual bridges according to the configuration file 124. The SFC logic 102 can add one or more network interfaces 312 to the first virtual bridge 302. In particular, the SFC logic 102 can add to the first virtual bridge 302, a first network interface to operatively couple to a first network port 314 (labeled PORT1) of the DPU 204, and a second network interface to operatively couple to a second network port 316 (labeled PORT2) of the DPU 204. The first virtual bridge 302 can receive network traffic data from the first network port 314 and the second network port 316.

In at least one embodiment, the SFC logic 102 can configure, in the second virtual bridge 304, a first link state propagation between a first host interface and the virtual port 306, and a second link state propagation between a second host interface and the virtual port 306. Similarly, the SFC logic 102 can configure, in the first virtual bridge 302, a third link state propagation between a third host interface and the network interfaces 312. Similar link state propagations can be configured in the first virtual bridge 302 for links between the virtual port 306 and the network interfaces 312.

In at least one embodiment, the SFC logic 102 can configure an operating system (OS) property in the second virtual bridge 304. In at least one embodiment, the SFC logic 102 can configure an OS property for each of the host interfaces 310, as well as an OS property for each of the host interfaces 402.

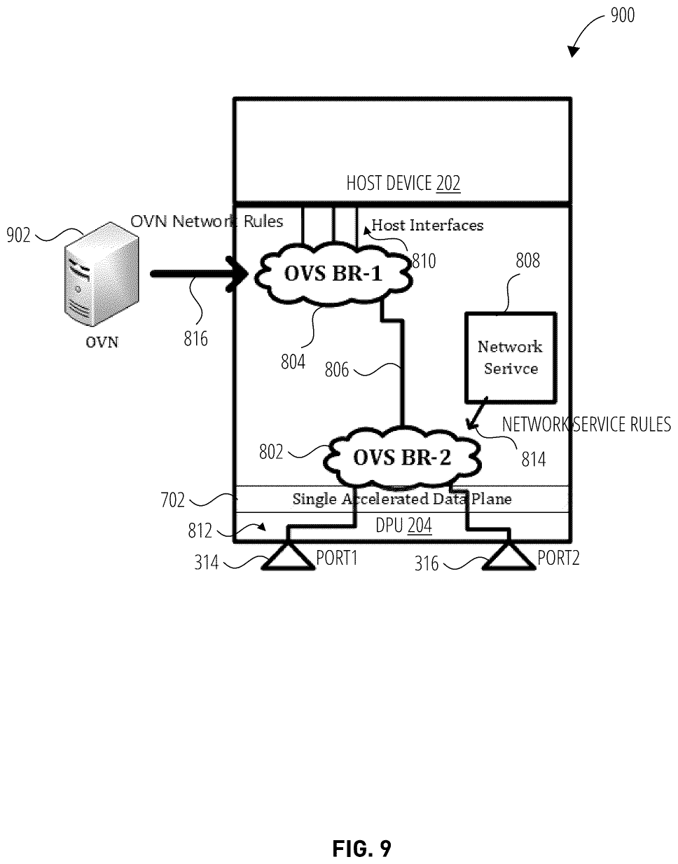

In at least one embodiment, the DPU 204 can support configurable and dynamic interfaces mapping on the DPU 204 based on SFC infrastructure. The configuration can be supported as part of DPU OS installation and dynamically for DPU in production. The interface configuration can support different use-cases for network acceleration on the DPU 204. As described above, the SFC architecture can be composed of two main bridges: an external virtual bridge (BR-EXT), controlled by a networking service running on the DPU 204; and an internal virtual bridge (BR-INT), controlled by a user controller (e.g., OVN controller as described below with respect to FIG. 9). The interface configuration can support different requirements based on customers' use cases. For example, the interface configuration can support uplink interfaces to external virtual bridge (BR-EXT) or internal virtual bridge (BR-INT), host interfaces to the external or internal virtual bridges, as well as additional services connected to the internal virtual bridge (BR-INT), for example, security services, telemetry services, or the like. The interface configuration can support Scalable Functions (SFs) configurations. The interface configuration can support link propagation and different OS attributes (e.g., HUGEPAGE_SIZE, HUGEPAGE_COUNT, etc.).

The following is an example configuration file.
ENABLE_EX_VB=yes
# enable external virtual bridge—Default is no
ENABLE_INT_VB=yes
# enable internal virtual bridge—Default is no
EX_VB_UPLINKS=“port1,port2”
# Optional, define uplinks—default is “port1,port2”
INT_VB_UPLINKS=“ ”
# Uplink ports can be attached to one VB only
INT_VB_REPS=“hostIF0, hostIF1, hostIF2”
EXT_VB_REPS=“hostIF3, hostIF4”
#Host interfaces are attached to first/second virtual bridge per configuration
#Each host interface is either on first/second virtual bridge only
INT_VB_SFS=“service1”
EXT_VB_SFS=“service2”
#Connect service interface on first/second virtual bridge
EXT_INT_VB_VPORTS=“vport0”, “vport1”
#Creates patch ports and set them as peers on first/second virtual bridge
LINK_PROPAGATION_1=“hostIF0: vport0”, “hostIF1: vport1”
LINK_PROPAGATION_2= “hostIF2: vport1”, “hostIF3: vport2”
#Link propagation between different interfaces
HUGEPAGE_SIZE=2048 # Optional, in kilobytes (KBs)
HUGEPAGE_COUNT=4096 # Optional, numeric

As described herein, the SFC architecture 400 can be created as part of installation of the OS on the DPU 204 or as part of runtime of the DPU 204. This can be done using a second configuration file or a modification to the original configuration file. The re-configuration of the DPU as part of runtime can be done without reinstallation of the OS on the DPU 204.

It should be noted that the SFC logic 102 can generate different combinations of virtual bridges and interface mappings in different SFC architectures, such as illustrated in FIG. 3 and FIG. 4. For comparison, FIG. 5 illustrates a non-SFC architecture 500 that only allows one network service to control a single virtual bridge between the hosts and network.

FIG. 5 is a block diagram of a non-SFC architecture 500 with a single virtual bridge 502 and a single network service 504, according to at least one embodiment. The single virtual bridge 502 can include multiple host interfaces 506, a service interface operatively coupled to the single network service 504, and two network interfaces 508. The single virtual bridge 502 is controlled by the single network service 504 using one or more network service rules 510. The network service 308 can provide one or more network service rules 318 over the service interface to configure the first virtual bridge 302. The single virtual bridge 502 can route network traffic data between the host device 202 (e.g., multiple VMs) and the first network port 314 and the second network port 316 of the DPU 204. The single virtual bridge 502 and the single network service 504 are limited in providing additional network functions than those provided by the single network service 504.

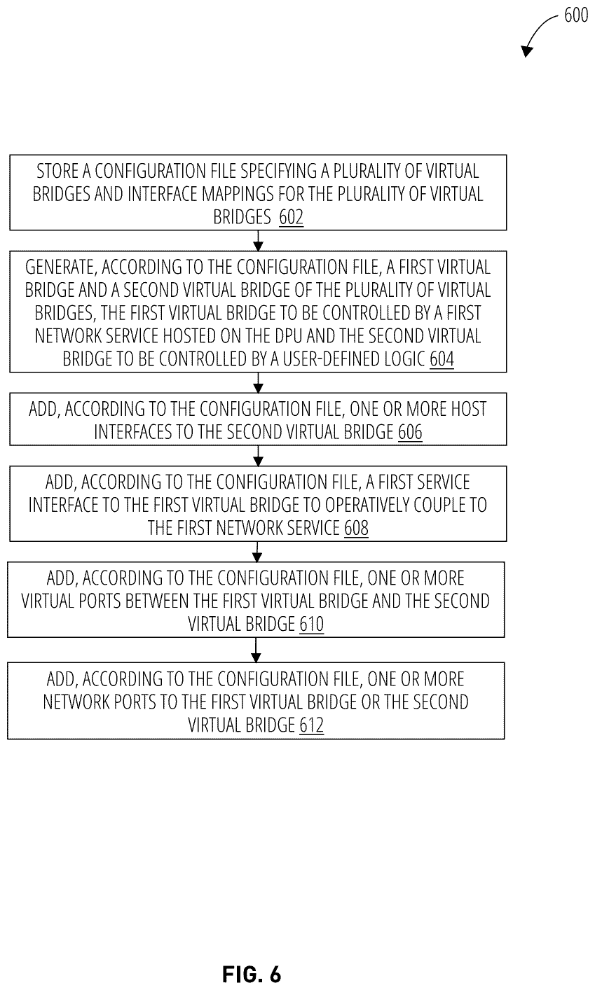

FIG. 6 is a flow diagram of an example method 600 of configuring an SFC architecture with multiple virtual bridges and interface mappings according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 600 may be performed by multiple processing threads, each thread executing one or more individual functions, routines, subroutines, or operations of the method. In at least one embodiment, processing threads implementing method 600 may be synchronized (e.g., using semaphores, critical sections, and/or other thread synchronization logic). Alternatively, processing threads implementing method 600 may be executed asynchronously with respect to each other. Various operations of method 600 may be performed differently than the order shown in FIG. 6. Some operations of the methods may be performed concurrently with other operations. In at least one embodiment, one or more operations shown in FIG. 6 may not always be performed.

Referring to FIG. 6, the processing logic begins with the processing logic storing a configuration file specifying a plurality of virtual bridges and interface mappings for the plurality of virtual bridges (block 602). At block 604, the processing logic generates, according to the configuration file, a first virtual bridge and a second virtual bridge of the plurality of virtual bridges, the first virtual bridge to be controlled by a first network service hosted on the DPU and the second virtual bridge to be controlled by a user-defined logic. At block 606, the processing logic adds, according to the configuration file, one or more host interfaces to the second virtual bridge. At block 608, the processing logic adds, according to the configuration file, a first service interface to the first virtual bridge to operatively couple to the first network service. At block 610, the processing logic adds, according to the configuration file, one or more virtual ports between the first virtual bridge and the second virtual bridge. At block 612, the processing logic adds, according to the configuration file, one or more network ports (uplink ports) to the first virtual bridge and/or the second virtual bridge.

In a further embodiment, the method 600 further includes the processing logic adding, according to the configuration file, a first network interface to the first virtual bridge to operatively couple to a first network port of the DPU, a second network interface to the first virtual bridge to operatively couple to a second network port of the DPU, a first host interface of the one or more host interfaces to the second virtual bridge to operatively couple to a host device, and adding, according to the configuration file, a second host interface of the one or more host interfaces to the second virtual bridge to operatively couple to the host device. The method 600 further includes the processing logic configuring, according to the configuration file, a first link state propagation in the second virtual bridge between the first host interface and the one or more virtual ports, and a second link state propagation in the second virtual bridge between the second host interface and the one or more virtual ports.

In a further embodiment, the method 600 further includes the processing logic adding, according to the configuration file, a first network interface to the first virtual bridge to operatively couple to a first network port of the DPU, a second network interface to the first virtual bridge to operatively couple to a second network port of the DPU, a first host interface of the one or more host interfaces to the second virtual bridge to operatively couple to a first host device, and a second host interface of the one or more host interfaces to the second virtual bridge to operatively couple to a second host device. The first host device is at least one of a virtual machine or a container, and the second host device is at least one of a virtual machine or a container. In a further embodiment, the method 600 further includes the processing logic configuring, according to the configuration file, a first link state propagation in the second virtual bridge between the first host interface and the one or more virtual ports, and a second link state propagation in the second virtual bridge between the second host interface and the one or more virtual ports.

In a further embodiment, the method 600 further includes the processing logic installing an OS to be executed on the processing device of the DPU. The processing logic generates the plurality of virtual bridges and the interface mappings of the plurality of virtual bridges is part of installing the OS on the DPU.

In a further embodiment, the method 600 further includes the processing logic installing an OS to be executed on the processing device of the DPU. The processing logic generates the plurality of virtual bridges and the interface mappings of the plurality of virtual bridges is part of runtime of the DPU and without reinstallation of the OS on the DPU.

### Flexible Steering Rules in SFC Architectures

Steering rules are essential components in network and traffic management, dictating how data packets are directed through a network based on specific criteria. These rules can be applied in various contexts, including load balancing, security, compliance, and optimization of network resources. Below is a description of some common types of steering rules.

Source IP-based steering focuses on routing traffic based on the origin of the IP address, which can be pivotal for managing traffic from specific regions or known addresses, useful for localization, imposing geo-restrictions, or enhancing security. Destination IP-based steering, on the other hand, targets the intended end-point of the traffic, allowing networks to channel traffic to particular data centers or cloud regions based on the destination IP address.

Port-based steering uses TCP or UDP port numbers to direct specific types of traffic, like HTTP or File Transfer Protocol (FTP), to resources that are best suited for handling them, thereby optimizing both performance and security. Application-aware steering goes deeper, inspecting packets to determine the application generating the traffic, and routing different types of application traffic through paths optimized for their specific needs, such as low latency or high bandwidth.

Load-based steering directs traffic based on the current load or capacity of network paths, often in conjunction with load balancers, to distribute load evenly and prevent any resource from becoming a bottleneck. Time-based steering is effective for managing network loads during different times of the day or week, routing traffic to alternate resources during peak periods to maintain performance.

Protocol-based steering makes routing decisions based on the specific protocols used, such as HTTP or HTTPS, ensuring that traffic is treated according to its particular requirements. Content or Data Type-based steering examines the content within the packets, directing types like video or text to processing services optimized for those data types, thus enhancing content delivery.

User Identity-based steering directs traffic based on the identity or role of the user, allowing networks to provide differentiated services or enforce security policies that are tailored to specific user profiles.

Combinations of these steering rules can form a comprehensive approach to managing traffic in complex environments like data centers, cloud networks, and large enterprises, ensuring efficient resource utilization and maintaining robust performance and security standards across the network.

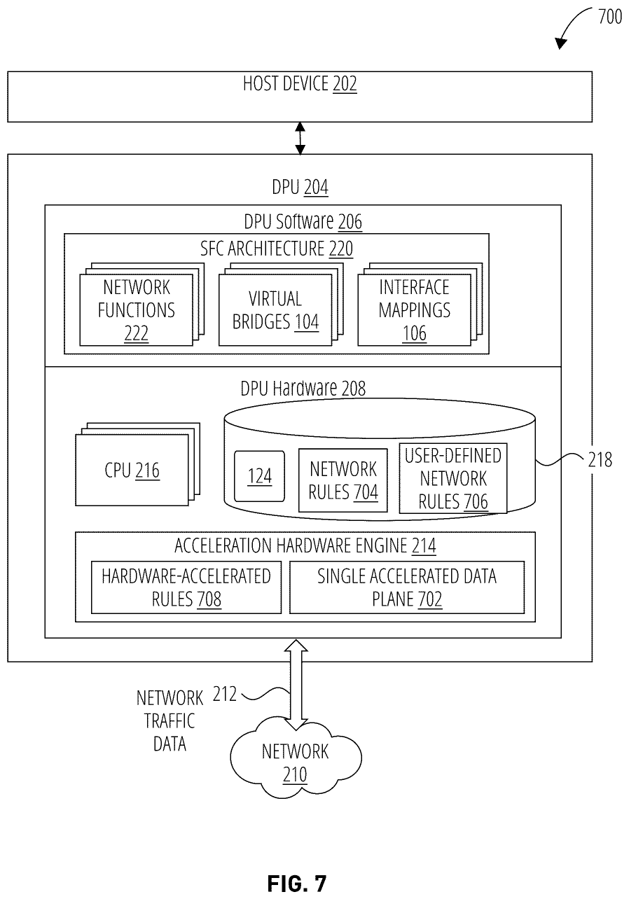

Prior solutions could not provide flexible steering rules in a single accelerated data plane on a DPU. Aspects and embodiments of the present disclosure can provide flexible steering rules in a single accelerated data plane on a DPU. Aspects and embodiments of the present disclosure can provide hardware-accelerated flexible steering rules over an SFC architecture, as described below with respect to FIG. 7 to FIG. 10.

FIG. 7 is a block diagram of an example DPU-based SFC infrastructure 700 for providing hardware-accelerated rules for an SFC architecture 220 according to at least one embodiment. The DPU-based SFC infrastructure 700 is similar to DPU-based SFC infrastructure 200 as noted by similar reference numbers, except the DPU-based SFC infrastructure 700 includes hardware-accelerated rules 708, which are derived from network rules from different sources in the 220 and accelerated on the single accelerated data plane 702 of the acceleration hardware engine 214 as described in more detail below.

The acceleration hardware engine 214 can provide a single accelerated data plane 702 for the SFC architecture 220. The memory 218 can store the configuration file 124 specifying at least a first virtual bridge, a second virtual bridge, and a virtual port between the first virtual bridge and the second virtual bridge. The SFC logic 102 can generate, according to the configuration file 124, the first virtual bridge to be controlled by a first network service hosted on the DPU 204 and having a first set of one or more network rules 704. The first set of one or more network rules 704 can include a layer 2 (L2) protocol rule, a layer 3 (L3) protocol rule, a tunneling protocol rule, an Access Control List (ACL) rule, an Equal-Cost Multi-Path (ECMP) rule, a tunneling encapsulation rule, a tunneling decapsulation rule, a Connection Tracking (CT) rule, a virtual local area network (VLAN) rule, a network address translation (NAT) rule, or the like.

The SFC logic 102 can generate, according to the configuration file 124, the second virtual bridge having a second set of one or more user-defined network rules 706. In at least one embodiment, the user-defined network rules 706 are programmable by a user or a controller. The user-defined network rules 706 can include a L2 protocol rule, a L3 protocol rule, a tunneling protocol rule, an ACL rule, an ECMP rule, a tunneling encapsulation rule, a tunneling decapsulation rule, a CT rule, a VLAN rule, a NAT rule, or the like. In at least one embodiment, the network rules 704 can include a first set of steering rules for the first virtual bridge and the user-defined network rules 706 can include a second set of steering rules for the second virtual bridge. The steering rules can be application-based steering rules, policy-based steering rules, geolocation-based steering rules, load balancing rules, QoS rules, failover rules, redundancy rules, security-based steering rules, cost-based routing rules, software-defined wide area network (SD-WAN) path steering rules, a software-defined networking (SDN) rules, or the like.

The SFC logic 102 can add, according to the 124, the virtual port between the first virtual bridge and the second virtual bridge. The SFC logic 102 can also generate a combined set of network rules based on the first set of one or more network rules 704 and the second set of one or more user-defined network rules 706. The combined set of rules can be added as hardware-accelerated rules 708 on the single accelerated data plane 702. The acceleration hardware engine 214 can process network traffic data 212 in the single accelerated data plane 702 using the hardware-accelerated rules 708 (i.e., the combined set of network rules).

In at least one embodiment, the virtual bridges 104, including the first and second virtual bridges described above, are Open vSwitch (OVS) bridges. The DPU 204 can execute an OVS application with hardware offload mechanisms to provide the single accelerated data plane 702 in the acceleration hardware engine 214 to process the network traffic data 212 using the hardware-accelerated rules 708 (i.e., the combined set of network rules).

In at least one embodiment, the SFC logic 102 can add one or more host interfaces to the second virtual bridge to operatively couple to one or more host devices operatively coupled to the DPU, and one or more network interfaces to the first virtual bridge to operatively couple to one or more network ports of the DPU. The SFC logic 102 can add a first service interface to the first virtual bridge to operatively couple to the first network service, and a second service interface to the second virtual bridge to operatively couple a second network service. The first network service and the second network service can be part of the SFC architecture 220 of the DPU-based SFC infrastructure 700. The first network service and the second network service can provide accelerated network capabilities in the single accelerated data plane 702 using the hardware-accelerated rules 708 (i.e., the combined set of network rules).

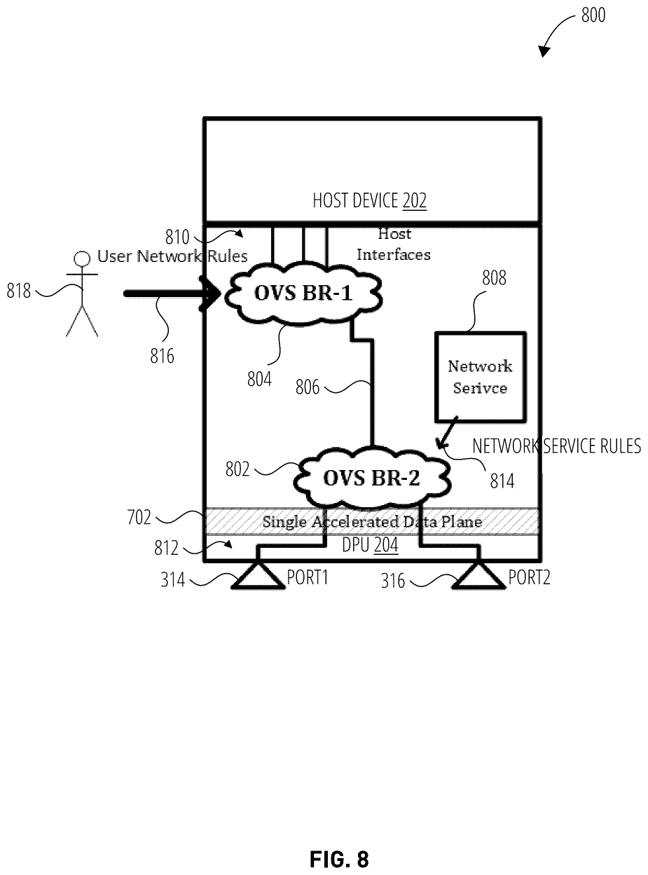

As described above, the DPU 204 can generate and configure the SFC architecture 220 of network functions 222 with hardware-accelerated rules in a single accelerated data plane of an SFC infrastructure. Examples of the SFC architectures are illustrated and described below with respect to FIG. 8 and FIG. 9.

FIG. 8 is a block diagram of an SFC architecture 800 with flexible hardware-accelerated rules for a single accelerated data plane, according to at least one embodiment. The SFC architecture 800 is similar to the SFC architecture 300 but uses different reference numbers. The SFC architecture 800 includes a first virtual bridge 802 (labeled “OVS BR-1”), a second virtual bridge 804 (labeled “OVS BR-2”), a virtual port 806, and a network service 808. As described herein, the SFC logic 102 can generate the first virtual bridge 802, the second virtual bridge 804, and the virtual port 806 in the SFC architecture 800. The SFC logic 102 can configure the first virtual bridge 802 to be controlled by network service rules 814 provided by the network service 808 hosted on the DPU 204 and the second virtual bridge 804 to be controlled by user-defined network rules 816. The SFC logic 102 adds a service interface to the first virtual bridge 802 to operatively couple the network service 808 to the first virtual bridge 802. The SFC logic 102 adds the virtual port 806 between the first virtual bridge 802 and second virtual bridge 804. The network service 808 can provide one or more network service rules 814 to the first virtual bridge 802. The user-defined logic 126 can provide one or more user-defined network rules 816 to the second virtual bridge 804. The SFC logic 102 can add one or more host interfaces 310 to the second virtual bridge 804.

As illustrated, three separate host interfaces can be added to connect the second virtual bridge 804 to hosts, such as three separate VMs hosted on the host device 202. For example, one VM can host a firewall application, another VM can host a load balancer application, and another VM can host an IDS application. The SFC logic 102 can add one or more network interfaces 812 to the first virtual bridge 802. In particular, the SFC logic 102 can add to the first virtual bridge 802, a first network interface to operatively couple to a first network port 314 (labeled PORT1) of the DPU 204, and a second network interface to operatively couple to a second network port 316 (labeled PORT2) of the DPU 204. The first virtual bridge 802 can receive network traffic data from the first network port 314 and the second network port 316. The first virtual bridge 802 can direct the network traffic data to the second virtual bridge 804 via the virtual port 806. The second virtual bridge 804 can direct the network traffic data to the corresponding host via the host interfaces 810.

In at least one embodiment, the user-defined network rules 816 can be provided by a user 818. The user 818 can provide the user-defined network rules 816 using the user-defined logic 126. The user 818 can program the second virtual bridge 804 with the user-defined network rules 816. Alternatively, user-defined logic 126 can receive user input from the 818, and the user-defined logic 126 can generate the user-defined network rules 816 and provide them to the second virtual bridge 804. In another embodiment, the user-defined network rules 816 can be provided by a user-defined service or another network service that is separate from the network service 808. The other network service (or user-defined service) can be a user-defined network service, a user-defined security service, a user-defined telemetry service, a user-defined storage service, or the like, hosted on the DPU 204 or as applications on the host device 202. When the user-defined network rules 816 are provided by a second network service, the SFC logic 102 can add another service interface to the second virtual bridge 804 to operatively couple the second network service to the second virtual bridge 804.

The DPU 204 can combine the network rules, corresponding to the different network services, to obtain a combined set of network rules that can be accelerated in a single accelerated data plane 702 of the DPU 204. The combined set of network rules become hardware-accelerated rules that are accelerated by the DPU 204 for the SFC architecture 800.

In at least one embodiment, the DPU 204 provides a DPU service that supports Host Based Networking (HBN) as the network service 808 for acceleration of L2/L3/tunneling protocols on the DPU 204. The HBN infrastructure is based on an SFC topology, where one OVS bridge is controlled by the HBN service providing all accelerated networking capabilities. As described above, the second OVS bridge (second virtual bridge 804) can be programmable by the user 818 or any other controller (as illustrated in FIG. 9). The HBN service can support different protocols and different network capabilities, such as ACLs, ECMP, tunneling, CT and more. The user 818 can program in a flexible manner different steering rules over the SFC architecture 800 in parallel to HBN service, which will result in hardware-accelerated rules 708 for the single accelerated data plane 702 provided by OVS-DOCA and the DPU hardware. Using the SFC infrastructure, users and customers can leverage the DPU 204 as networking accelerator on an edge device without the need for sophisticated and smart switches in different network topologies in a DC network or a SP network.

It should be noted that the SFC logic 102 can generate different combinations of hardware-accelerated rules 708 in different SFC architectures, such as illustrated in FIG. 9.

FIG. 9 is a block diagram of an SFC architecture 900 with flexible hardware-accelerated rules for a single accelerated data plane, according to at least one embodiment. The SFC architecture 900 is similar to the SFC architecture 800 as noted by similar reference numbers, except the user-defined network rules 816 in SFC architecture 900 are received from a controller 902, such as an Open Virtual Network (OVN) controller. OVN is an open-source project designed to provide network virtualization solutions, enabling the creation and management of virtual network infrastructure within cloud and data center environments. It is an extension of the OVS project, leveraging its underlying technology to offer advanced network automation and scalability capabilities for virtualized networks. OVN aims to simplify the process of setting up and managing virtual networking components such as virtual switches, routers, firewalls, and load balancers. It allows for the dynamic creation of these components through software, without the need for manual configuration of the physical network hardware. This facilitates the deployment of highly flexible and scalable networks that can easily adapt to the changing needs of applications and services running in virtualized environments. OVN abstracts the physical network, allowing users to define logical networks that are mapped to the underlying physical infrastructure. This abstraction layer simplifies network design and management by enabling the use of high-level constructs such as logical switches and routers. Through integration with orchestration systems (e.g., OpenStack), OVN supports automated provisioning and configuration of network resources based on the requirements of the deployed applications and services for automated network management. OVN provides a range of networking services, including L2/L3 virtual networking, access control policies, NAT, and more, offering the functionality needed to support complex network topologies for advanced networking services. With OVN, it is possible to create isolated virtual networks, applying security policies and rules at the logical level to ensure that only authorized traffic can flow between different parts of the network. OVN is designed to scale efficiently with the size of the network and the number of virtualized workloads, aiming to minimize the impact on performance as networks grow. OVN is a tool for organizations looking to leverage the benefits of network virtualization, offering an efficient and flexible approach to managing virtual network infrastructures in modern cloud and data center environments. In another embodiment, the controller 902 can be other types of controllers, such a controller for a particular network service provided in the SFC architecture 900.

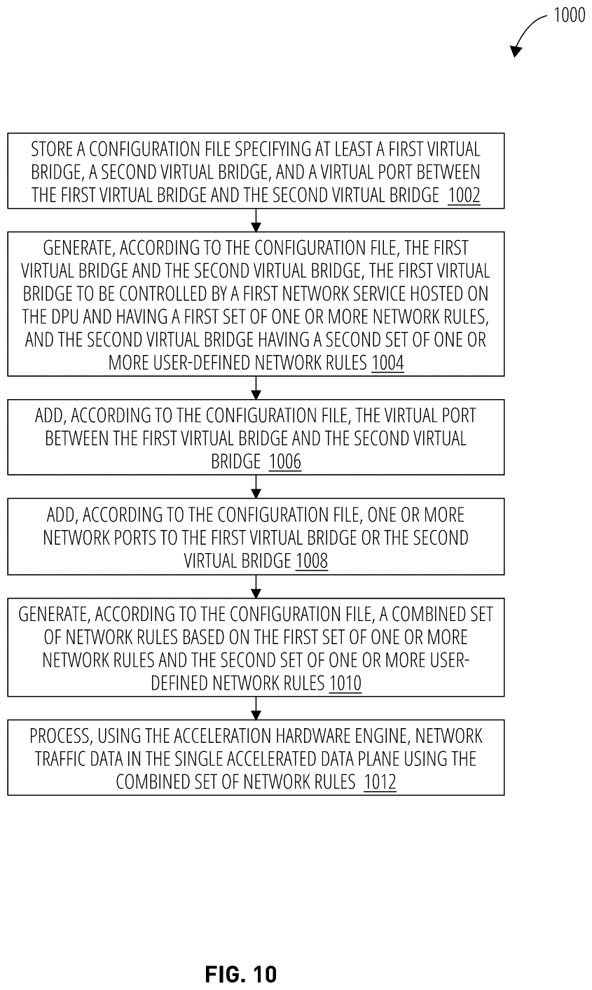

FIG. 10 is a flow diagram of an example method 1000 of configuring an SFC architecture with flexible hardware-accelerated rules for acceleration on a single accelerated data plane of a DPU according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 1000 may be performed by multiple processing threads, each thread executing one or more individual functions, routines, subroutines, or operations of the method. In at least one embodiment, processing threads implementing method 1000 may be synchronized (e.g., using semaphores, critical sections, and/or other thread synchronization logic). Alternatively, processing threads implementing method 1000 may be executed asynchronously with respect to each other. Various operations of method 1000 may be performed differently than the order shown in FIG. 10. Some operations of the methods may be performed concurrently with other operations. In at least one embodiment, one or more operations shown in FIG. 10 may not always be performed.

Referring to FIG. 10 the processing logic begins with the processing logic storing a configuration file specifying at least a first virtual bridge, a second virtual bridge, and a virtual port between the first virtual bridge and the second virtual bridge (block 1002). At block 1004, the processing logic generates, according to the configuration file, the first virtual bridge and the second virtual bridge, the first virtual bridge to be controlled by a first network service hosted on the DPU and having a first set of one or more network rules, and the second virtual bridge having a second set of one or more user-defined network rules. At block 1006, the processing logic adds, according to the configuration file, the virtual port between the first virtual bridge and the second virtual bridge. At block 1008, the processing logic adds, according to the configuration file, one or more network ports (uplink ports) to the first virtual bridge and/or the second virtual bridge. At block 1010, the processing logic generates, according to the configuration file, a combined set of network rules based on the first set of one or more network rules and the second set of one or more user-defined network rules. At block 1012, the processing logic processes, using the acceleration hardware engine, network traffic data in the single accelerated data plane using the combined set of network rules.

In a further embodiment, the method 1000 can further include the processing logic adding, according to the configuration file, one or more network interfaces to the first virtual bridge to operatively couple to one or more network ports of the DPU, and a first service interface to the first virtual bridge to operatively couple to the first network service. The first network service can provide accelerated network capabilities using the first set of one or more network rules, where the first set of one or more network rules includes any one or more of a L2 protocol rule, a L3 protocol rule, a tunneling protocol rule, an ACL rule, an ECMP rule, a tunneling encapsulation rule, a tunneling decapsulation rule, a CT rule, a VLAN rule, a NAT rule, or the like.

In a further embodiment, the method 1000 may also include further includes the processing logic adding, according to the configuration file, one or more host interfaces to the second virtual bridge to operatively couple to one or more host devices operatively coupled to the DPU, and receiving user input from a user or a controller, the user input specifying the second set of one or more user-defined network rules, where the second set of one or more user-defined network rules includes one or more steering rules. The processing logic can add, according to the configuration file, the second set of one or more user-defined network rules to the second virtual bridge. In at least one embodiment, the one or more steering rules includes any one or more of an application-based steering rule, a policy-based steering rule a geolocation-based steering rule, a load balancing rule, a QoS rule, a failover rule, a redundancy rule, a security-based steering rule, a cost-based routing rule, a SD-WAN path steering rule, a software-defined networking (SDN) rule, or the like.

In a further embodiment, the method 1000 may also further include the processing logic adding, according to the configuration file, one or more network interfaces to the first virtual bridge to operatively couple to one or more network ports of the DPU, and a first service interface to the first virtual bridge to operatively couple to the first network service, the first network service to provide accelerated network capabilities. The first set of one or more network rules includes at least one of an ACL rule, an ECMP rule, a tunneling rule, a CT rule, a QoS rule, a STP, a VLAN rule, a NAT rule, a SDN rule, a MPLS rule, or the like.

In a further embodiment, the method 1000 may also further include the processing logic adding, according to the configuration file, one or more host interfaces to the second virtual bridge to operatively couple to one or more host devices operatively coupled to the DPU, and one or more network interfaces to the first virtual bridge to operatively couple to one or more network ports of the DPU. In a further embodiment, the method 1000 may also further include the processing logic adding, according to the configuration file, a first service interface to the first virtual bridge to operatively couple to the first network service. In a further embodiment, the method 1000 may also further include the processing logic adding, according to the configuration file, a second service interface to the second virtual bridge to operatively couple a second network service, where the first network service and the second network service are part of a SFC infrastructure to provide accelerated network capabilities in the single accelerated data plane using the combined set of network rules.

### Creating an Optimized and Accelerated Network Pipeline Using Network Pipeline Abstraction Layer (NAPL)

A database abstraction layer (DAL) is a software component that provides a unified interface to interact with different types of database systems, enabling applications to perform database operations without needing to use database-specific syntax. The DAL acts as a mediator between the application and the database, translating the application's data access requests into the appropriate queries for the underlying database. By abstracting the specifics of the database system, the DAL allows developers to write database-independent code, thereby enhancing the application's portability and scalability. This layer can support various database operations, including creating, reading, updating, and deleting records, and can be implemented in various forms, such as object-relational mapping (ORM) libraries, which further simplify data manipulation by allowing data to be handled in terms of objects.

As described herein, an integrated circuit (e.g., DPU) can provide a network pipeline abstraction layer (NPAL) similar to a DAL. The NPAL is a software programmable layer that provides an optimized and accelerated network pipeline that supports different accelerated network capabilities, such as L2 bridging, L3 routing, tunnel encapsulation, tunnel decapsulation, hash calculations, ECMP operations, static and dynamic ACLs, CT, etc. The NPAL can include a set of APIs or classes that provide a unified interface for performing common networking operations in a network pipeline that is optimized for hardware acceleration on an acceleration hardware engine. The network pipeline can include a set of tables and logic in a specific order, the network pipeline being optimized to be accelerated by an acceleration hardware engine of a DPU hardware, providing customers and users a rich set of capabilities and high performance.

Using an NPAL in the DPU can provide various benefits, including operational independence, encapsulation of logic, performance, code reusability, platform independence, or the like. For example, developers can write agnostic code, allowing applications (e.g., network services) to work with different underlying access logic and network functionality. The NPAL can encapsulate the access or network function-related logic, making it easier to manage and maintain the codebase. systems. Changes to the schema or underlying technology can be isolated within the NPAL implementation. The NPAL can provide optimized and high-performance pipeline to address different networking requirements and functionality. By separating access logic from application logic, developers can reuse the NPAL components across multiple parts of the application (network service), promoting code reuse and maintainability. The NPAL can abstract away platform-specific differences, data types, and other access or network function-related features, enabling the application (network service) to run on different platforms and environments seamlessly. Overall, the NPAL can be a powerful tool for building flexible, scalable, and maintainable network function-driven applications, offering a level of abstraction that simplifies interactions between network functions and promotes code efficiency and portability.

In at least one embodiment, the DPU includes DPU hardware, including a processing device and an acceleration hardware engine. The DPU includes memory operatively coupled to the DPU hardware. The memory can store DPU software including an NPAL that supports multiple network protocols and network functions in a network pipeline. The network pipeline includes a set of tables and logic organized in a specific order to be accelerated by the acceleration hardware engine. The acceleration hardware engine can process network traffic data using the network pipeline. The network pipeline can be optimized for network services running on the DPU

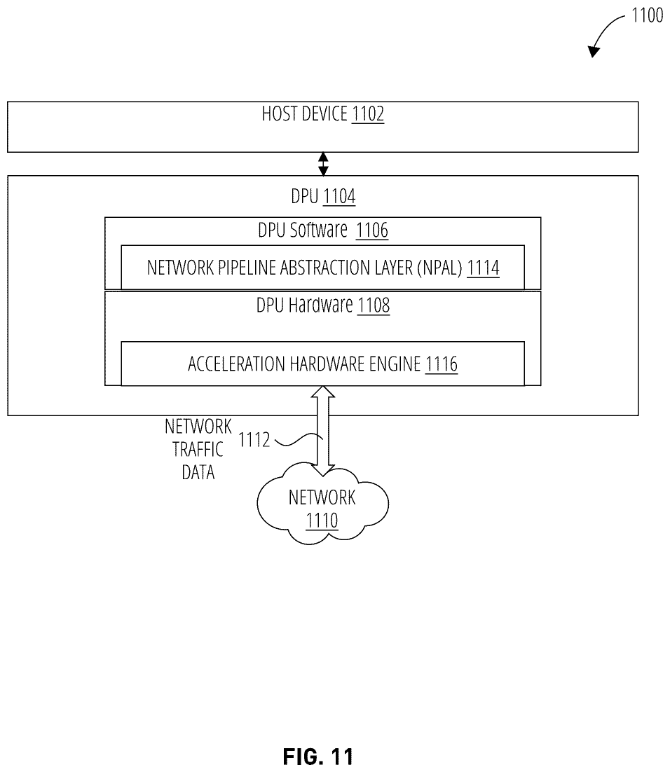

FIG. 11 is a block diagram of an example computing system 1100 with a DPU 1104 having an NPAL 1114 for providing an optimized and accelerated network pipeline to be accelerated by an acceleration hardware engine 1116 according to at least one embodiment. The computing system 1100 includes the DPU 1104 coupled between a host device 1102 and a network 1110. The host device 1102 and DPU 1104 can be similar to the host device 202 and DPU 204 of DPU-based SFC infrastructure 200 and DPU-based SFC infrastructure 700, described above except as were expressly noted.

In at least one embodiment, the DPU 1104 includes DPU hardware 1108 and DPU software 1106 (e.g., software framework with acceleration libraries). The DPU hardware 208 can include one or more CPUs (e.g., a single-core or multi-core CPU), an acceleration hardware engine 1116 (or multiple hardware accelerators), memory, and the network and host interconnects. In at least one embodiment, the DPU 1104 includes DPU software 1106, including software framework and acceleration libraries. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated AI/ML services, hardware-accelerated service, and hardware-accelerated management services. The DPU software 1106 also includes NPAL 1114. The NPAL 1114 can include a set of APIs or classes that provide a unified interface for performing common networking operations in a network pipeline that is optimized for hardware acceleration on an acceleration hardware engine 1116. The set of APIs or class can provide a unified interface to one or more applications, network services, or other logic executed by the DPU 1104 or host device 1102, or both. The network pipeline can include a set of tables and logic in a specific order, the network pipeline being optimized to be accelerated by an acceleration hardware engine 1116 of the DPU hardware 1108.

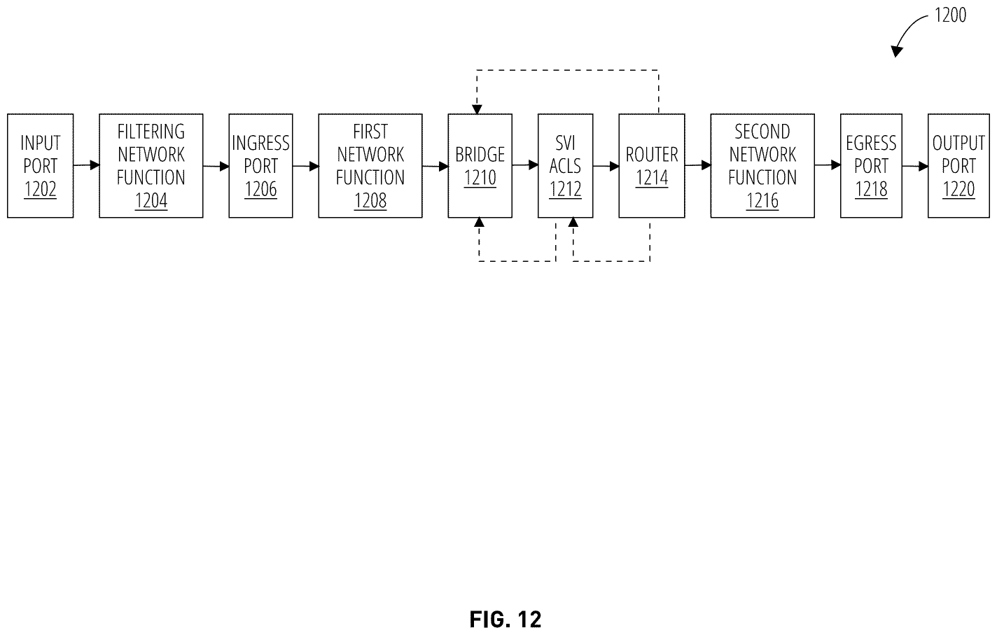

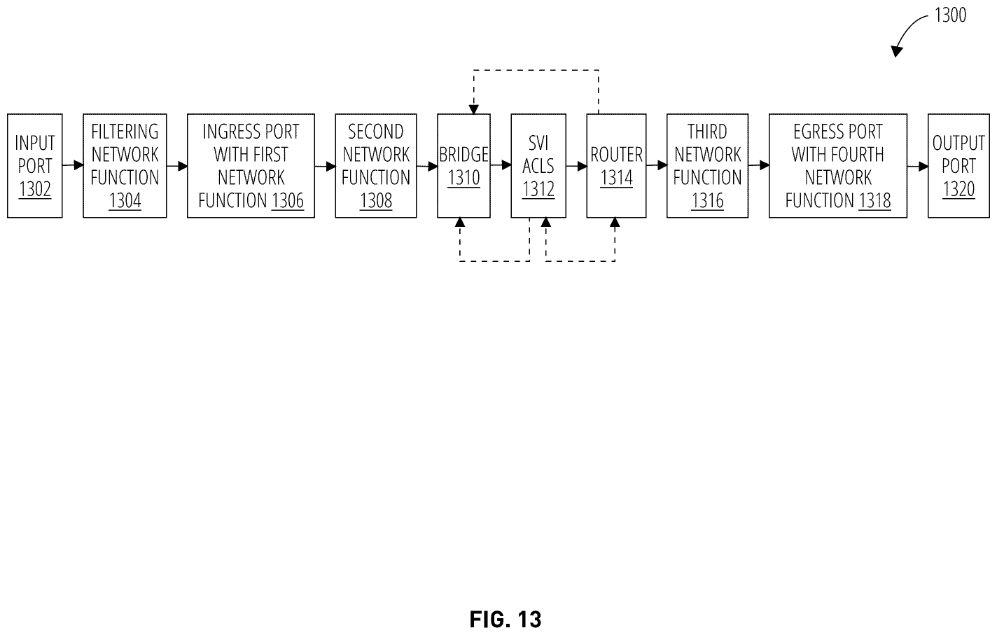

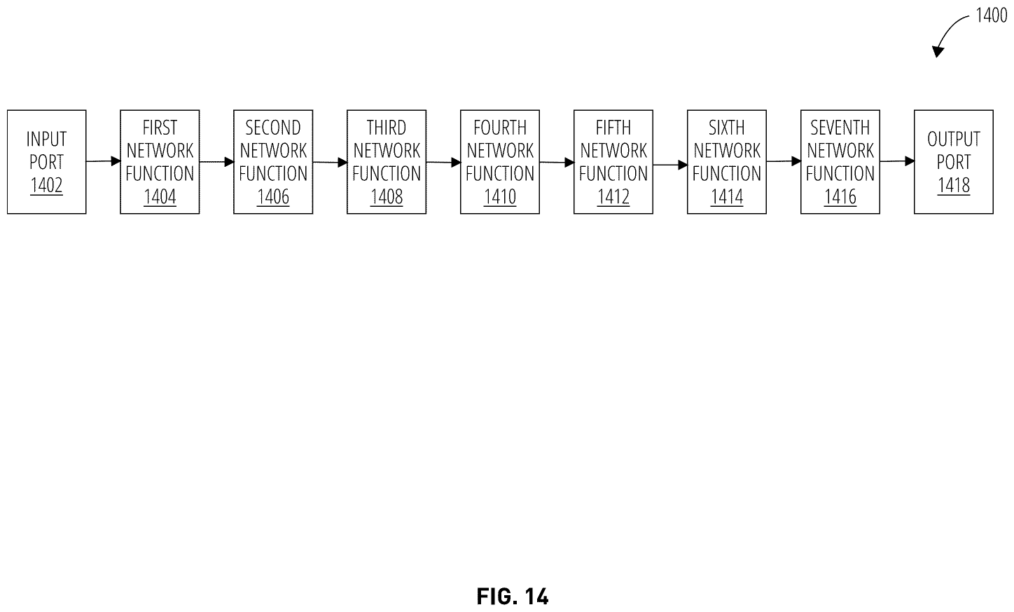

During operation, the DPU hardware 1108 can receive the network traffic data 1112 from the network 1110 and process the network traffic data 1112 using the optimized and accelerated network pipeline programmed by the NPAL 1114. As described herein the NPAL 1114 supports multiple network protocols and network functions in a network pipeline. The network pipeline includes a set of tables and logic organized in a specific order to be accelerated by the acceleration hardware engine 1116. The acceleration hardware engine 1116 can process network traffic data 1112 using the network pipeline. In at least one embodiment, the network pipeline includes an input port, an ingress dynamic or static Access Control List (ACL), a bridge, a router, an egress dynamic or static ACL, and an output port. Examples of the optimized and accelerated network pipelines are illustrated and described below with respect to FIG. 12, FIG. 13, and FIG. 14.

FIG. 12 is a network diagram of an example network pipeline 1200 that is optimized and accelerated on an acceleration hardware engine of a DPU having an NPAL according to at least one embodiment. The network pipeline 1200 includes an input port 1202, a filtering network function 1204, an ingress port 1206, a first network function 1208, a bridge 1210, a Switched Virtual Interface (SVI) ACLs 1212, a router 1214, a second network function 1216, an egress port 1218, and an output port 1220. The input port 1202 can receive the network traffic data and provide the network traffic data to the filtering network function 1204, which is operatively coupled to the input port 1202. The filtering network function 1204 can filter the network traffic data. The ingress port 1206 is operatively coupled to the filtering network function 1204, and the ingress port 1206 is operatively coupled to the first network function 1208. The first network function 1208 can process the network traffic data using one or more ingress ACLs. The bridge 1210 is operatively coupled to the first network function 1208. The bridge 1210 can perform a layer 2 (L2) bridging operation. The one or more SVI ACLs are operatively coupled to the bridge 1210 and the router 1214. The router 1214 can perform a layer 3 (L3) routing operation. The second network function 1216 is operatively coupled to the router 1214, The second network function 1216 can process the network traffic data using one or more egress ACLs. The egress port 1218 is operatively coupled to the second network function 1216. The egress port 1218 is operatively coupled to the output port 1220. The output port 1220 can output the network traffic data.

FIG. 13 is a network diagram of an example network pipeline that is optimized and accelerated on an acceleration hardware engine of a DPU having an NPAL according to at least one embodiment. The network pipeline 1300 includes an input port 1302, a filtering network function 1304, an ingress port with first network function 1306, a second network function 1308, a bridge 1310, an SVI ACLs 1312, a router 1314, a third network function 1316, an egress port with fourth network function 1318, and an output port 1320. The input port 1302 can receive the network traffic data and provide the network traffic data to the filtering network function 1304, which is operatively coupled to the input port 1302 with a first filtering network function 1304. The filtering network function 1304 can filter the network traffic data, providing the network traffic data to the ingress port with the first network function 1306. The first network function 1306 can perform first virtual local area network (VLAN) mapping on the network traffic data and provide the data to the second network function 1308 (or alternatively, the bridge 1310). The second network function can process the network traffic data using one or more ingress Access Control Lists (ACLs). The ingress ACLs can be dynamic or static ACLs. The bridge 1310 is operatively coupled to the first network function and the second network function 1308. The bridge 1310 can perform a layer 2 (L2) bridging operation. The SVI ACLs are operatively coupled to the bridge 1310 and the router 1314. The router 1314 can perform a layer 3 (L3) routing operation. The third network function 1316 is operatively coupled to the router 1314. The third network function 1316 can process the network traffic data using one or more egress ACLs. The egress ACLs can be dynamic or static. The egress port with fourth network function 1318 is operatively coupled to the third network function 1316. The fourth network function can perform second VLAN mapping on the network traffic data. The output port 1320 is operatively coupled to the egress port with fourth network function 1318. The output port 1320 can output the network traffic data.

FIG. 14 is a network diagram of an example network pipeline 1400 that is optimized and accelerated on an acceleration hardware engine of a DPU having an NPAL according to at least one embodiment. The network pipeline 1400 includes an input port 1402, a first network function 1404, a second network function 1406, a third network function 1408, a fourth network function 1410, a fifth network function 1412, a sixth network function 1414, a seventh network function 1416, and an output port 1418. The network pipeline 1400 can include any combination of network functions in a specified order, each network function including logic and/or tables to implement the respective network function and pass the network traffic data to the subsequent network function. In at least one embodiment, the first network function 1404 can perform layer 2 (L2) bridging, the second network function 1406 can perform layer 3 (L3) routing, the third network function 1408 can perform tunnel encapsulation or tunnel decapsulation, the fourth network function 1410 can perform a hash calculation, the fifth network function 1412 can perform an ECMP operation, the sixth network function 1414 can perform a CT operation, and the seventh network function 1416 can perform a NAT operation. Alternatively, the network pipeline 1400 can include different numbers and different types of network operations between the input port 1402 and output port 1418.

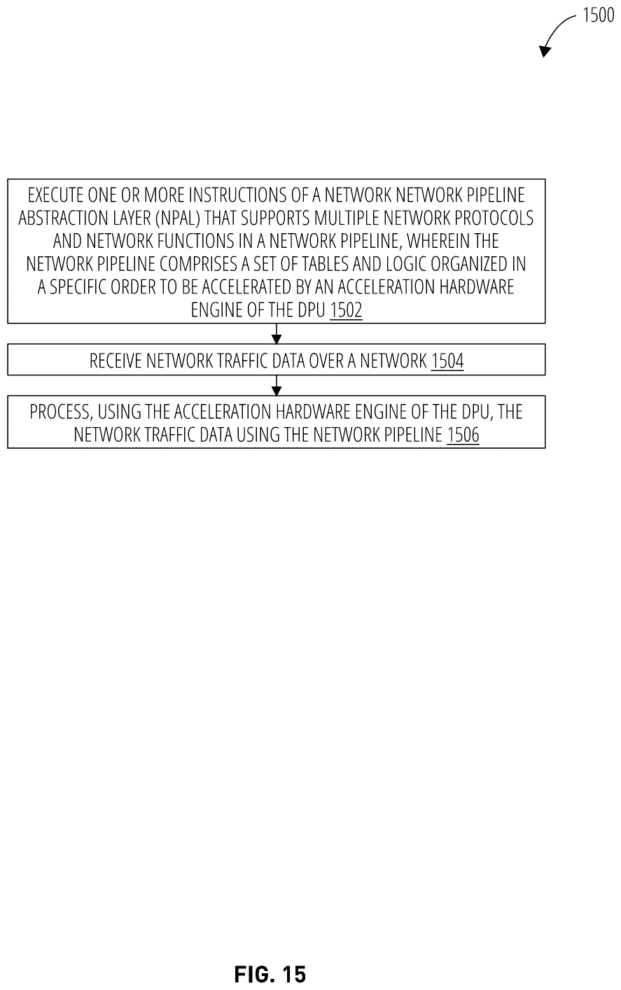

FIG. 15 is a flow diagram of an example method 1500 of creating an optimized and accelerated network pipeline using a network pipeline abstraction layer (NPAL) according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 1500 may be performed by multiple processing threads, each thread executing one or more individual functions, routines, subroutines, or operations of the method. In at least one embodiment, processing threads implementing method 1500 may be synchronized (e.g., using semaphores, critical sections, and/or other thread synchronization logic). Alternatively, processing threads implementing method 1500 may be executed asynchronously with respect to each other. Various operations of method 1500 may be performed differently than the order shown in FIG. 15. Some operations of the methods may be performed concurrently with other operations. In at least one embodiment, one or more operations shown in FIG. 15 may not always be performed.

Referring to FIG. 15, the processing logic begins with the processing logic executing one or more instructions of a network pipeline abstraction layer (NPAL) that supports multiple network protocols and network functions in a network pipeline (block 1502). The network pipeline includes a set of tables and logic organized in a specific order to be accelerated by an acceleration hardware engine of the DPU. At block 1504, the processing logic receives network traffic data over a network. At block 1506, the processing logic processes, using the acceleration hardware engine of the DPU, the network traffic data using the network pipeline.

In at least one embodiment, the network pipeline includes the ports and network functions described above with respect to FIG. 12, FIG. 13, and FIG. 14.

### NPAL Supporting Split Interfaces

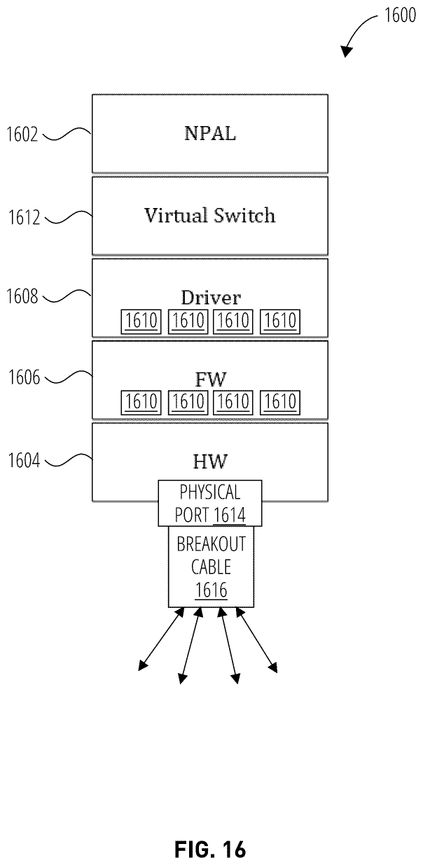

FIG. 16 is a block diagram of a software stack 1600 of a DPU with an NPAL 1602 that supports split interfaces according to at least one embodiment. As described above, to support port splitting, the DPU needs to support it in both hardware and software. From the hardware perspective, the DPU hardware includes a network interconnect, including one or more physical ports, coupled to a network, a host interconnect coupled to a host device, and an acceleration hardware engine. The network interconnect includes a physical port 1614 (or more physical ports) configured to be coupled to a breakout cable 1616 that physically couples to a set of a plurality of devices. The breakout cable 1616 physically separates data streams associated with the separate devices. In high-speed networking environments, especially in data centers, it is common to use breakout cables that allow a single high-speed port (such as 40 Gbps or 100 Gbps) to be “split” into multiple lower-speed ports (e.g., 4×10 Gbps or 4×25 Gbps). These breakout cables physically separate the data streams and allow multiple devices or ports to connect to a single high-speed interface. The DPU hardware can include additional hardware, such as a processing device (e.g., one or more CPU cores), one or more GPUs, switches, memory, or the like. It should also be noted that the DPU hardware can have a second physical port that is also split using a second breakout cable that physical couples to a second set of devices.

From the software perspective, the software stack 1600 can support the logical split ports through a single physical port 1614. The software stack 1600 can be stored in a memory of the DPU. The software stack 1600 includes firmware 1606, driver 1608, virtual switch 1612, and NPAL 1602. The firmware 1606 can interact with the DPU hardware 1604 and the driver 1608. The driver 1608 can interact with the firmware 1606 and the virtual switch 1612. The NPAL 1602 can sit on top of the virtual switch 1612. The software stack 1600 can be made up of instructions that when executed by the DPU hardware can provide the NPAL 1602 that supports multiple network protocols and network functions in a network pipeline for a set of logical split ports 1610. Each logical split port 1610 corresponds to one device of a set of device. As described above, the network pipeline includes a set of tables and logic organized in a specific order to be accelerated by the acceleration hardware engine.

In at least one embodiment, the firmware 1606 can be configured to generate multiple logical split port 1610 as physical functions (PFs) and map physical lanes of the physical port 1614 to the different logical split ports 1610. In at least one embodiment, the firmware 1606 and driver 1608 can present multiple logical split port 1610 as PFs to the virtual switch 1612 and NPAL 1602. The NPAL 1602 can be configured to manage each of the PFs as it were a separate physical port, even though they are supported over the single physical port 1614.

The NPAL 1602 can configure different policies to the different PFs. In at least one embodiment, a first logical split port is configured with a first policy, and a second logical split port is configured with a second policy different than the first policy. As described herein, the NPAL 1602 includes a set of APIs or classes that provide a unified interface to one or more applications executed by the processing device or a host device coupled to the DPU. The NPAL 1602 can be used to define the different policies to the different logical split ports. The NPAL 1602 can be used to configure the network pipeline to perform a first network function for a first logical split port (first PF) and a second network function for a second logical split port (second PF), the second network function being different than the first network function. For example, the network pipeline can be configured with different polices per PF, like different QoS requirements, different traffic management, or the like. In at least one embodiment, the different network functions can include L2 bridging, L3 routing, tunnel encapsulation, tunnel decapsulation, hash calculations, ECMP operations, static and dynamic ACLs, CT, etc. Similarly, different network functions can be performed for the other logical split ports (other PFs). Once configured, the DPU hardware can process the network traffic data using the network pipeline.

As illustrated in FIG. 16, the firmware 1606 generates a first logical split port, a second logical split port, a third logical split port, and a fourth logical split port because the breakout cable 1616 is coupled to four separate devices. For example, the physical port 1614 can support network traffic data at 100 Gbps (or 40 Gbps) to be “split” into multiple lower-speed logical ports at 4×25 Gbps (or 4×10 Gbps). Once the physical port 1614 is split physically and logically, the network pipeline can send network traffic data to any logical split port 1610 (i.e., to any PF) as part of the output port logic.

The generation and use of multiple PFs for a single physical port 1614 can be used to isolate networking between the PFs, provide better resource utilization, support more than two PFs instead of just one or more, etc. or the like. In at least one embodiment, the NPAL 1602 is configured to configure a first logical split port with a first policy and a second logical split port with a second policy different than the first policy. Similarly, the NPAL 1602 can configure a third logical split port with a third policy and a fourth logical split port with a fourth policy. The NPAL 1602 can configure multiple logical split ports with the same policy. In at least one embodiment, the NPAL 1602 is configured to isolate networking between the multiple PFs. In at least one embodiment, the set of logical split ports 1610 includes two or more logical splits (i.e., a number of logical split ports greater than two). The NPAL 1602 can provide customers or users a rich set of capabilities, high performance, and flexibility when breakout cables are plugged into the physical ports of the DPU.

In at least one embodiment, the network pipeline includes an input port, an ingress dynamic or static ACL, a bridge, a router, and egress dynamic or static ACL, and an output port having multiple logical split ports 1610.

In at least one embodiment, the network pipeline includes an input port to receive the network traffic data over the physical port 1614. The network pipeline includes a filtering network function operatively coupled to the input port, the filtering network function to filter the network traffic data. The network pipeline includes an ingress port operatively coupled to the filtering network function, and a first network function operatively coupled to the ingress port, the first network function to process the network traffic data using one or more ingress Access Control Lists (ACLs). The network pipeline includes a bridge operatively coupled to the first network function, the bridge to perform a L2 bridging operation, and one or more SVI ACLs (e.g., static or dynamic) operatively coupled to the bridge. The network pipeline includes a router operatively coupled to the SVI ACLs (e.g., static or dynamic), the router to perform a L3 routing operation. The network pipeline includes a second network function operatively coupled to the router, the second network function to process the network traffic data using one or more egress ACLs. The network pipeline includes an egress port operatively coupled to the second network function, and an output port having the set of logical split ports 1610 to output the network traffic data. As described above, once the physical port 1614 is split logically and physically, the network traffic data can be sent to any of the logical split ports 1610.

In at least one embodiment, the network pipeline includes an input port to receive the network traffic data over the physical port 1614. The network pipeline includes a filtering network function operatively coupled to the input port, the filtering network function to filter the network traffic data. The network pipeline includes an ingress port operatively coupled to the filtering network function, the ingress port having a first network function to perform first VLAN mapping on the network traffic data. The network pipeline includes a second network function operatively coupled to the ingress port, the second network function to process the network traffic data using one or more ingress ACLs. The network pipeline includes a bridge operatively coupled to the second network function, the bridge to perform a L2 bridging operation, and one or more SVI ACLs (e.g., static or dynamic) operatively coupled to the bridge. The network pipeline includes a router operatively coupled to the SVI ACLs (e.g., static or dynamic), the router to perform a layer 3 (L3) routing operation. The network pipeline includes a third network function operatively coupled to the router, the third network function to process the network traffic data using one or more egress ACLs. The network pipeline includes an egress port operatively coupled to the third network function, the egress port having a fourth network function to perform second VLAN mapping on the network traffic data. The network pipeline includes an output port with the set of logical split ports 1610 to output the network traffic data. As described above, once the physical port 1614 is split logically and physically, the network traffic data can be sent to any of the logical split ports 1610.

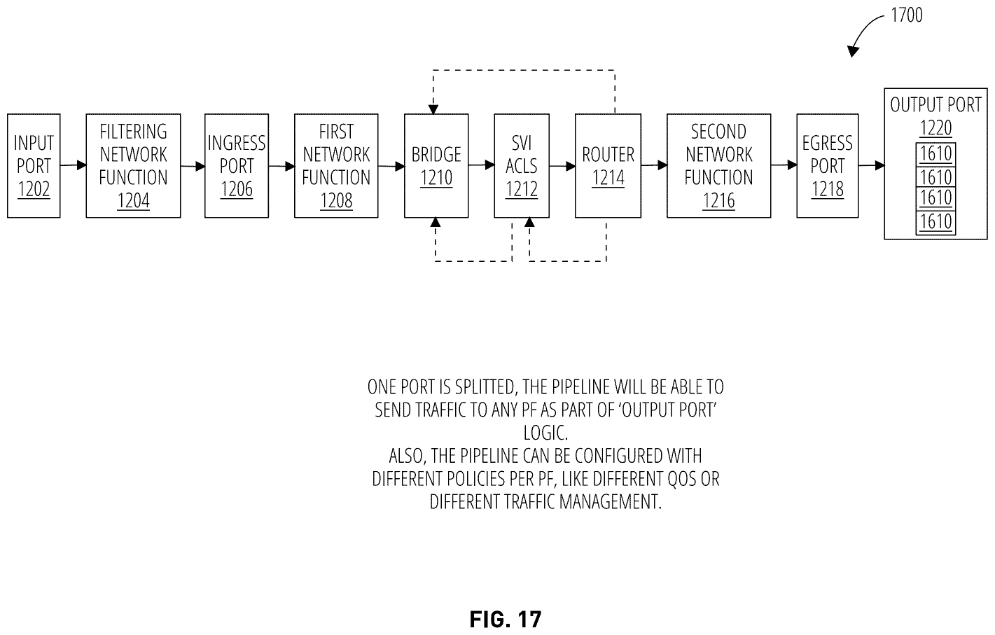

In at least one embodiment, the network pipeline includes two or more of the following network functions: a first network function to perform L2 bridging; a second network function to perform L3 routing; a third network function to perform tunnel encapsulation or tunnel decapsulation; a fourth network function to perform a hash calculation; a fifth network function to perform an ECMP operation; a sixth network function to perform a CT operation; or a seventh network function to perform a NAT operation. An example network pipeline is illustrated and described below with respect to FIG. 17.

FIG. 17 is a network diagram of an example network pipeline 1700 that is optimized and accelerated on an acceleration hardware engine of a DPU having an NPAL supporting split interfaces according to at least one embodiment. The network pipeline 1700 is similar to the network pipeline 1200 of FIG. 12, except the network pipeline 1700 can send network traffic data to any of the logical split ports 1610 of the output port 1220. The NPAL 1602 can configure different policies for the different logical splits. The network pipeline can process the network traffic data and send the network traffic data to the appropriate logical split port 1610.

As illustrated in FIG. 17, the network pipeline 1700 includes an input port 1202 that can receive the network traffic data and provide the network traffic data to the filtering network function 1204, which is operatively coupled to the input port 1202. The filtering network function 1204 can filter the network traffic data. The ingress port 1206 is operatively coupled to the filtering network function 1204, and the ingress port 1206 is operatively coupled to the first network function 1208. The first network function 1208 can process the network traffic data using one or more ingress ACLs. The bridge 1210 is operatively coupled to the first network function 1208. The bridge 1210 can perform a L2 bridging operation. The one or more SVI ACLs are operatively coupled to the bridge 1210 and the router 1214. The router 1214 can perform a L3 routing operation. The second network function 1216 is operatively coupled to the router 1214, The second network function 1216 can process the network traffic data using one or more egress ACLs. The egress port 1218 is operatively coupled to the second network function 1216. The egress port 1218 is operatively coupled to the output port 1220. The output port 1220 can output the network traffic data on any one of the logical split ports 1610.

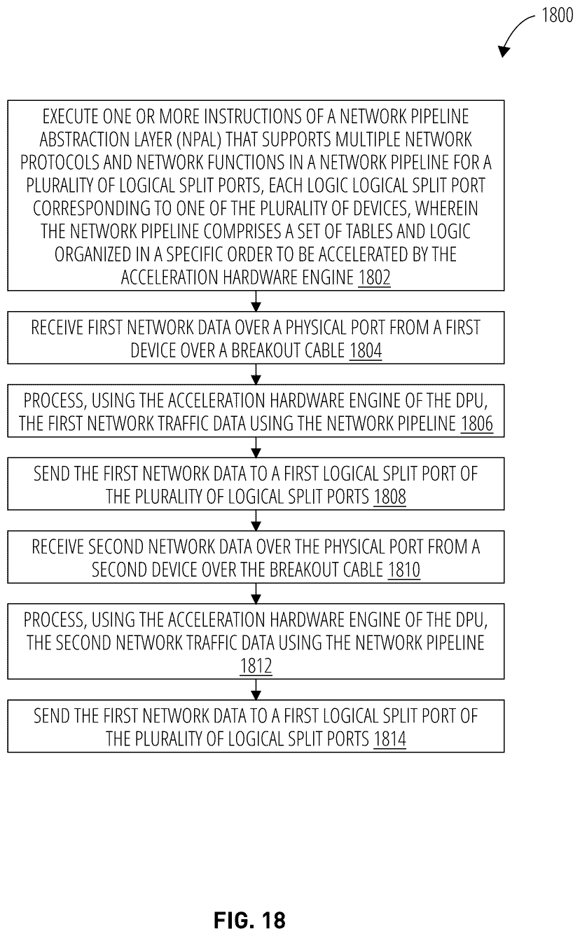

FIG. 18 is a flow diagram of a method 1800 of operating a DPU with split interfaces according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 1800 may be performed by multiple processing threads, each thread executing one or more individual functions, routines, subroutines, or operations of the method. In at least one embodiment, processing threads implementing method 1800 may be synchronized (e.g., using semaphores, critical sections, and/or other thread synchronization logic). Alternatively, processing threads implementing method 1800 may be executed asynchronously with respect to each other. Various operations of method 1800 may be performed differently than the order shown in FIG. 18. Some operations of the methods may be performed concurrently with other operations. In at least one embodiment, one or more operations shown in FIG. 18 may not always be performed.

Referring to FIG. 18, the processing logic begins with the processing logic executes one or more instructions of a NPAL that supports multiple network protocols and network functions in a network pipeline for a plurality of logical split ports (block 1802). Each logical split port corresponds to one of the plurality of devices. The network pipeline includes a set of tables and logic organized in a specific order to be accelerated by the acceleration hardware engine. At block 1804, the processing logic receives first network data over a physical port from a first device over a breakout cable. At block 1806, the processing logic processes, using the acceleration hardware engine of the DPU, the first network traffic data using the network pipeline. At block 1808, the processing logic sends the first network data to a first logical split port of the plurality of logical split ports. At block 1810, the processing logic receives second network data over the physical port from a second device over the breakout cable. At block 1812, the processing logic processes, using the acceleration hardware engine of the DPU, the second network traffic data using the network pipeline. At block 1814, the processing logic sends the first network data to a first logical split port of the plurality of logical split ports.

In a further embodiment, the processing logic configures the first logical split port with a first policy, and configures the second logical split port with a second policy different than the first policy.

In a further embodiment, the processing logic (e.g., firmware) maps physical lanes of the physical port to the plurality of logical split ports and presents the plurality of logical split ports as a plurality of physical functions (PFs) to a virtual switch and the NPAL. The processing logic (e.g., NPAL) manages each of the plurality of PFs as if it were a separate physical port.

In at least one embodiment, the processing logic configures the network pipeline to perform a first network function for a first PFs of a plurality of PFs, and configures the network pipeline to perform a second network function for a second PF of the plurality of PFs, the second network function being different than the first network function.

### NPAL Supporting Fast Link Recovery

As described above, link failure in network topologies refers to a situation where a communication link between two network devices, such as routers, NICs, switches, or hosts, becomes unavailable due to various reasons such as hardware failure, cable disconnection, or network congestion. Link failures can significantly impact the performance, availability, and reliability of network services, especially in large-scale or critical environments like data centers or enterprise networks. The are several reasons which might cause link failure, such as physical link failures (e.g., damage or disconnection of cables due to fiber cuts, broken Ethernet cables, etc.), device failures (e.g., hardware failures causing interfaces to go down), congestion or overload (i.e., network links overloaded with too much traffic causing timeouts or packet drops), software bugs or misconfigurations that cause a network device to drop connections, power failures, maintenance activities (e.g., planned outages for maintenance or upgrades might also cause temporary link failures), or the like. There can be different implications for link failures as described above.

One routing strategy is called ECMP. As described above, an NPAL can support fast link recovery when there is a link failure and an Equal-Cost Multi-Path (ECMP) group needs to be updated to reflect a new network topology. Due to the implications for link failure mentioned above, it is important to have fast recovery when link goes down. In particular, when link goes down, an ECMP group must be updated immediately to reflect that a specific link is no longer available. Also, when link goes up, the ECMP group must be updated immediately with the recovered link to allow better network utilization.

As described below in more detail, the NPAL can operate as an accelerated network pipeline and virtual switching hardware offload mechanism that periodically monitors links. In at least one embodiment, a user can configure the NPAL to support fast link recovery, enabling link monitoring by the virtual switch. For example, all ports in a specific ECMP group can be monitored using inter-process communication (IPC) messages, such as Linux Netlink messages from a Linux kernel. If a link goes down (i.e., experiences a link failure), the virtual switch identifies the link as being down and updates the ECMP group immediately by removing the link from the ECMP group. That is, the virtual switch updates the ECMP group in the tables in a bridge and/or a router of the network pipeline to remove the failed link. Once the ECMP group is updated, the traffic can be distributed to other links in the ECMP group. If a link goes up (i.e., no longer experiences a link failure), the virtual switch identifies the link as being up and updates the ECMP group immediately by adding the link from the ECMP group. That is, the virtual switch updates the ECMP group in the tables in the bridge and/or the router of the network pipeline to add the recovered link (also referred to as a new link). Once the ECMP group is updated, the traffic can be distributed to the new link along with the other links in the ECMP group.

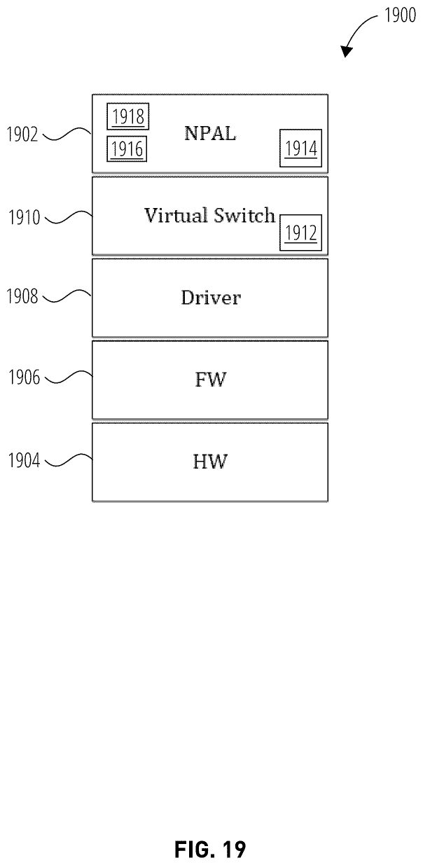

In at least one embodiment, a DPU includes DPU hardware, including a processing device and an acceleration hardware engine, and a memory operatively coupled to the DPU hardware. The memory can store instructions that, when executed by the DPU hardware, provide a virtual switch and a NPAL that fast link recovery. An example software stack of the DPU is illustrated and described below with respect to FIG. 19.

FIG. 19 is a block diagram of a software stack 1900 of a DPU with an NPAL 1902 that supports fast link recovery according to at least one embodiment. As described above, to support fast link recovery, the DPU needs to support it in both hardware and software. From the hardware perspective, the DPU hardware includes a network interconnect coupled to a network, a host interconnect coupled to a host device, and an acceleration hardware engine. The DPU hardware can include additional hardware, such as a processing device (e.g., one or more CPU cores), one or more GPUs, switches, memory, or the like.

From the software perspective, the software stack 1900 can support the fast link recovery. The software stack 1900 can be stored in a memory of the DPU. The software stack 1900 includes firmware 1906, driver 1908, virtual switch 1910, and NPAL 1902. The firmware 1906 can interact with the DPU hardware 1904 and the driver 1908. The driver 1908 can interact with the firmware 1906 and the virtual switch 1910. The NPAL 1902 can sit on top of the virtual switch 1910. The software stack 1900 can be made up of instructions that when executed by the DPU hardware can provide the NPAL 1902 that supports multiple network protocols and network functions in a network pipeline. As described above, the network pipeline includes a set of tables and logic organized in a specific order to be accelerated by the acceleration hardware engine.

In at least one embodiment, the virtual switch 1910 can include link monitoring logic 1912 that monitors a link availability of each of a plurality of links to a destination. The plurality of links can be part or specified in an initial group of identifiers in a routing table 1918. That is, the link monitoring logic 1912 can monitor if a link is available by monitoring all ports associated with the initial group of link identifiers. The link monitoring logic 1912 can detect a link failure of a first link of the plurality of links. The link monitoring logic 1912 can notify ECMP logic 1914 in the NPAL 1902. The ECMP logic 1914 can remove a first link identifier, associated with the first link, from the initial group of link identifiers to obtain a modified group of link identifiers in an ECMP group table 1916. The ECMP logic 1914 can also cause a routing table 1918 in the NPAL 1902 to be updated to remove the first link identifier. The acceleration hardware engine in the DPU hardware 1904 can process network traffic data using the network pipeline and distribute the network traffic data to only the remaining links of the plurality of links corresponding to the modified group of identifiers.

In at least one embodiment, the virtual switch is controlled by a network service hosted on the DPU. The virtual switch can send a notification to the network service of the link failure of the first link. The network service can update the routing table in the NPAL in response to the notification. The routing table stores configuration information associated with the initial group of identifiers. In at least one embodiment, the notification is a message from a kernel (e.g., NetLink message from a Linux kernel).

In at least one embodiment, the ECMP logic 1914 can receive a first packet prior to the link failure of the first link, and perform an IP address lookup for the first packet to identify an ECMP group identifier associated with the plurality of links. The ECMP logic 1914 can hash the ECMP group identifier to identify any one of the plurality of links. The ECMP logic 1914 can receive a second packet after the link failure of the first link, and perform an IP address lookup for the second packet to identify the ECMP group identifier. The ECMP logic 1914 can hash the ECMP group identifier to identify any one of the remaining links.

In at least one embodiment, the virtual switch 1910 can monitor the link availability of each of the plurality of links to the destination, and detect a link recovery of the first link. The ECMP logic 1914 can add the first link identifier to the modified group of link identifiers to obtain the initial group of link identifiers in the ECMP group table 1916. The ECMP logic 1914 can cause the routing table 1918 in the NPAL 1902 to be updated to add the first link identifier. The acceleration hardware engine is to process subsequent network traffic data using the network pipeline and distribute the subsequent network traffic data to the plurality of links corresponding to the initial group of identifiers. In at least one embodiment, the ECMP logic 1914 can receive a first packet prior to the link recovery of the first link, and perform an IP address lookup for the first packet to identify an ECMP group identifier associated with the plurality of links. The ECMP logic 1914 can hash the ECMP group identifier to identify any one of the remaining links. The ECMP logic 1914 can receive a second packet after the link recovery of the first link, and perform an IP address lookup for the second packet to identify the ECMP group identifier. The ECMP logic 1914 can hash the ECMP group identifier to identify any one of the plurality of links.

In at least one embodiment, the virtual switch 1910 is controlled by a network service hosted on the DPU. The virtual switch 1910 can send a first notification to the network service of the link failure of the first link, the network service to update the routing table in the NPAL in response to the first notification, the routing table storing configuration information associated with the initial group of identifiers. The virtual switch 1910 can send a second notification to the network service of the link recovery of the first link, the network service to update the routing table 1918 in the NPAL 1902 in response to the second notification. In at least one embodiment, the virtual switch 1910 can remove the first link identifier from the ECMP group in the virtual switch 1612, and modify the routing table 1918 in the NAPL in parallel.

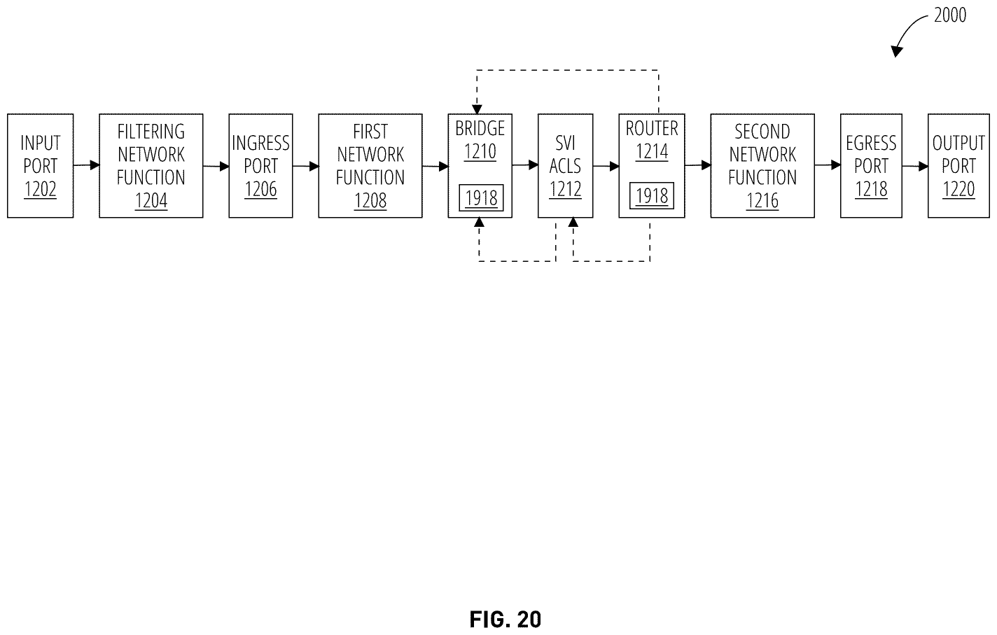

In at least one embodiment, the network pipeline includes an input port, an ingress dynamic or static ACL, a bridge, a router, and egress dynamic or static ACL, and an output port. The routing table 1918 can be stored in the bridge, the router, or both. An example network pipeline is illustrated and described below with respect to FIG. 20.

FIG. 20 is a network diagram of an example network pipeline 2000 that is optimized and accelerated on an acceleration hardware engine of a DPU having an NPAL supporting fast link recovery according to at least one embodiment. The network pipeline 2000 is similar to the network traffic data 120 of FIG. 12, except network pipeline 2000 includes a routing table 1918 stored at the bridge 1210, the router 1214, or both. As described above, the virtual switch can monitor a link availability of each of a plurality of links to a destination. Once the virtual switch detects a link failure of a first link, the virtual switch can remove a first link identifier, associated with the first link, from an initial group of link identifiers to obtain a modified group of link identifiers in the ECMP group table 1916. The virtual switch causes the routing table 1918 to be updated to remove the first link identifier. Once the routing table 1918 is updated, the acceleration hardware engine can process network traffic data using the network pipeline and distribute the network traffic data to only the remaining links of the plurality of links corresponding to the modified group of identifiers. Similarly, the virtual switch can continue monitoring the link availability of each link. The virtual switch can detect a link recovery of the first link. The virtual switch can add the first link identifier to the modified group of link identifiers to obtain the initial group of link identifiers, and cause the routing table 1918 to be updated to add the first link identifier. Once the routing table 1918 is updated, the acceleration hardware engine can process subsequent network traffic data using the network pipeline and distribute the subsequent network traffic data to the plurality of links corresponding to the initial group of identifiers.

As illustrated in FIG. 20, the network pipeline 2000 includes an input port 1202, a filtering network function 1204, an ingress port 1206, a first network function 1208, a bridge 1210 storing the routing table 1918, SVI ACLs 1212, a router 1214 storing the routing table 1918, a second network function 1216, an egress port 1218, and an output port 1220. The input port 1202 can receive the network traffic data and provide the network traffic data to the filtering network function 1204, which is operatively coupled to the input port 1202. The filtering network function 1204 can filter the network traffic data. The ingress port 1206 is operatively coupled to the filtering network function 1204, and the ingress port 1206 is operatively coupled to the first network function 1208. The first network function 1208 can process the network traffic data using one or more ingress ACLs. The bridge 1210 is operatively coupled to the first network function 1208. The bridge 1210 can perform an ECMP bridge operation using a current routing table 1918, excluding any failed links as described above. The one or more SVI ACLs are operatively coupled to the bridge 1210 and the router 1214. The router 1214 can perform an ECMP routing operation using the current routing table 1918, excluding any failed links as described above. The second network function 1216 is operatively coupled to the router 1214, The second network function 1216 can process the network traffic data using one or more egress ACLs. The egress port 1218 is operatively coupled to the second network function 1216. The egress port 1218 is operatively coupled to the output port 1220. The output port 1220 can output the network traffic data.

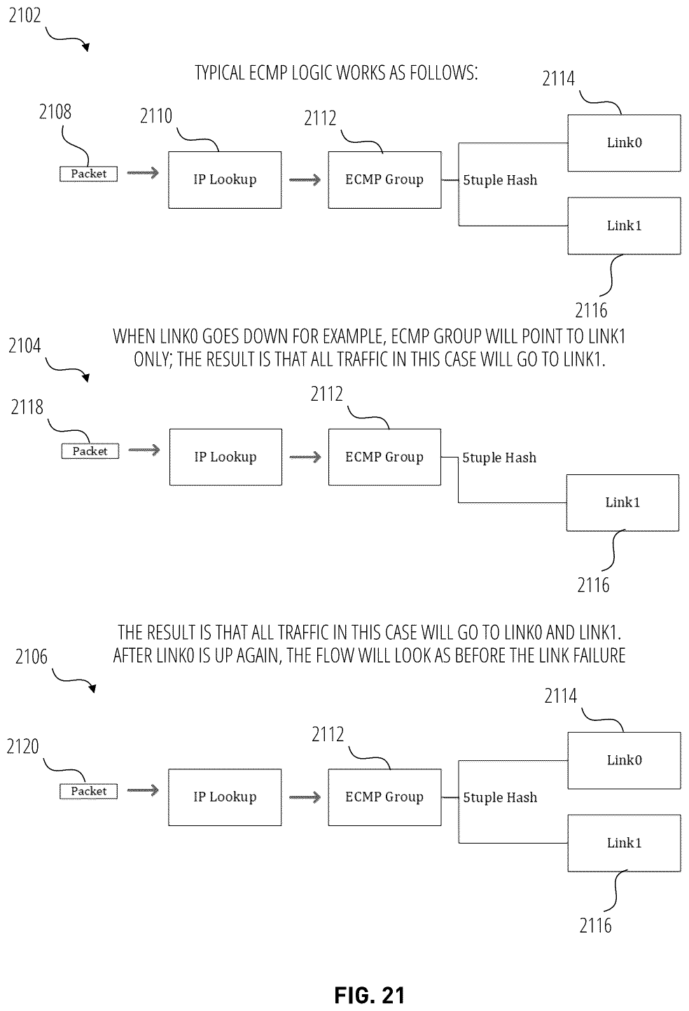

As described above, the NPAL can include ECMP logic 1914 that performs ECMP operations on incoming packets before a link failure, after a link failure, and after a link recovery, such as illustrated and described below with respect to FIG. 21.

FIG. 21 are flow diagrams of ECMP operations before a link failure, after a link failure, and after a link recovery according to at least one embodiment. In a first flow 2102, the ECMP logic receives a first packet 2108 and performs an IP lookup operation 2110 that returns an ECMP group 2112. The ECMP group 2112 can be a 5tuple hash that identifies a first link 2114 (Link0) and a second link 2116 (Link1) as part of the ECMP group 2112. The first flow 2102 is before a link failure is detected.

In a second flow 2104, if a link failure is detected for the first link 2114, the ECMP logic receives a second packet 2118 and performs the IP lookup operation 2110 that returns the ECMP group 2112. The 5tuple hash of the ECMP group 2112 in this instances identifies only the second link 2116, since the first link 2114 has a link failure. The result is that all traffic in this case will go to only the second link 2116 (Link1). The second flow 2104 is after a link failure is detected.

In a third flow 2106, if a link recovery is detected for the first link 2114, the ECMP logic receives a third packet 2120 and performs the IP lookup operation 2110 that returns the ECMP group 2112. In this instances, the ECMP group 2112 can be a 5tuple hash that identifies the first link 2114 (Link0) and the second link 2116 (Link1) as part of the ECMP group 2112. The result is that all traffic in this case will go to both the first link 2114 (Link0) and the second link 2116 (Link1). The third flow 2106 is after a link recovery is detected.

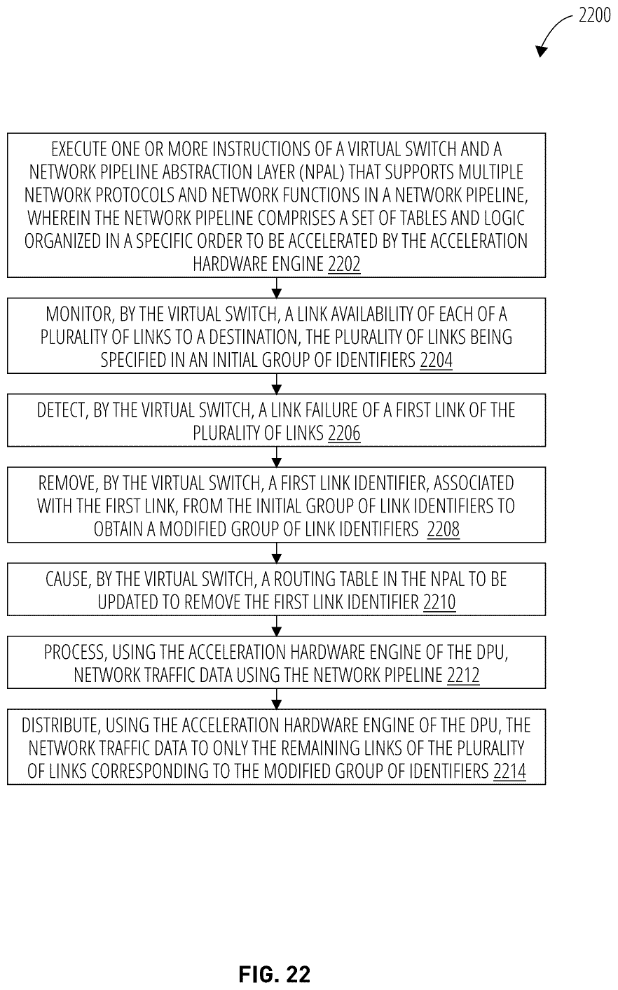

FIG. 22 is a flow diagram of a method 2200 of operating a DPU with fast link recovery according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 2200 may be performed by multiple processing threads, each thread executing one or more individual functions, routines, subroutines, or operations of the method. In at least one embodiment, processing threads implementing method 2200 may be synchronized (e.g., using semaphores, critical sections, and/or other thread synchronization logic). Alternatively, processing threads implementing method 2200 may be executed asynchronously with respect to each other. Various operations of method 2200 may be performed differently than the order shown in FIG. 22. Some operations of the methods may be performed concurrently with other operations. In at least one embodiment, one or more operations shown in FIG. 22 may not always be performed.

Referring to FIG. 22, the processing logic begins with the processing logic executing one or more instructions of a virtual switch and a NPAL that supports multiple network protocols and network functions in a network pipeline (block 2202). The network pipeline includes a set of tables and logic organized in a specific order to be accelerated by the acceleration hardware engine. At block 2204, the processing logic monitors, by the virtual switch, a link availability of each of a plurality of links to a destination, the plurality of links being specified in an initial group of identifiers. At block 2206, the processing logic detects, by the virtual switch, a link failure of a first link of the plurality of links. At block 2208, the processing logic removes, by the virtual switch, a first link identifier, associated with the first link, from the initial group of link identifiers to obtain a modified group of link identifiers. At block 2210, the processing logic causes, by the virtual switch, a routing table in the NPAL to be updated to remove the first link identifier. At block 2212, the processing logic processes, using the acceleration hardware engine of the DPU, network traffic data using the network pipeline. At block 2214, the processing logic distributes, using the acceleration hardware engine of the DPU, the network traffic data to only the remaining links of the plurality of links corresponding to the modified group of identifiers.

In a further embodiment, the initial group of link identifiers is an Equal-Cost Multi-Path group (ECMP group). The processing logic removes the first link identifier from the initial group by removing the first link identifier from the ECMP. The processing logic causes the routing table in the NPAL to be updated in parallel with removing the first link identifier from the ECMP.

In a further embodiment, the processing logic receives a first packet prior to the link failure of the first link. The processing logic performs an IP address lookup for the first packet to identify an ECMP group identifier associated with the plurality of links. The processing logic hashes the ECMP group identifier to identify any one of the plurality of links. The processing logic receives a second packet after the link failure of the first link. The processing logic performs an IP address lookup for the second packet to identify the ECMP group identifier. The processing logic hashes the ECMP group identifier to identify any one of the remaining links.

In a further embodiment, the processing logic monitors the link availability of each of the plurality of links to the destination. The processing logic detects a link recovery of the first link. The processing logic adds the first link identifier to the modified group of link identifiers to obtain the initial group of link identifiers. The processing logic causes the routing table in the NPAL to be updated to add the first link identifier. The acceleration hardware engine can process subsequent network traffic data using the network pipeline and distribute the subsequent network traffic data to the plurality of links corresponding to the initial group of identifiers.

In a further embodiment, the processing logic receives a first packet prior to the link recovery of the first link. The processing logic performs an Internet Protocol (IP) address lookup for the first packet to identify an ECMP group identifier associated with the plurality of links. The processing logic hashes the ECMP group identifier to identify any one of the remaining links. The processing logic receives a second packet after the link recovery of the first link. The processing logic performs an IP address lookup for the second packet to identify the ECMP group identifier. The processing logic hashes the ECMP group identifier to identify any one of the plurality of links.

### NPAL Supporting PBR Over SFC Architecture

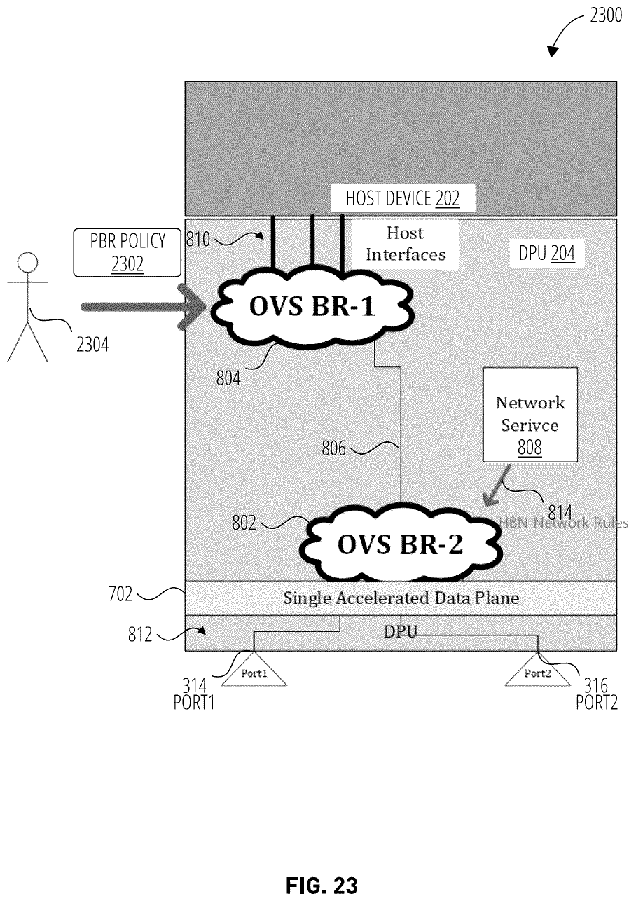

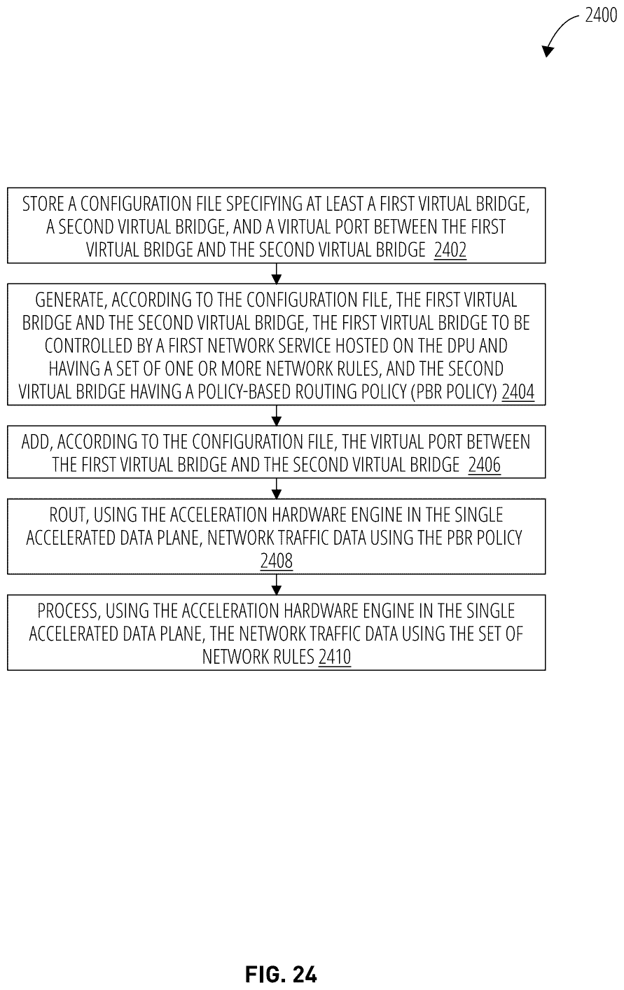

In at least one embodiment, the NPAL can provide hardware-accelerated Policy-Based Routing (PBR) over SFC architecture of a DPU. Using an SFC on the DPU, a user (or controller) can add different PBR policies, which are accelerated by DPU hardware as single data plane on the DPU. As described above, the PBR is a technique that allows network administrators to make routing decisions based on policies set by the network administrator, rather than relying on the default routing table, which uses destination IP addresses to determine the next hop. With traditional routing, a router decides how to forward packets based on the destination IP address and the routing table. PBR allows the router to make routing decisions based on other criteria, such as: Source IP address or subnet; IP protocol type; Port number; Ingress interface; Packet size, QoS parameters, etc. PBR is useful for controlling the path that traffic takes through a network. It gives network administrators greater flexibility to implement routing rules that depend on more than just the destination IP address, as described below with respect to FIG. 23 and FIG. 24.

FIG. 23 is a block diagram of an SFC architecture 2300 with a PBR policy 2302 according to at least one embodiment. The SFC architecture 2300 is similar to the SFC architecture 800 of FIG. 8 and SFC architecture 300 of FIG. 3, except the PBR policy 2302 is used instead of the user-defined network rules 816 in the SFC architecture 800. The SFC architecture 2300 includes a first virtual bridge 802 (labeled “OVS BR-1”), a second virtual bridge 804 (labeled “OVS BR-2”), a virtual port 806, and a network service 808. As described herein, the SFC logic 102 can generate the first virtual bridge 802, the second virtual bridge 804, and the virtual port 806 in the SFC architecture 800. The SFC logic 102 can configure the first virtual bridge 802 to be controlled by network service rules 814 provided by the network service 808 hosted on the DPU 204 and the second virtual bridge 804 to be controlled by the PBR policy 2302. The SFC logic 102 adds a service interface to the first virtual bridge 802 to operatively couple the network service 808 to the first virtual bridge 802. The SFC logic 102 adds the virtual port 806 between the first virtual bridge 802 and second virtual bridge 804. The network service 808 can provide one or more network service rules 814 to the first virtual bridge 802. The user-defined logic 126 can provide one or more PBR policies 2302 to the second virtual bridge 804. The user-defined logic 126 can be a user or can be a controller as described herein. The SFC logic 102 can add one or more host interfaces 310 to the second virtual bridge 804.

In at least one embodiment, the first virtual bridge 802 and the second virtual bridge 804 are OVS bridges. The processing device can execute an OVS application with hardware offload mechanisms to provide the single accelerated data plane 702 in the acceleration hardware engine to route the network traffic data using the PBR policy 2302 and process the network traffic data using the set of one or more network rules.

As illustrated, three separate host interfaces can be added to connect the second virtual bridge 804 to hosts, such as three separate VMs hosted on the host device 202. For example, one VM can host a firewall application, another VM can host a load balancer application, and another VM can host an IDS application. The SFC logic 102 can add one or more network interfaces 812 to the first virtual bridge 802. In particular, the SFC logic 102 can add to the first virtual bridge 802, a first network interface to operatively couple to a first network port 314 (labeled PORT1) of the DPU 204, and a second network interface to operatively couple to a second network port 316 (labeled PORT2) of the DPU 204. The first virtual bridge 802 can receive network traffic data from the first network port 314 and the second network port 316. The first virtual bridge 802 can direct the network traffic data to the second virtual bridge 804 via the virtual port 806. The second virtual bridge 804 can direct the network traffic data to the corresponding host via the host interfaces 810.

In at least one embodiment, the PBR policy 2302 can be provided by a user 2304. The user 2304 can provide the PBR policy 2302 using the user-defined logic 126. The user 2304 can program the second virtual bridge 804 with the PBR policy 2302. Alternatively, user-defined logic 126 can receive user input from the user 2304, and the user-defined logic 126 can generate the PBR policy 2302 and provide them to the second virtual bridge 804. In another embodiment, the PBR policy 2302 can be provided by a user-defined service or another network service that is separate from the network service 808. The other network service (or user-defined service) can be a user-defined network service, a user-defined security service, a user-defined telemetry service, a user-defined storage service, or the like, hosted on the DPU 204 or as applications on the host device 202. When the PBR policy 2302 is provided by a second network service, the SFC logic 102 can add another service interface to the second virtual bridge 804 to operatively couple the second network service to the second virtual bridge 804. In another, a controller can provide the PBR policy 2302 to the second virtual bridge 804.

The DPU 204 can combine the network rules, corresponding to the different network services, to obtain a combined set of network rules that can be accelerated in a single accelerated data plane 702 of the DPU 204. The combined set of network rules become hardware-accelerated rules that are accelerated by the DPU 204 for the SFC architecture 800.

In at least one embodiment, the DPU 204 provides a DPU service that supports Host Based Networking (HBN) as the network service 808 for acceleration of L2/L3/tunneling protocols on the DPU 204. The HBN infrastructure is based on an SFC topology, where one OVS bridge is controlled by the HBN service providing all accelerated networking capabilities. As described above, the second OVS bridge (second virtual bridge 804) can be programmable by the user 2304 or any other controller (as illustrated in FIG. 9). The HBN service can support different protocols and different network capabilities, such as ACLs, ECMP, tunneling, CT and more. The user 2304 can program in a flexible manner different routing rules per one or more PBR policies over the SFC architecture 2300 in parallel to HBN service, which will result in hardware-accelerated rules 708 for the single accelerated data plane 702 provided by OVS-DOCA and the DPU hardware. Using the SFC infrastructure, users and customers can leverage the DPU 204 as networking accelerator on an edge device without the need for sophisticated and smart switches in different network topologies in a DC network or a SP network.

It should be noted that the SFC logic 102 can generate different combinations of hardware-accelerated rules 708 in different SFC architectures, such as illustrated and described herein.

In at least one embodiment, an acceleration hardware engine of the DPU 204 provides the single accelerated data plane 702. The DPU 204 can include memory to store a configuration file specifying at least a first virtual bridge, a second virtual bridge, and a virtual port between the first virtual bridge and the second virtual bridge. A processing device of the DPU can generate the first virtual bridge and the second virtual bridge, the first virtual bridge to be controlled by a first network service hosted on the DPU and having a set of one or more network rules, and the second virtual bridge having the PBR policy 2302. The processing device can add the PBR policy to the second virtual bridge. The processing device can add the virtual port between the first virtual bridge and the second virtual bridge. The acceleration hardware engine, in the single accelerated data plane 702, can route network traffic data using the PBR policy and process the network traffic data using the set of one or more network rules.

In at least one embodiment, the processing device can receive user input from the user 2304 (or a controller). The user input can specify the PBR policy 2302. The SFC architecture 2300 can include one or more routing rules, each including a matching condition (also referred to as a matching criterion or matching criteria), and a corresponding action. It should be noted that the matching condition can be a condition that does not include the destination address, as used in traditional routing. In at least one embodiment, the matching condition specifies at least one of the following: a source IP address; a source or destination port; a protocol identifier; a virtual local area network (VLAN) tag; a Differentiated Service Code Point (DSCP) or Type of Service (ToS) value; an application or service type; a time of day; or similar conditions. The action can include at least one of the following: a forward action; a drop action; a re-route action; a mirror action; a load balance action; a rate limit action; a Quality of Service (Qos) marking action; a traffic shaping action; an encapsulation action; a redirect action; or other similar actions.

In at least one embodiment, the processing device, according to the configuration file, can add one or more host interfaces 810 to the second virtual bridge 804 to operatively couple to one or more host devices 202 operatively coupled to the DPU 204. The processing device can add one or more network interfaces 812 to the first virtual bridge 802 to operatively couple to one or more network ports 314 and 316 of the DPU 204. The processing device can add a first service interface to the first virtual bridge to operatively couple to the first network service, the first network service to provide accelerated network capabilities using the set of one or more network service rules 814 (e.g., L2 protocol rule, a L3 protocol rule, a tunneling protocol rule, an ACL rule, an ECMP rule, a tunneling encapsulation rule, a tunneling decapsulation rule, a CT rule, a VLAN rule, or a NAT rule). The network service rules 814 can include one or more steering rules (e.g., an application-based steering rule, a policy-based steering rule, a geolocation-based steering rule, a load balancing rule, a QoS rule, a failover rule, a redundancy rule, a security-based steering rule, a cost-based routing rule, a SD-WAN path steering rule, or a SDN rule.

In at least one embodiment, the processing device, according to the configuration file, can add one or more host interfaces 810 to the second virtual bridge 804 to operatively couple to one or more host devices 202 operatively coupled to the DPU 204. The processing device can add one or more network interfaces 812 to the first virtual bridge 802 to operatively couple to one or more network ports of the DPU 204. The processing device can add a first service interface to the first virtual bridge 802 to operatively couple to the first network service. The processing device can add a second service interface to the second virtual bridge 804 to operatively couple a second network service, the second network service wherein the first network service and the second network service are part of a SFC infrastructure to provide accelerated network capabilities in the single accelerated data plane 702 using a combined set of network rules. The combined set of rules include the set of one or more network rules associated with the first network service and a second set of one or more network rules associated with the second network service.

In at least one embodiment, an operating system (OS) can be installed and executed on a processing device of the DPU 204. The generation of the plurality of virtual bridges and the interface mappings of the plurality of virtual bridges can be part of installing the OS on the DPU 204. In at least one embodiment, The generation of the plurality of virtual bridges and the interface mappings of the plurality of virtual bridges can be part of runtime of the DPU 204 and without reinstallation of the OS on the DPU 204.

FIG. 24 is a flow diagram of a method 2400 of operating a DPU supporting PBR over an SFC architecture according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 2400 may be performed by multiple processing threads, each thread executing one or more individual functions, routines, subroutines, or operations of the method. In at least one embodiment, processing threads implementing method 2400 may be synchronized (e.g., using semaphores, critical sections, and/or other thread synchronization logic). Alternatively, processing threads implementing method 2400 may be executed asynchronously with respect to each other. Various operations of method 2400 may be performed differently than the order shown in FIG. 24. Some operations of the methods may be performed concurrently with other operations. In at least one embodiment, one or more operations shown in FIG. 24 may not always be performed.

Referring to FIG. 24, the processing logic begins with the processing logic storing a configuration file specifying at least a first virtual bridge, a second virtual bridge, and a virtual port between the first virtual bridge and the second virtual bridge (block 2402). At block 2404, the processing logic generates, according to the configuration file, the first virtual bridge and the second virtual bridge, the first virtual bridge to be controlled by a first network service hosted on the DPU and having a set of one or more network rules, and the second virtual bridge having a PBR policy. At block 2406, the processing logic adds, according to the configuration file, the virtual port between the first virtual bridge and the second virtual bridge. At block 2408, the processing logic routes, using the acceleration hardware engine in the single accelerated data plane, network traffic data using the PBR policy. At block 2410, the processing logic processes, using the acceleration hardware engine in the single accelerated data plane, the network traffic data using the set of network rules.

In a further embodiment, the processing logic receives receiving user input from a user or a controller, the user input specifying the PBR policy. The PBR policy includes one or more routing rules each including a matching condition and a corresponding action. The processing logic adds the PBR policy to the second virtual bridge. The matching condition can be any of the examples described above. Similarly, the action can be any of the examples described above.

In a further embodiment, the processing logic adds, according to the configuration file, one or more host interfaces to the second virtual bridge to operatively couple to one or more host devices operatively coupled to the DPU. The processing logic adds, according to the configuration file, one or more network interfaces to the first virtual bridge to operatively couple to one or more network ports of the DPU. The processing logic adds, according to the configuration file, a first service interface to the first virtual bridge to operatively couple to the first network service, the first network service to provide accelerated network capabilities using the set of one or more network rules.

In a further embodiment, the processing logic adds, according to the configuration file, one or more host interfaces to the second virtual bridge to operatively couple to one or more host devices operatively coupled to the DPU. The processing logic adds, according to the configuration file, one or more network interfaces to the first virtual bridge to operatively couple to one or more network ports of the DPU. The processing logic adds, according to the configuration file, a first service interface to the first virtual bridge to operatively couple to the first network service, the first network service to provide accelerated network capabilities using the set of one or more network rules (e.g., L2 protocol rule, a L3 protocol rule, a tunneling protocol rule, an ACL rule, an ECMP rule, a tunneling encapsulation rule, a tunneling decapsulation rule, a CT rule, a VLAN rule, or a NAT rule). The network service rules 814 can include one or more steering rules (e.g., an application-based steering rule, a policy-based steering rule, a geolocation-based steering rule, a load balancing rule, a QoS rule, a failover rule, a redundancy rule, a security-based steering rule, a cost-based routing rule, a SD-WAN path steering rule, or a SDN rule.

In a further embodiment, the processing logic adds, according to the configuration file, one or more host interfaces to the second virtual bridge to operatively couple to one or more host devices operatively coupled to the DPU. The processing logic adds, according to the configuration file, one or more network interfaces to the first virtual bridge to operatively couple to one or more network ports of the DPU. The processing logic adds, according to the configuration file, a first service interface to the first virtual bridge to operatively couple to the first network service. The processing logic adds, according to the configuration file, a second service interface to the second virtual bridge to operatively couple a second network service, the second network service wherein the first network service and the second network service are part of a SFC infrastructure to provide accelerated network capabilities in the single accelerated data plane using a combined set of network rules. The combined set of rules includes the set of one or more network rules associated with the first network service and a second set of one or more network rules associated with the second network service.

### NPAL Emulation

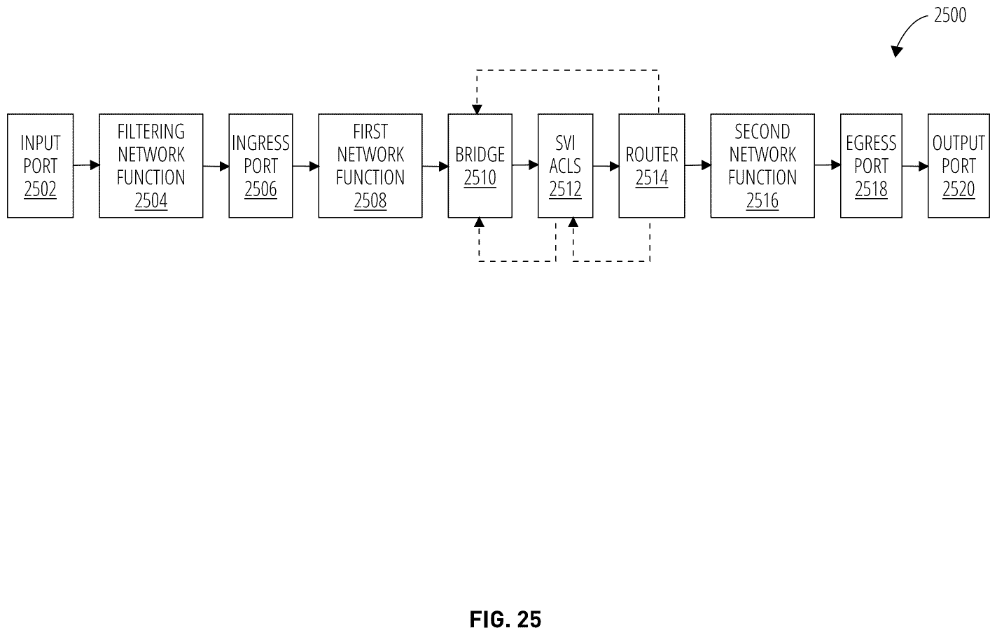

As described herein, an emulated NPAL can be used to emulate a hardware DPU with an NPAL as an emulated network pipeline. An emulated network pipeline refers to a software-based framework that mimics or emulates the behavior of a hardware-based networking pipeline, which typically exists in physical networking devices like switches, routers, NICs, DPUs etc. The emulated pipeline is implemented in software, often in environments like virtual machines (VMs) or containerized environments, to simulate the same packet processing, forwarding, and routing decisions as hardware pipelines, without relying on physical network hardware. An emulated network pipeline takes on the roles of traditional networking hardware (like packet switching, traffic management, firewalling, etc.) but runs entirely as software. This is useful in scenarios where physical network hardware is not available, or when testing, development, or virtualized environments require networking functionality. In at least one embodiment, a computing system include one or more processors and one or more memories storing instructions that when executed by the one or more processors perform operations of an emulated network pipeline abstraction layer (NPAL) of an emulated data processing unit (DPU). The DPU includes an emulated processing device and an emulated acceleration hardware engine. The emulated NPAL supports multiple network protocols and network functions in an emulated network pipeline. The emulated network pipeline includes a set of tables and logic organized in a specific order to be accelerated by the emulated acceleration hardware engine. The emulated acceleration hardware engine is to process network traffic data using the emulated network pipeline. An example emulated network pipeline is illustrated and described below with respect to FIG. 25.

FIG. 25 is a block diagram of an emulated network pipeline 2500 on an emulated acceleration hardware engine of an emulated DPU having an emulated NPAL according to at least one embodiment. The emulated network pipeline 2500 includes a set of tables and logic organized in a specific order to be accelerated by an emulated acceleration hardware engine. The emulated acceleration hardware engine can process network traffic data using the emulated network pipeline 2500. As illustrated, the emulated network pipeline 2500 includes an input port 2502, a filtering network function 2504, an ingress port 2506, a first network function 2508, a bridge 2510, an SVI ACLs 2512, a router 2514, a second network function 2516, an egress port 2518, and an output port 2520. The input port 2502 can receive the network traffic data and provide the network traffic data to the filtering network function 2504, which is operatively coupled to the input port 2502. The filtering network function 2504 can filter the network traffic data. The ingress port 2506 is operatively coupled to the filtering network function 2504, and the ingress port 2506 is operatively coupled to the first network function 2508. The first network function 2508 can process the network traffic data using one or more ingress ACLs. The bridge 2510 is operatively coupled to the first network function 2508. The bridge 2510 can perform a L2 bridging operation. The one or more SVI ACLs are operatively coupled to the bridge 2510 and the router 2514. The router 2514 can perform a L3 routing operation. The second network function 2516 is operatively coupled to the router 2514, The second network function 2516 can process the network traffic data using one or more egress ACLs. The egress port 2518 is operatively coupled to the second network function 2516. The egress port 2518 is operatively coupled to the output port 2520. The output port 2520 can output the network traffic data.

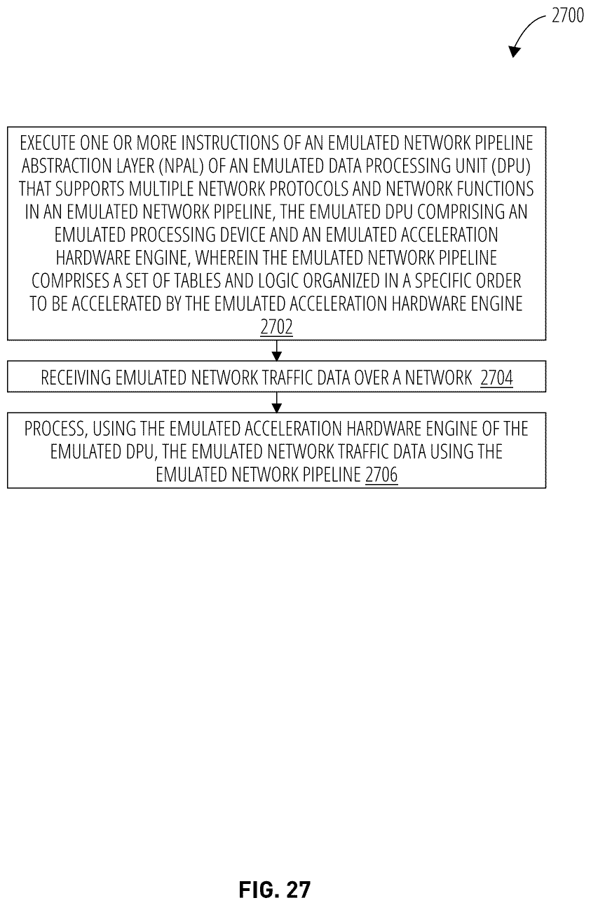

Unlike the network pipeline 1200 of FIG. 12 that is part of the DPU 204 of FIG. 2, the emulated network pipeline 2500 is implemented in an emulated DPU, such as illustrated in FIG. 27. The emulated network pipeline 2500 can be used in connection with the various embodiments described herein, including the configurable and dynamic SFC interfaces in a DPU, Hardware-Accelerated Flexible Steering Rules of SFC Architecture in a DPU, an NPAL of a DPU, OVS bridges, NPAL split interfaces, NPAL fast link recovery, PBR over SFC, or the like.

In at least one embodiment, the one or more processors can further emulate an emulated physical port of the emulated DPU configured to couple to an emulated breakout cable that physically couples to a set of a plurality of emulated devices. The one or more processors can further emulate an emulated NPAL that supports the multiple network protocols and network functions in the network pipeline for a plurality of logical split ports, each logical split port corresponding to one of the plurality of devices. The emulated network pipeline 2500 can send the network traffic data to any of the plurality of logical split ports. In at least one embodiment, a first logical split port of the plurality of logical split ports is configured with a first policy, and a second logical split port of the plurality of logical split ports is configured with a second policy different than the first policy. The emulated acceleration hardware engine can process the network traffic data using the emulated network pipeline 2500. In at least one embodiment, the emulated DPU includes firmware configured to map physical lanes of the physical port to the plurality of logical split ports. The firmware can present the plurality of logical split ports as a set of PFs to the emulated NPAL. The emulated NPAL can configure the emulated network pipeline 2500 to perform a first network function for a first PF of the plurality of PFs and a second network function for a second PF of the plurality of PFs, the second network function being different than the first network function.

In at least one embodiment, the one or more processors can further emulate a virtual switch of the emulated DPU. The virtual switch can monitor a link availability of each of a plurality of links to a destination, the plurality of links being specified in an initial group of identifiers. The virtual switch can detect a link failure of a first link of the plurality of links. The emulated NPAL can remove a first link identifier, associated with the first link, from the initial group of link identifiers to obtain a modified group of link identifiers. The emulated NPAL can cause a routing table in the emulated NPAL to be updated to remove the first link identifier. The emulated acceleration hardware engine can process network traffic data using the emulated network pipeline 2500 and distribute the network traffic data to only the remaining links of the plurality of links corresponding to the modified group of identifiers. In at least one embodiment, the virtual switch can be controlled by a network service hosted on the emulated DPU. The virtual switch can send a notification to the network service of the link failure of the first link. The network service can update the routing table in the emulated DPU in response to the notification. The routing table can store configuration information associated with the initial group of identifiers.

In at least one embodiment, the emulated processing device can generate the first virtual bridge and the second virtual bridge, the first virtual bridge to be controlled by a first network service hosted on the emulated DPU and having a set of one or more network rules, and the second virtual bridge having a policy-based routing policy (PBR policy). The emulated processing device can add the virtual port between the first virtual bridge and the second virtual bridge. The emulated acceleration hardware engine, in the single accelerated data plane, can route network traffic data using the PBR policy and process the network traffic data using the set of one or more network rules. In at least one embodiment, the emulated processing device can receive user input from a user or a controller, the user input specifying the PBR policy. The PBR policy can include one or more routing rules each comprising a matching condition and a corresponding action. The emulated processing device can add the PBR policy to the second virtual bridge.

The emulated network pipeline 2500 can be used in various scenarios. In at least one embodiment, the emulated network pipeline 2500 can be used in network testing and simulation. Before deploying network policies, rules, or configurations to physical hardware, network engineers often simulate how these changes will affect the network using an emulated networking pipeline. This can be used for debugging, testing new protocols, or troubleshooting network behavior in a virtual environment. The emulated network pipeline 2500 can eliminate the need to invest in physical hardware during early stages of deployment or testing, reducing costs for network labs, developers, or organizations that rely heavily on virtualized infrastructure.

The emulated network pipeline 2500 can be adapted or reconfigured quickly compared to hardware-based pipelines, which require physical changes. This allows developers to experiment with different configurations, test various topologies, or simulate failures without touching physical infrastructure. The emulated network pipeline 2500 can be used by small companies, startups, or development environments where deploying costly switches and routers is not feasible, for example. In cloud environments, scalability is important. The emulated network pipeline 2500 can allow networking behavior to scale up or down dynamically according to demand, something physical hardware can struggle with due to limited capacity.

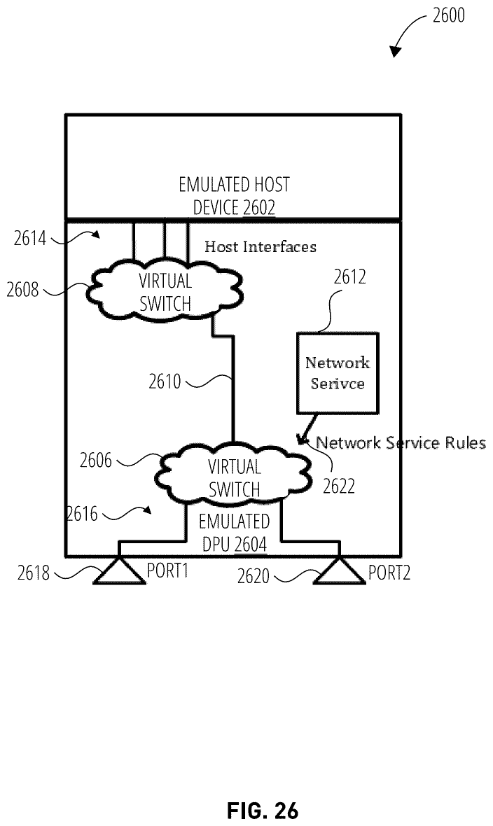

As described above, the emulated network pipeline 2500 can be emulated in an emulated environment including other virtualized components, such as one or more network service, an NPAL used by the one or more network services, a virtual bridge, an SFC, or the like. Each of the emulated components is implemented in software to emulates the exact same behavior as real hardware device. The emulated network pipeline 2500 performs the same as the hardware network pipeline. An example emulated environment is illustrated and described below with respect to FIG. 26.

FIG. 26 is a block diagram of an emulated SFC architecture 2600 with an emulated host device 2602 and an emulated DPU 2604 according to at least one embodiment. The emulated SFC architecture 2600 is similar to the SFC architecture 300 of FIG. 3, except the hardware and software components are emulated hardware and emulated software. In this embodiment, the physical ports of the emulated DPU 2604 are emulated as first emulated network port 2618 and second emulated network port 2620. As described above, the emulated DPU 2604 can generate and configure the emulated SFC architecture 2600 with an emulated software components, such as a first emulated virtual switch 2606, a second emulated virtual switch 2608, a virtual emulated port 2610, and an emulated network service 2612, according to at least one embodiment.

The emulated DPU 2604 can include SFC logic that can generate the first emulated virtual switch 2606, the second emulated virtual switch 2608, and the virtual emulated port 2610 in the emulated SFC architecture 2600. The SFC logic can configure the first emulated virtual switch 2606 to be controlled by the emulated network service 2612 hosted on the emulated DPU 2604 and the second emulated virtual switch 2608. The SFC logic can add a service interface to the first emulated virtual switch 2606 to operatively couple the emulated network service 2612 to the first emulated virtual switch 2606. The SFC logic can add the virtual emulated port 2610 between the first emulated virtual switch 2606 and second emulated virtual switch 2608. The emulated network service 2612 can provide one or more emulated network service rules 2622 to the first emulated virtual switch 2606. The SFC logic can add one or more Emulated host interfaces 2614 to the second emulated virtual switch 2608.

As illustrated, three separate host interfaces can be added to connect the second emulated virtual switch 2608 to hosts, such as three separate VMs hosted on the host device 202. For example, one VM can host a firewall application, another VM can host a load balancer application, and another VM can host an IDS application. The SFC logic can add one or more emulated network interfaces 2616 to the first emulated virtual switch 2606. In particular, the SFC logic 102 can add to the first emulated virtual switch 2606, a first network interface to operatively couple to a first emulated network port 2618 (labeled PORT1) of the emulated DPU 2604, and a second network interface to operatively couple to a second emulated network port 2620 (labeled PORT2) of the emulated DPU 2604. The first emulated virtual switch 2606 can receive network traffic data from the first emulated network port 2618 and the second emulated network port 2620. The first emulated virtual switch 2606 can receive network traffic data from the first emulated network port 2618 and the second emulated network port 2620. The first emulated virtual switch 2606 can direct the network traffic data to the second emulated virtual switch 2608 via the virtual port 806. The second emulated virtual switch 2608 can direct the network traffic data to the corresponding host via the emulated host interfaces 2614.

In at least one embodiment, the emulated DPU 2604 can include user-defined logic as part of the second emulated virtual switch 2608. In at least one embodiment, the user-defined logic can be part of a user-defined service hosted on the emulated DPU 2604, such as a user-defined network service, a user-defined security service, a user-defined telemetry service, a user-defined storage service, or the like. The SFC logic can add another service interface to the second emulated virtual switch 2608 to operatively couple the user-defined service to the second emulated virtual switch 2608.

In at least one embodiment, the SFC logic can configure, in the second emulated virtual switch 2608, a first link state propagation between a first host interface and the virtual emulated port 2610, and a second link state propagation between a second host interface and the virtual emulated port 2610. Similarly, the SFC logic can configure, in the second emulated virtual switch 2608, a third link state propagation between a third host interface and the virtual emulated port 2610. Similar link state propagations can be configured in the first emulated virtual switch 2606 for links between the virtual emulated port 2610 and the emulated network interfaces 2616.

In at least one embodiment, the SFC logic can configure an OS property in the second emulated virtual switch 2608. In at least one embodiment, the SFC logic 102 can configure an OS property for each of the emulated host interfaces 2614.

As described herein, the emulated SFC architecture 2600 can be created as part of installation of the OS on the emulated DPU 2604 or as part of runtime of the emulated DPU 2604. This can be done using a second configuration file or a modification to the original configuration file. The re-configuration of the emulated DPU 2604 as part of runtime can be done without reinstallation of the OS on the emulated DPU 2604.

In at least one embodiment, the emulated SFC architecture 2600 is a set of instructions executed by a computing system with a processing device and a memory operatively coupled to the processing device. The instructions, when executed by the processing device, cause the processing device to perform first operations of the emulated host device 2602 and second operations of an NPAL of the emulated DPU 2604, including an emulated processing device and an emulated acceleration hardware engine. The emulated NPAL supports multiple network protocols and network functions in an emulated network pipeline. The emulated network pipeline includes a set of tables and logic organized in a specific order to be accelerated by the emulated acceleration hardware engine, such as illustrated in FIG. 25. The emulated acceleration hardware engine can process network traffic data using the emulated network pipeline 2500.

In at least one embodiment, the processing device can emulate the emulated physical virtual emulated port 2610 of the emulated DPU 2604. The emulated DPU 2604 is configured to couple to an emulated breakout cable that physically couples to a set of a plurality of emulated devices. The emulated NPAL supports the multiple network protocols and network functions in the emulated network pipeline 2500 for a plurality of logical split ports, each logical split port corresponding to one of the plurality of devices. The emulated network pipeline can send the network traffic data to any of the plurality of logical split ports. A first logical split port of the plurality of logical split ports can be configured with a first policy, and a second logical split port of the plurality of logical split ports can be configured with a second policy different than the first policy. The emulated acceleration hardware engine can process the network traffic data using the emulated network pipeline 2500

In at least one embodiment, the emulated DPU 2604 includes firmware configured to map physical lanes of the physical port to the plurality of logical split ports. In at least one embodiment, the firmware can present the plurality of logical split ports as a plurality of PFs to the emulated NPAL. The emulated NPAL can configure the emulated network pipeline to perform a first network function for a first PF of the plurality of PFs and a second network function for a second PF of the plurality of PFs, the second network function being different than the first network function.

In at least one embodiment, the processing device can emulate a virtual switch, such as the first emulated virtual switch 2606 or second emulated virtual switch 2608 of the emulated DPU 2604. The second emulated virtual switch 2608 can monitor a link availability of each of a plurality of links to a destination, the plurality of links being specified in an initial group of identifiers. The second emulated virtual switch 2608 can detect a link failure of a first link of the plurality of links. The emulated NPAL can remove a first link identifier, associated with the first link, from the initial group of link identifiers to obtain a modified group of link identifiers. The emulated NPAL can cause a routing table in the emulated NPAL to be updated to remove the first link identifier. The emulated acceleration hardware engine can process network traffic data using the emulated network pipeline and distribute the network traffic data to only the remaining links of the plurality of links corresponding to the modified group of identifiers. In at least one embodiment, the second emulated virtual switch 2608 is controlled by the emulated network service 2612 hosted on the emulated DPU 2604. The second emulated virtual switch 2608 can send a notification to the emulated network service 2612 of the link failure of the first link, the emulated network service 2612 to update the routing table in the emulated DPU 2604 in response to the notification, the routing table storing configuration information associated with the initial group of identifiers.

In at least one embodiment, the processing device can emulate a physical processing device. The emulated processing device can generate the first virtual bridge and the second virtual bridge, the first virtual bridge to be controlled by the emulated network service 2612 hosted on the emulated DPU 2604 and having a set of one or more network rules, and the second virtual bridge having a policy-based routing policy (PBR policy). The emulated processing device can add the virtual port between the first virtual bridge and the second virtual bridge. The emulated acceleration hardware engine, in the single accelerated data plane, can route network traffic data using the PBR policy and process the network traffic data using the set of one or more network rules.

In at least one embodiment, the emulated processing device can receive user input from a user or a controller, the user input specifying the PBR policy. The PBR policy includes one or more routing rules each includes a matching condition and a corresponding action. The emulated processing device can add the PBR policy to the second virtual bridge.

It should be noted that the SFC logic can generate different combinations of virtual bridges and interface mappings in different SFC architectures, such as illustrated and described herein.

FIG. 27 is a flow diagram of a method 2700 of operating an emulated DPU according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 2700 may be performed by multiple processing threads, each thread executing one or more individual functions, routines, subroutines, or operations of the method. In at least one embodiment, processing threads implementing method 2700 may be synchronized (e.g., using semaphores, critical sections, and/or other thread synchronization logic). Alternatively, processing threads implementing method 2700 may be executed asynchronously with respect to each other. Various operations of method 2700 may be performed differently than the order shown in FIG. 27. Some operations of the methods may be performed concurrently with other operations. In at least one embodiment, one or more operations shown in FIG. 27 may not always be performed.

Referring to FIG. 27, the processing logic begins with the processing logic executing one or more instructions of an emulated NPAL of an emulated DPU that supports multiple network protocols and network functions in an emulated network pipeline, the emulated DPU comprising an emulated processing device and an emulated acceleration hardware engine. The emulated network pipeline includes a set of tables and logic organized in a specific order to be accelerated by the emulated acceleration hardware engine. At block 2704, the processing logic receives emulated network traffic data over a network. At block 2706, the processing logic processes, using the emulated acceleration hardware engine of the emulated DPU, the emulated network traffic data using the emulated network pipeline.

In a further embodiment, the processing logic emulates an emulated physical port of the emulated DPU configured to couple to an emulated breakout cable that physically couples to a set of a plurality of emulated devices, The emulated NPAL supports the multiple network protocols and network functions in the emulated network pipeline for a plurality of logical split ports, each logical split port corresponding to one of the plurality of devices. The emulated network pipeline can send the network traffic data to any of the plurality of logical split ports. A first logical split port of the plurality of logical split ports is configured with a first policy, and a second logical split port of the plurality of logical split ports is configured with a second policy different than the first policy.

In a further embodiment, the processing logic maps physical lanes of the physical port to the plurality of logical split ports and presents the plurality of logical split ports as a plurality of PFs to the emulated NPAL. The processing logic configures the emulated network pipeline to perform a first network function for a first PF of the plurality of PFs and a second network function for a second PF of the plurality of PFs, the second network function being different than the first network function.

In at least one embodiment, the processing logic emulates a virtual switch of the emulated DPU by monitoring a link availability of each of a plurality of links to a destination, the plurality of links being specified in an initial group of identifiers, and detecting a link failure of a first link of the plurality of links. The processing logic removes a first link identifier, associated with the first link, from the initial group of link identifiers to obtain a modified group of link identifiers. The processing logic causes a routing table in the emulated NPAL to be updated to remove the first link identifier. The emulated acceleration hardware engine can process network traffic data using the emulated network pipeline and distribute the network traffic data to only the remaining links of the plurality of links corresponding to the modified group of identifiers.

In at least one embodiment, the virtual switch is controlled by an emulated network service hosted on the emulated DPU, and emulating the virtual switch includes sending a notification to the emulated network service of the link failure of the first link, the emulated network service to update the routing table in the emulated DPU in response to the notification, and the routing table storing configuration information associated with the initial group of identifiers.

In at least one embodiment, the processing logic emulates the processing device by: generating a first virtual switch and a second virtual switch, the first virtual switch to be controlled by an emulated network service hosted on the emulated DPU and having a set of one or more network rules, and the second virtual switch having a PBR policy; adding the virtual port between the first virtual switch and the second virtual switch; routing network traffic data using the PBR policy; and processing the network traffic data using the set of one or more network rules.

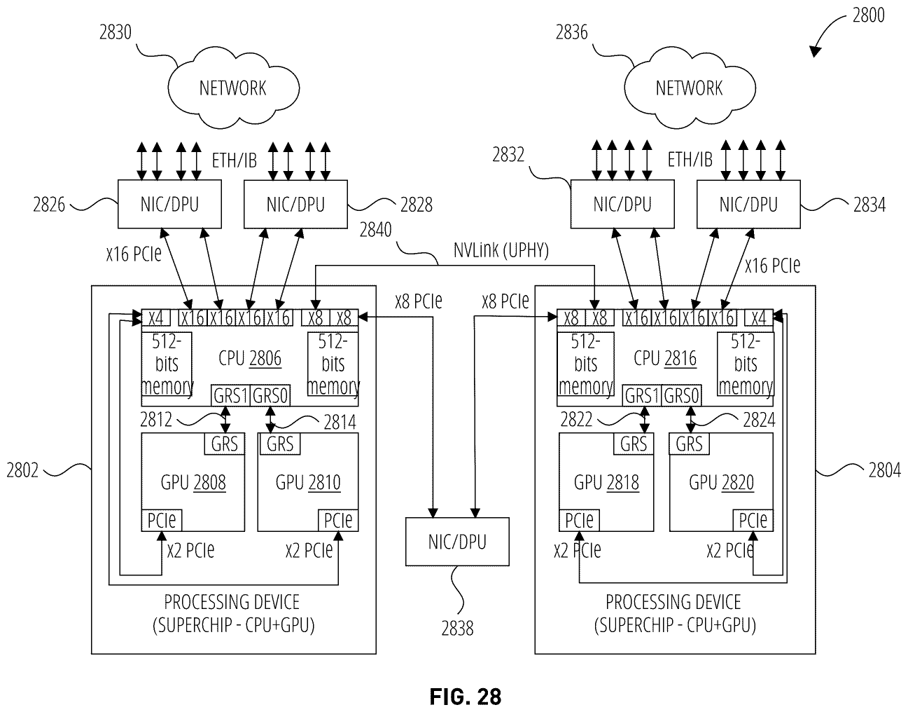

FIG. 28 is a block diagram of a computing system 2800 having two processing devices coupled to each other and multiple networks according to at least one embodiment. The computing system 2800 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 2800. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 2800 highly suitable for demanding applications that require significant processing power, such as artificial intelligence (AI), machine learning (ML), and data-intensive computing, while ensuring robust connectivity and scalability across various networked environments. The integrated circuits of the computing system 2800 can include one or more CPUs and one or more GPUs. An example architecture of a multi-GPU architecture is illustrated in FIG. 28.

As illustrated in FIG. 28, the computing system 2800 includes a processing device 2802 with a multi-GPU architecture. In particular, the processing device 2802 includes a CPU 2806, a GPU 2808, and a GPU 2810. The CPU 2806 can be coupled to the GPU 2808 via an die-to-die (D2D) or chip-to-chip (C2C) interconnect 2812, such as a Ground-Referenced Signaling interconnect (GRS interconnect). The CPU 2806 can be coupled to the GPU 2810 via a D2D or C2C interconnect 2814. The CPU 2806 can also couple to the GPU 2808 and GPU 2810 via PCIe interconnects. The CPU 2806 can be coupled to one or more network interface cards (NICs) or data processing units (DPUs), which are coupled to one or more networks. For example, as illustrated in FIG. 28, the CPU 2806 is coupled to a first NIC/DPU 2826, which is coupled to a network 2830. The CPU 2806 is also coupled to a second NIC/DPU 2828, which is coupled to the network 2830. The NIC/DPU 2826 and NIC/DPU 2828 can be coupled to the network 2830 over Ethernet (ETH) or InfiniBand (IB) connections.

The computing system 2800 also includes a processing device 2804 with a multi-GPU architecture. In particular, the processing device 2804 includes a CPU 2816, a GPU 2818, and a GPU 2820. The CPU 2816 can be coupled to the GPU 2818 via an D2D or C2C interconnect 2822. The CPU 2816 can be coupled to the GPU 2820 via a D2D or C2C interconnect 2824. The CPU 2816 can also couple to the GPU 2818 and GPU 2820 via PCIe interconnects. The CPU 2816 can be coupled to one or more NICs or DPUs, which are coupled to one or more networks. For example, as illustrated in FIG. 28, the CPU 2816 is coupled to a first NIC/DPU 2832, which is coupled to a network 2836. The CPU 2816 is also coupled to a second NIC/DPU 2834, which is coupled to the network 2836. The NIC/DPU 2832 and NIC/DPU 2834 can be coupled to the network 2836 over Ethernet (ETH) or InfiniBand (IB) connections.

In at least one embodiment, the processing device 2802 and the processing device 2804 can communication with each other via a NIC/DPU 2838, such as over PCIe interconnects. The processing device 2802 and processing device 2804 can also communicate with each other over a high-bandwidth communication interconnects 2840, such as an NVLink interconnect or other high-speed interconnects.

The NIC/DPUs of FIG. 28 can be the various embodiments of the DPUs described herein with respect to FIG. 1 to FIG. 26.

In at least one embodiment, the computing system 2800 is used for high-speed network communication and includes a processing unit (e.g., CPU 2806, GPU 2808, GPU 2810, CPU 2816, GPU 2818, GPU 2820, NIC/DPU 2826, NIC/DPU 2828, NIC/DPU 2832, NIC/DPU 2834, or NIC/DPU 2838), and a network interface coupled to the processing unit. The network interface can include the operations and functionality of the DPUs described herein.

In at least one embodiment, the computing system 2800 includes a host device and an auxiliary device. The auxiliary device includes a device memory and a processor, communicably coupled to the device memory. The auxiliary device performs the operations described herein with respect to FIG. 1 to FIG. 26. The auxiliary device can include a GPU. The auxiliary device can include a DPU. The auxiliary device can include a DPU. The auxiliary device can include accelerator hardware.

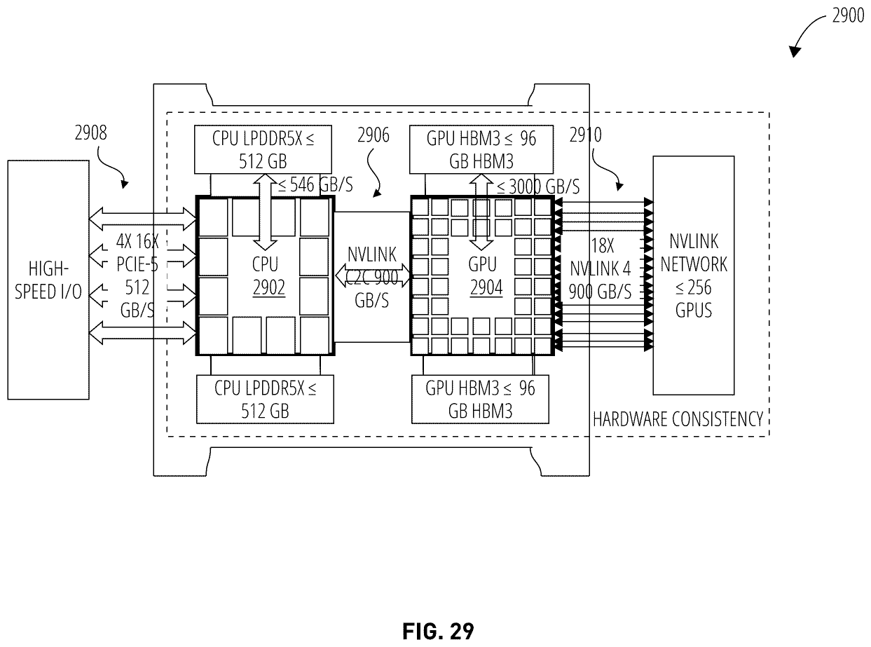

FIG. 29 is a block diagram of a computing system 2900 having a CPU 2902 and a GPU 2904 in a single integrated circuit according to at least one embodiment. The computing system 2900 can be a highly integrated design where a CPU 2902 and GPU 2904 are connected on a single integrated circuit, utilizing an NVLink C2C (Chip-to-Chip) interconnect 2906 to enable fast, low-latency communication between the two processing units. This close integration allows for efficient data transfer and parallel processing between the CPU 2902 and GPU 2904, optimizing performance for complex computational tasks. The GPU elements within the computing system 2900 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 2910. Additionally, the computing system 2900 can be designed to interface with a high-speed I/O through PCIe interconnects 2908, ensuring rapid data transfer to and from external devices, further enhancing the system's capabilities in handling data-intensive tasks and providing robust connectivity to peripheral components. It should be noted that the C2C interconnects 2906 can be considered D2D interconnects since the CPU 2902 and the GPU 2904 are located on the same integrated circuit. The integrated circuit can include CPU memory (also referred to as main memory) and GPU memory, which are accessible by the CPU 2902 and the GPU 2904, respectively, over high-speed interconnects. The computing system 2900 can bring together performance of the GPU 2904 with the versatility of the CPU 2902. The CPU 2902 can be connected with a high-bandwidth and memory coherent C2C interconnects 2906 in a single integrated circuit. The computing system 2900 can support a link switch system.

The computing system 2900 can be used for the various embodiments described herein with respect to FIG. 1 to FIG. 26.

In at least one embodiment, the computing system 2900 is used for high-speed network communication and includes a processing unit, and a network interface coupled to the processing unit. The network interface can include the operations and functionality of the DPUs described herein.

In at least one embodiment, the computing system 2900 includes a host device and an auxiliary device. The auxiliary device includes a device memory and a processor, communicably coupled to the device memory. The auxiliary device performs the operations described herein with respect to FIG. 1 to FIG. 26. The auxiliary device can include a GPU. The auxiliary device can include a DPU. The auxiliary device can include a DPU. The auxiliary device can include accelerator hardware.

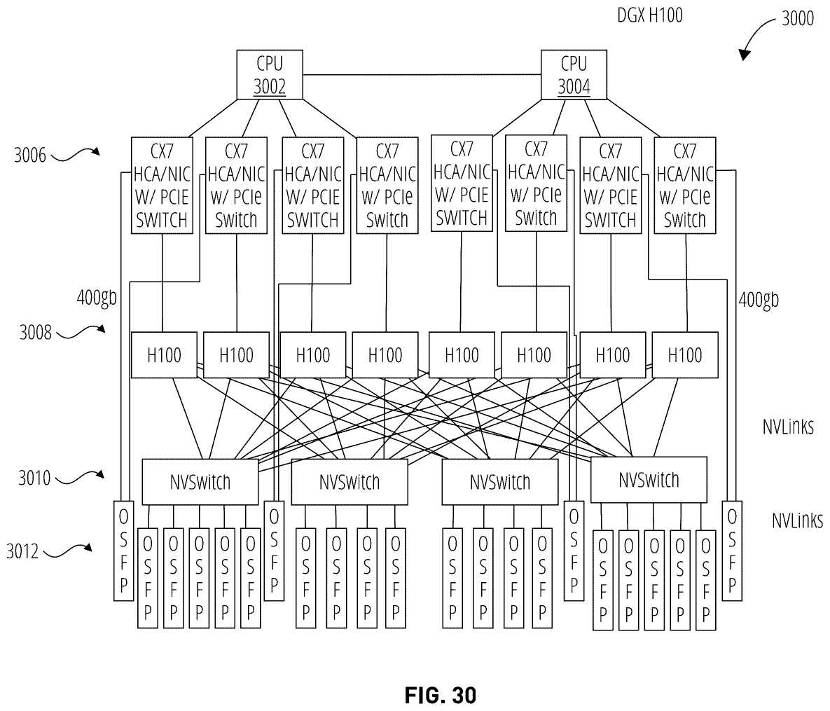

FIG. 30 is a block diagram of a computing system 3000 having tensor core GPUs 3008 according to at least one embodiment. The computing system 3000 can be a DGX H100 system, which is a high-performance computing platform designed to meet the demands of AI, ML, and deep learning (DL) workloads. The computing system 3000 can include multiple tensor core GPUs 3008 (e.g., NVIDIA H100 Tensor Core GPUs). The tensor core GPUs 3008 can each be one of the integrated circuits described above with respect to FIG. 29. The tensor core GPUs 3008 can be optimized for AI/ML/DL applications, offering exceptional performance for deep learning training, inference, and high-performance computing tasks. The tensor core GPUs 3008 within the computing system 3000 are interconnected using high-speed communication interfaces like NVLinks, enabling rapid data transfer between them, which is crucial for handling large-scale AI models and datasets with low latency. This computing system 3000 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 3008, the computing system 3000 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 3008 for their specific applications. The computing system 3000 is ideally suited for large-scale AI model training, real-time inference, scientific simulations, data analytics, and other compute-intensive tasks that require massive parallel processing power.

The tensor core GPUs 3008 can be coupled to multiple CPUs, such as CPU 3002 and CPU 3004, using switches 3006 (e.g., CX7 HCA/NIC with PCIe switch). The tensor core GPUs 3008 can be coupled to each other via switches 3010 (e.g., NVSwitches). The switches 3006 and switches 3010 can be coupled to high-speed transceiver modules 3012. The high-speed transceiver modules 3012 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 3000 remains capable of meeting increasing data demands and can be upgraded to support future advancements in network speeds, thus contributing to the system's overall performance and scalability.

In at least one embodiment, the computing system 3000 can be considered a data-network configuration with full-bandwidth intra-server NVLinks. In this example, all eight tensor core GPUs 3008 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 3008 can half-subscribe eighteen NVLinks to GPUs in other servers. Four tensor core GPUs 3008 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 3008 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

The NICs/switches of computing system 3000 can include the various embodiments described herein with respect to FIG. 1 to FIG. 26.

In at least one embodiment, the computing system 3000 is used for high-speed network communication and includes a processing unit (e.g., CPU 3002, CPU 3004, switches 3006, tensor core GPUs 3008, switches 3010, high-speed transceiver modules 3012), and a network interface coupled to the processing unit. The network interface can include the operations and functionality of the DPUs described herein.

In at least one embodiment, the computing system 3000 includes a host device and an auxiliary device. The auxiliary device includes a device memory and a processor, communicably coupled to the device memory. The auxiliary device performs the operations described herein with respect to FIG. 1 to FIG. 26. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors—for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A data processing unit (DPU) comprising:
acceleration hardware engine to provide a single accelerated data plane;
memory to store a configuration file specifying at least a first virtual bridge, a second virtual bridge, and a virtual port between the first virtual bridge and the second virtual bridge; and
a processing device operatively coupled to the memory and the acceleration hardware engine, wherein the processing device, according to the configuration file, is to:
generate the first virtual bridge and the second virtual bridge, the first virtual bridge to be controlled by a first network service hosted on the DPU and having a set of one or more network rules, and the second virtual bridge having a policy-based routing policy (PBR policy); and
add the virtual port between the first virtual bridge and the second virtual bridge; and
wherein the acceleration hardware engine, in the single accelerated data plane, is to route network traffic data using the PBR policy and process the network traffic data using the set of one or more network rules.

2. The DPU of claim 1, wherein the processing device is to:
receive user input from a user or a controller, the user input specifying the PBR policy, wherein the PBR policy comprises one or more routing rules each comprising a matching condition and a corresponding action; and
add the PBR policy to the second virtual bridge.

3. The DPU of claim 2, wherein the matching condition specifies at least one of:
a source internet protocol (IP) address
a source or destination port;
a protocol identifier;
a virtual local area network (VLAN) tag;
a Differentiated Service Code Point (DSCP) or Type of Service (ToS) value;
an application or service type; or
a time of day.

4. The DPU of claim 2, wherein the action comprises at least one of:
a forward action;
a drop action;
a re-route action;
a mirror action;
a load balance action;
a rate limit action;
a Quality of Service (QOS) marking action;
a traffic shaping action;
an encapsulation action; or
a redirect action.

5. The DPU of claim 1, wherein the processing device, according to the configuration file, is to:
add one or more host interfaces to the second virtual bridge to operatively couple to one or more host devices operatively coupled to the DPU;
add one or more network interfaces to the first virtual bridge to operatively couple to one or more network ports of the DPU; and
add a first service interface to the first virtual bridge to operatively couple to the first network service, the first network service to provide accelerated network capabilities using the set of one or more network rules.

6. The DPU of claim 5, wherein the set of one or more network rules comprises at least one of a layer 2 (L2) protocol rule, a layer 3 (L3) protocol rule, a tunneling protocol rule, an Access Control List (ACL) rule, an Equal-Cost Multi-Path (ECMP) rule, a tunneling encapsulation rule, a tunneling decapsulation rule, a Connection Tracking (CT) rule, a virtual local area network (VLAN) rule, or a network address translation (NAT) rule.

7. The DPU of claim 5, wherein the set of one or more network rules comprises one or more steering rules, wherein the one or more steering rules comprises at least one of an application-based steering rule, a policy-based steering rule, a geolocation-based steering rule, a load balancing rule, a Quality of Service (QOS) rule, a failover rule, a redundancy rule, a security-based steering rule, a cost-based routing rule, a software-defined wide area network (SD-WAN) path steering rule, or a software-defined networking (SDN) rule.

8. The DPU of claim 1, wherein the PBR policy is programmable by a user or a controller.

9. The DPU of claim 1, wherein the first virtual bridge and the second virtual bridge are Open vSwitch (OVS) bridges, wherein the processing device is to execute an OVS application with hardware offload mechanisms to provide the single accelerated data plane in the acceleration hardware engine to route the network traffic data using the PBR policy and process the network traffic data using the set of one or more network rules.

10. The DPU of claim 1, wherein the processing device, according to the configuration file, is to:
add one or more host interfaces to the second virtual bridge to operatively couple to one or more host devices operatively coupled to the DPU; and
add one or more network interfaces to the first virtual bridge to operatively couple to one or more network ports of the DPU; and
add a first service interface to the first virtual bridge to operatively couple to the first network service; and
add a second service interface to the second virtual bridge to operatively couple a second network service, the second network service wherein the first network service and the second network service are part of a service function chaining (SFC) infrastructure to provide accelerated network capabilities in the single accelerated data plane using a combined set of network rules, the combined set of rules comprising the set of one or more network rules associated with the first network service and a second set of one or more network rules associated with the second network service.

11. A method of operating a data processing unit (DPU) with an acceleration hardware engine to provide a single accelerated data plane, the method comprising:
storing a configuration file specifying at least a first virtual bridge, a second virtual bridge, and a virtual port between the first virtual bridge and the second virtual bridge;
generating, according to the configuration file, the first virtual bridge and the second virtual bridge, the first virtual bridge to be controlled by a first network service hosted on the DPU and having a set of one or more network rules, and the second virtual bridge having a policy-based routing policy (PBR policy);
adding, according to the configuration file, the virtual port between the first virtual bridge and the second virtual bridge;
routing, using the acceleration hardware engine in the single accelerated data plane, network traffic data using the PBR policy; and
processing, using the acceleration hardware engine in the single accelerated data plane, the network traffic data using the set of network rules.

12. The method of claim 11, further comprising:
receiving user input from a user or a controller, the user input specifying the PBR policy, wherein the PBR policy comprises one or more routing rules each comprising a matching condition and a corresponding action; and
adding the PBR policy to the second virtual bridge.

13. The method of claim 12, wherein the matching condition specifies at least one of:
a source internet protocol (IP) address
a source or destination port;
a protocol identifier;
a virtual local area network (VLAN) tag;
a Differentiated Service Code Point (DSCP) or Type of Service (ToS) value;
an application or service type; or
a time of day.

14. The method of claim 12, wherein the action comprises at least one of:
a forward action;
a drop action;
a re-route action;
a mirror action;
a load balance action;
a rate limit action;
a Quality of Service (QOS) marking action;
a traffic shaping action;
an encapsulation action; or
a redirect action.

15. The method of claim 11, further comprising:
adding, according to the configuration file, one or more host interfaces to the second virtual bridge to operatively couple to one or more host devices operatively coupled to the DPU;
adding, according to the configuration file, one or more network interfaces to the first virtual bridge to operatively couple to one or more network ports of the DPU; and
adding, according to the configuration file, a first service interface to the first virtual bridge to operatively couple to the first network service, the first network service to provide accelerated network capabilities using the set of one or more network rules.

16. The method of claim 12, further comprising:
adding, according to the configuration file, one or more host interfaces to the second virtual bridge to operatively couple to one or more host devices operatively coupled to the DPU;
adding, according to the configuration file, one or more network interfaces to the first virtual bridge to operatively couple to one or more network ports of the DPU; and
adding, according to the configuration file, a first service interface to the first virtual bridge to operatively couple to the first network service, the first network service to provide accelerated network capabilities using the set of one or more network rules, wherein the set of one or more network rules comprises at least one of a layer 2 (L2) protocol rule, a layer 3 (L3) protocol rule, a tunneling protocol rule, an Access Control List (ACL) rule, an Equal-Cost Multi-Path (ECMP) rule, a tunneling encapsulation rule, a tunneling decapsulation rule, a Connection Tracking (CT) rule, a virtual local area network (VLAN) rule, a network address translation (NAT) rule, or one or more steering rules, wherein the one or more steering rules comprises at least one of an application-based steering rule, a policy-based steering rule, a geolocation-based steering rule, a load balancing rule, a Quality of Service (QOS) rule, a failover rule, a redundancy rule, a security-based steering rule, a cost-based routing rule, a software-defined wide area network (SD-WAN) path steering rule, or a software-defined networking (SDN) rule.

17. The method of claim 11, further comprising:
adding, according to the configuration file, one or more host interfaces to the second virtual bridge to operatively couple to one or more host devices operatively coupled to the DPU; and
adding, according to the configuration file, one or more network interfaces to the first virtual bridge to operatively couple to one or more network ports of the DPU; and
adding, according to the configuration file, a first service interface to the first virtual bridge to operatively couple to the first network service; and
adding, according to the configuration file, a second service interface to the second virtual bridge to operatively couple a second network service, the second network service wherein the first network service and the second network service are part of a service function chaining (SFC) infrastructure to provide accelerated network capabilities in the single accelerated data plane using a combined set of network rules, the combined set of rules comprising the set of one or more network rules associated with the first network service and a second set of one or more network rules associated with the second network service.

18. A computing system comprising:
a host device; and
an integrated circuit coupled to the host device and a network, wherein the integrated circuit comprises:
a network interconnect coupled to the network;
a host interconnect coupled to the host device;
a memory to store a configuration file specifying at least a first virtual bridge, a second virtual bridge, and a virtual port between the first virtual bridge and the second virtual bridge;
an acceleration hardware engine to provide a single accelerated data plane; and
a central processing unit (CPU) coupled to the network interconnect, the host interconnect, and the acceleration hardware engine, wherein the CPU is to:
generate the first virtual bridge and the second virtual bridge, the first virtual bridge to be controlled by a first network service hosted on the integrated circuit and having a set of one or more network rules, and the second virtual bridge having a policy-based routing policy (PBR policy); and
add the virtual port between the first virtual bridge and the second virtual bridge; and
wherein the acceleration hardware engine, in the single accelerated data plane, is to:
route network traffic data using the PBR policy; and
process the network traffic data using the set of one or more network rules.

19. The computing system of claim 18, wherein the integrated circuit is at least one of a data processing unit (DPU), a network interface card (NIC), a network interface device, or a switch, wherein the DPU is a programmable data center infrastructure on a chip.

20. The computing system of claim 18, wherein the CPU is to:
receive user input from a user or a controller, the user input specifying the PBR policy, wherein the PBR policy comprises one or more routing rules each comprising a matching condition and a corresponding action; and
add the PBR policy to the second virtual bridge.
